(19) United States
(12) Patent Application Publication
(10) Pub. No.: US 2024/0192972 A1
(43) Pub. Date: Jun. 13, 2024

(54) METHODS AND SYSTEMS FOR OBJECT-AWARE FUZZY PROCESSING BASED ON ANALOGIES

(71) Applicant: LVT Enformasyon Teknolojileri Ltd. Sti., Beyoglu Istanbul (TR)

(72) Inventor: Osman Levent Soyarslan, Beyoglu Istanbul (TR)

(73) Assignee: LVT Enformasyon Teknolojileri Ltd. Sti., Beyoglu Istanbul (TR)

(21) Appl. No.: 18/583,521

(22) Filed: Feb. 21, 2024

Related U.S. Application Data
(63) Continuation-in-part of application No. 18/178,382, filed on Mar. 3, 2023.
Application No. 18/178,382 is a continuation-in-part of application No. 16/886,265, filed on May 28, 2020, now Pat. No. 11,625,448.

(51) Int. Cl. G06F 9/451; G06F 3/0483; G06F 3/04842; G06F 16/906; G06F 40/123; G06F 40/169

(52) U.S. Cl. CPC G06F 9/451; G06F 3/0483; G06F 3/04842; G06F 16/906; G06F 40/123; G06F 40/169

(57) ABSTRACT

Disclosed methods and systems provide an intelligent semantic web infrastructure to transform decentralized data networks, such as the Internet, into controllable and evolvable information spaces, i.e., where all information becomes subject to further processing in real-time in a stable and sustainable manner without any API support. In contrast to the object-based state-of-the-art, the disclosed system is designed to be object-aware to ensure the establishment of stable and sustainable associations with web objects, while enabling them to be processed dynamically with full adaptability in response to contextual and structural alterations. In this context, the system provides human and machine users with the ability to develop and deploy modular dynamic subsystems capable of engaging any conceivable digital interaction with the resources of a data network, such as dynamically linking and manipulating clusters of complex web objects to execute complex tasks in complex and dynamic web environments—most importantly—stably and sustainably.

### RELATED APPLICATIONS

This application is a continuation-in-part of U.S. patent application Ser. No. 18/178,382 filed Mar. 3, 2023, which is a continuation-in-part of U.S. patent application Ser. No. 16/886,265 filed May 28, 2020, now U.S. Pat. No. 11,625,448, all of which are hereby incorporated by reference.

### TECHNICAL FIELD

This disclosure relates generally to data processing and more particularly to graphical user interface and document processing in regard to a knowledge-based system that provides an interactive communication medium on resources of a data network, such as on web resources of the Internet. In this context, the described methods and systems directly relates to some sub-fields of artificial intelligence, such as semantic analysis, ontologies, knowledge representation and reasoning, rule-based and knowledge-based systems, hybrid intelligent systems, such as neural expert systems and neuro-fuzzy systems; and indirectly relates to natural language processing, machine learning, computer vision, pattern recognition, hybrid intelligence, etc. In addition, or alternatively, the methods and systems are also applicable to automation and robotics by generalizing web objects to physical objects and equipping the system with appropriate sensors, transducers, actuators, and controllers, etc.

### BACKGROUND

The Web has been the cradle of many revolutionary concepts, and socio-economically one of the most influential of all is probably the interactive features such as interactive posts, social networking capabilities, etc. that triggered the Social Web or Web 2.0. Users' ability to interact on the Web has enabled users to become active contributors instead of passive followers and thus these users began to shape the Web and through the Web they began to shape the world. There have been countless initiatives on the Web that have influenced society, for example crimes committed by governments were exposed, or public revolts against tyranny were coordinated through social networks, and all this was achieved through interactive platforms. On the other hand, interaction ability on the Web has indeed reached only a small part of its potential despite this revolutionary leap. Unlike the rosy picture that is widely accepted, ability to interact on the Web is quite limited, and it is almost entirely dependent on the interactive features provided by websites, such as graphical user interfaces (GUIs) or application programming interfaces (APIs). Moreover, interaction on the Web is being deliberately restricted in the interests of websites, and interaction design—including APIs—has become a frontend manipulation tool. For example, YouTube™ has decommissioned the dislike counter to increase the view rates and, in this context, has regressed to the level of Facebook™ or Twitter™, which have never provided such a feature.

Alternatively, interaction ability on resources of decentralized data networks—such as web resources of the Internet—can be enhanced dramatically, such as by virtually integrating contents or features into web resources or by similar approaches. In current practice, content integration is mainly manifested in the form of web annotations. Web annotation systems enable users to annotate web pages with user generated contents and share them with other users. On the other hand, feature integration is manifested in various forms such as extensions, plugins, addons, or in the more advanced form of augmented browsing. The problem with the state-of-the-art content and feature integration systems is that they can only operate in relatively static, non-complex web environments, and rely mostly on integration APIs to ensure sustainability against alterations—if provided and adequate. However, web environments can be dynamic and complex both contextually and structurally, and even static environments can be manually altered drastically. Furthermore, most websites do not provide APIs for integration or what is provided may not be adequate and/or permanent. In such scenarios associations are often lost or incorrectly re-established and executed. In principle, the problem of ‘maintaining associations and adapting execution procedures’—which is identified within the context of this subject matter as the problem of ‘ensuring the stability and sustainability of interactions’—increase exponentially as the dynamicity and complexity of web resources and/or alterations increase.

Decentralized data networks—especially the Internet—have a tremendous potential that is currently idle in terms of interactivity and this potential can only be activated by ensuring stability and sustainability of interactions. Ensuring stability and sustainability of interactions in decentralized data networks within any scenario constitutes the fundamental problem for which state-of-the-art cannot provide any concrete solution. Thus, there is presently no system that considerably enhances the interaction ability upon the Web stably and sustainably—regardless of features and services provided by websites such as integration APIs—which are profoundly limited and impotent solutions inherently. Said technological inadequacy in question also constitutes the main reason behind the fact that the Web has not been developed in this direction. Paving the way for the development of the Web in this direction may also lead to the solution of fundamental problems such as disinformation and monopolization on the Web, which have turned into a deep crisis globally.

### SUMMARY

Disclosed methods and systems provide an intelligent semantic web infrastructure to transform decentralized data networks, such as the Internet, into controllable and evolvable information spaces, i.e., where all information becomes subject to further processing in real-time in a stable and sustainable manner without any API support. In contrast to the object-based state-of-the-art, the disclosed system is designed to be object-aware to ensure the establishment of stable and sustainable associations with web objects, while enabling them to be processed dynamically with full adaptability in response to contextual and structural alterations. In this context, the system provides human and machine users with the ability to develop and deploy modular dynamic subsystems capable of engaging any conceivable digital/virtual interaction with the resources of a data network, such as dynamically linking and manipulating clusters of complex web objects to execute complex tasks in complex and dynamic web environments—most importantly—stably and sustainably.

The subject-matter described herein includes: i) A novel web-based interaction framework, i.e., ‘Superimposed Communication Framework’; ii) A next generation intelligent semantic web infrastructure envisaged to realize Superimposed Communication Framework; iii) The fundamental problems that the framework involves; iv) The disclosed solution that constitutes the technological basis of the framework, i.e., ‘Methods and Systems for Object-Aware Fuzzy Processing based on Analogies’, or as formerly named as ‘System for Superimposed Communication by Object-Oriented Resource Manipulation’; v) Generalized methods and systems involving both virtual and physical objects and ontological consequences of ‘Object-Aware Fuzzy Processing based on Analogies’. A brief summary of each is listed below.

i) Superimposed Communication Framework—Envisioned Interactions: The primary goal of the ‘Superimposed Communication Framework’ (SCF) is to transform decentralized data networks into controllable and evolvable information spaces, where all information becomes subject to further processing in a stable and sustainable manner, in real-time, without any API support. Within this framework, both human and machine users gain the ability to develop and deploy adaptive software applications that dynamically process the web objects—including APIs—to which they are associated. Such adaptive software applications are herein referred to as ‘super-objects’ or ‘user inputs’ or ‘superimposed applications’, which are user generated applications that are associated with web objects.

Super-objects may be associated with complex and dynamic web objects—such as a structurally altering GUI, or a contextually altering HTML table in a structurally altering GUI, or an API, or combinations thereof—in complex and dynamic web environments—such as an adaptive website—to perform complex and dynamic tasks within the scope of accessible data/information—such as a dynamic task about data mining and analytics—stably and sustainably. Once super-objects are deployed in association with web objects—which is herein referred to as first-order super-objects—users may further deploy higher-order super-objects in association with the first-order super-objects while interacting with each other through any super-object that act as a network link—such as through messaging interfaces provided. As a result, within the scope of the disclosed framework, an infinite array of associations may be established between or through web objects in order to perform an infinite array of operations in relation to the corresponding web objects. Thus, any identifiable web object, such as a GUI, a table, an article, an API, etc. or any identifiable cluster of web objects, such as a combination of GUIs, tables, articles, APIs, etc., may become a potential building block—besides the user-generated super-objects—for constructing complex modular sub-systems—such as, creating cascade data processing structures via super-objects that act as connectors and processors—in order to perform complex operations—similar to the concept of electronic sound generation by modular synthesis.

ii) Semantic Web Infrastructure for Superimposed Communication—Envisioned Infrastructure: In order to provide the envisioned interactions, a next generation intelligent semantic web infrastructure for Superimposed Communication (SWISC) is proposed. In essence, the infrastructure is envisioned to be based on an intelligent intermediary system that operates autonomously between nodes of a data network, especially focusing on decentralized data networks where generally there is no coalition between the server nodes, such as the Web. In this context, as an infrastructural system, SWISC may directly provide a coalition between client nodes through the client-side application of the system embedded in browsers in coordination with the server-side application. On the other hand, SWISC may indirectly provide a coalition between server nodes by controlling the interactions between client nodes and server nodes in real-time, through the client-side application of the system embedded in browsers in coordination with the server-side application. During this particularly challenging process, SWISC may utilize data/information accessible through browsers of client nodes, e.g., web resources, including any API, without resorting to any support from server nodes such as integration APIs. Theoretically, SWISC may provide a full coalition between all nodes of a data network within the scope of all accessible data and information through browsers. Metaphorically, SWISC may act as a universal and highly capable ‘dynamic integration API’ between nodes of a data network without the need of any API support from any node for integration.

SWISC synthesizes many basic interaction concepts from ‘web annotations’ to ‘user-script based augmented browsing’ or ‘decentralization’ to ‘API conformity’ and elevates them to a super-dimension where they can reach their true potential, e.g., in the form of ‘dynamic associations that establish adaptive procedural interactions between web objects of uncoordinated remote servers’ or in the form of ‘a versatile infrastructure that functions as a dynamic integration API, providing robust coalitions between unrelated—and even rival—servers globally’. Among the current state-of-the-art systems with respect to the above-mentioned concepts includes; Hypothesis™, as an example for advanced web annotation systems; or Greasemonkey™, as an example for advanced userscript based augmented browsing systems. However, there is no framework comparable to the disclosed framework, i.e., ‘Superimposed Communication Framework’, and there is no technology comparable to the disclosed technology, i.e., ‘Methods and Systems for Object-Aware Fuzzy Processing based on Analogies’, or as formerly named as ‘System for Superimposed Communication by Object-Oriented Resource Manipulation’, which constitute the technological foundation of SWISC.

iii) Stability and Sustainability—Cardinal Problem Related to the Envisioned Interactions: While the ability to develop and deploy super-objects tremendously enhances the interaction capabilities in decentralized data networks, it involves profoundly difficult scientific and technical problems to overcome. The fundamental problem of Superimposed Communication is ensuring the stability and sustainability of interactions between super-objects and web objects in all web environments within any scenario. This is a challenging problem since web environments are no longer static documents instead, they are mostly complex and dynamic user interfaces. Moreover, these environments are evolving further to become personally adaptive intelligent interfaces that provide personalized experiences to their users. For example, adaptive websites provide dynamically altering web pages—both contextually and structurally—according to each corresponding user, such as based on real-time sentiment analysis. On the other hand, even completely static web environments can be altered manually both structurally and contextually in time—and the level of these alterations can be dramatic. Therefore, ensuring the stability and sustainability of super-objects is a general problem for all environments. Indeed, it is merely an engineering problem to provide any interaction capability in absolutely static environments, i.e., environments where it is guaranteed that there will not be any significant alteration, such as an EPUB or PDF document.

The first half of the problem is maintaining an established association, e.g., between two web objects, in response to contextual and structural alterations. While the second half of the problem is adapting to the most recent state in response to contextual and structural alterations in the process of manipulating web objects—e.g., to which super-objects are associated. State-of-the-art web annotation systems—which particularly concerns only the first half of the problem—rely on object-based linking and searching, i.e., focusing solely on the object itself for linking and searching, which inherently leads to difficulties when tracking target objects in different configurations of document object models. Furthermore, struggling to identify a relatively complex object, such as a GUI, that has already transfigured—slightly or drastically—into another object in between states, generally ends with an orphan annotation or—more importantly—false annotation. Determination of conditions for maintaining or terminating an association between two objects is a multi-layered ontological problem. In this context, object-based linking, and processing is radically problematic and far from providing any concrete solution to the fundamental problem of ensuring stability and sustainability of interactions in response to contextual and structural alterations of web resources, either for super-objects, or for web annotations. In conclusion, state-of-the-art is inadequate to solve even the first half of the problem.

iv) Technology Concept—Basics of the Disclosed Solution: The web resource interaction system disclosed herein is a fuzzy interaction control system—with real-time computing properties—based on analogies, i.e., ‘System for Object-Aware Fuzzy Processing based on Analogies’, or as formerly named as ‘System for Superimposed Communication by Object Oriented Resource Manipulation’. In essence, the system ensures the establishment of stable and sustainable associations with web objects—including enabling them to be processed dynamically with full adaptability—based on similarity comparison of semantically extracted initial and current state analogue references of identified web objects through each individual client at each viewing/rendering in real-time. In this context, the system re-establishes or terminates associations according to corresponding similitude thresholds. If a connection is established, then the system utilizes the differentials of initial and current state analogue references of the associated objects to identify adaptation procedures. As detailed in the following sections, by this approach the system not only gains the ability to provide a robust dynamic linking mechanism but also gains the ability to provide a dynamic adaptation mechanism in response to contextual and/or structural alterations of resources of a decentralized data network within any possible scenario—including adversarial attempts of websites to confuse the system.

Said approach was developed based on the assumption that ‘all web pages—including static documents—has to be treated as contextually and structurally dynamic, complex, user specific interfaces rather than web documents’-since even the simplest static web document can be manually altered dramatically both contextually and structurally. Therefore, ‘tracking the web objects themselves in such environments to maintain associations and adaptations is fundamentally problematic’. In contrast, said approach neither relies on establishing object-based links, nor on object-based adaptation and processing. Rather, relies on object-aware analogue links and object-aware adaptation and processing—similar to that of analogue linking and processing of the cerebral cortex of the human brain. Said approach diverges radically from the conventional approaches. For example, because associations may be established based on the context of interactions between super-objects and web objects—due to the object-oriented nature of the technology—instead of objects themselves, any segment identifier, e.g., URIs of objects, may be totally ignored. Furthermore, in theory, even URLs of web pages or websites may be eliminated thus, resource identifiers may be totally eliminated in the processes of establishing and maintaining associations. Similarly, instead of developing particular interaction procedures for particular web objects themselves, interaction procedures may be developed according to the context of interactions between super-objects and web objects, such as a procedure with respect to a role and/or function of a web object. Compared to the state-of-the-art, said approach does not involve crawling, scraping, or archiving web resources; keeping track of states and activities; recording and re-constructing intended previous versions of document object models to identify the correct representations, etc. But most important of all, said approach does not involve orphan or false annotations as it does not involve object-based searching—therefore struggling—in between DOM states.

v) Generalized Methods and Systems for Object-Aware Fuzzy Processing based on Analogies—Beyond Web Resource Interaction: Beyond providing methods and systems for operations with respect to web resource interaction—thus paving the way for the realization of SWISC and all the advanced interaction capabilities involved—, the disclosed technology further provides generalized methods and systems for processing both virtual and physical objects. Furthermore, the disclosed technology provides ontological concepts emerging from the disclosed methods and principles such as transforming-objects, transforming-classes, and their analogue relationships, while providing advanced methods in this context. Accordingly, the disclosed subject matter has the potential to influence various fields of data science, from ‘data linking’ to ‘knowledge representation and reasoning’.

To recap, the current disclosure offers: i) A novel web-based interaction framework, i.e., ‘Superimposed Communication Framework’; ii) A next generation intelligent semantic web infrastructure, i.e., SWISC, envisaged to realize SFC; iii) A technological basis for the framework as a solution for the fundamental problems that the framework involves, i.e., Methods and Systems for Object-Aware Fuzzy Processing based on Analogies; and iv) A further technological basis for processing both virtual and physical objects i.e., Generalized Methods and Systems for Object-Aware Fuzzy Processing based on Analogies, including an ontology framework comprising transforming-objects, transforming-classes, and analogue relationships. On the whole, while providing a concrete solution to the fundamental problem of ensuring stability and sustainability of interactions, the disclosed subject matter inherently paves the way for more advanced interaction concepts—far beyond the concept of feature integration—, such as constructing networks of modular sub-systems—based on super-objects—that dynamically and coordinately manipulate web objects in order to realize a certain process in complex and dynamic environments of decentralized data networks.

Note1: An information space is the set of concepts, and relations among them, held by an information system. Note2: The terms ‘super-object’ and ‘user input’ are used interchangeably. Note3: The term ‘alteration’ is used in the meaning of any kind of change such as slight or drastic modifications, transformations, additions, deletions, etc. Note4: A superimposed application—which is a user generated software application associated with a web object—is a super-object. Similarly, a superimposed content—which is a user generated content associated with a web object—is a special case of a superimposed application that has a null set of instructions. Thus, a superimposed content is also a super-object or more precisely, a ‘passive super-object’. Note5: Super-objects may be created by human users, and/or machine users, and/or by the system itself. Note6: Creating modular sub-systems with super-objects that are associated with web objects of decentralized data networks is a novel concept that also comprises conventional content and feature integration. Note7: The system may provide its own APIs developed to communicate with ‘machine users’ (i.e., other computer systems), thereby enabling machine users to have the capabilities available to ‘human users’ and beyond.

### BRIEF DESCRIPTION OF THE FIGURES

FIG. 1 is a high-level architecture of an exemplary system, according to an embodiment;

FIG. 2 is a flowchart diagram illustrating an example process to identify and mark visual elements—of a rendered web page—that are associated with user inputs, i.e., super-objects;

FIG. 3 is a flowchart diagram illustrating an example process to classify each visual element, and identify each cluster of interrelated visual elements including corresponding function of each, in a rendered web page;

FIG. 4 is a flowchart diagram illustrating an example process to filter visual elements for interaction, and based on receipt of a selection by a user from among these filtered visual elements, to associate user inputs, i.e., super-objects, with selected visual elements of a rendered web page;

FIG. 5 is a flowchart diagram illustrating an example process to display metadata of user inputs, i.e., super-objects, to display content of user inputs, i.e., super-objects, and/or to execute program instructions of user inputs, i.e., super-objects, in connection with the corresponding visual elements of a rendered web page;

FIG. 6 is an exemplary user interface displaying a plurality of input markers (IM) and input metadata (IMD) of associated user inputs, i.e., super-objects, on a rendered web page;

FIG. 7 is an exemplary user interface displaying a user input, i.e., a super-object, corresponding to an input metadata (IMD);

FIG. 8 is an exemplary database record structure representing a database record for a user input, i.e., a super-object;

FIG. 9 is a flowchart diagram illustrating an example process that includes steps with respect to processing of/interacting with a rendered web page;

FIG. 10 is a high-level architecture of an exemplary system consisting of multiple servers deployed in various locations, according to an embodiment;

FIG. 11 is a diagram illustrating example modular sub-systems created by super-objects on the basis of web objects;

FIG. 12 is a flowchart diagram illustrating an example process that includes steps with respect to processing of/interacting with any virtual and/or physical object;

FIG. 13 is a high-level architecture of an exemplary system processing virtual and physical objects, according to an embodiment;

FIG. 14 is an example semantic network, i.e., knowledge graph, of an arbitrarily chosen ontology model involving objects, concepts, and their relationships;

FIG. 15 is an example semantic network—created based on the ontology model presented at FIG. 14—involving a ‘transforming object’ (t-object) and its relationships;

FIG. 16 is an example semantic network—created based on the ontology model presented at FIG. 15—involving further t-objects and their relationships;

FIG. 17 is an example semantic network—created based on the ontology model presented at FIG. 16—involving ‘transforming concepts’ (t-concepts) and their relationships;

FIG. 18 is an example semantic network, i.e., knowledge graph, of an arbitrarily chosen ontology model involving concepts and their relationships, extracted according to the standard ontologies;

FIG. 19 is another representation of the same ontology model presented at FIG. 18;

FIG. 20 is an example semantic network—created based on the ontology model presented at FIG. 18—involving t-concepts and their relationships according to the disclosed ontologies, wherein the t-concepts are the exemplary transforming correspondences of the concepts presented at FIG. 18;

FIG. 21 is a slightly altered version of the example semantic network presented at FIG. 20;

FIG. 22 is a generic similarity function of a bounded transforming-object (TO) with respect to a reference object—or base object—(O_{B}) in the context of a base concept—or base class—(C_{B});

FIG. 23 is a generic similarity function of a bounded transforming-object (TO) with respect to a reference concept—or base concept—(C_{B}) in the context of the same reference concept—or base concept—(C_{B});

FIG. 24 is a generic similarity function of a bounded transforming-concept (TC) with respect to a reference concept—or base concept—(C_{B}) in the context of the same reference concept—or base concept—(C_{B});

FIG. 25 is an example similarity function of a particular sequence of manifestations (TO₁) of a transforming object (TO) with respect to a reference concept (C_{B}) in the cartesian coordinate system;

FIG. 26 is an example similarity equation of a particular sequence of manifestations (TO₂) of a transforming object (TO) with respect to a reference concept (C_{B}) in the polar coordinate system;

FIG. 27 is a flowchart diagram illustrating an example process that includes steps with respect to identifying the context (C_{B}), root-object (O_{B}), and similarity threshold (ST) of a super-object; and

FIG. 28 is a flowchart diagram illustrating an example process that includes steps with respect to identifying associations between objects and super-objects and executing the corresponding set of instructions accordingly in an environment comprising both virtual and physical objects including virtual objects of resources of various data networks.

### DETAILED DESCRIPTION

### Superimposed Communication Framework—The Concept of Super-Objects:

At its simplest, a super-object is a user generated set of instructions, i.e., a user generated application, that process/manipulate the web object to which it is associated. Super-objects together with web objects constitute the building blocks in the framework of Superimposed Communication. By definition, a web object can be any component of a web resource from a single element, i.e., an elementary object, to a cluster of interrelated elements including the web resource itself as a whole. Thus, any web resource e.g., any web page or API, can be included in any process partially or wholly as a web object along with super-objects (provided that integration APIs or similar services are not used for any process related to ensuring stability and sustainability). In this context, super-objects that are directly associated with web objects constitute the most fundamental layer of the Superimposed Communication, and they are considered as first-order interactions with web objects or—shortly—first-order super-objects. For example, a first-order super-object may be programmed to dynamically process particular images in dynamic websites in order to convert them from 2D to stereo 3D.

Similarly, super-objects that are directly associated with first-order super-objects are considered as second-order interactions with web objects or second-order super-objects. For example, a second-order super-object may be programmed in association with the above mentioned first-order super-object—that converts 2D images to 3D—to enable users to annotate sections of 3D images with intelligent 3D post interfaces that can positionally organize the display of 3D annotations. However, if the adjunct super-object directly processes the web-object itself or its surrounding environment—such as adapting to the background to provide an improved user experience—then it is considered a first-order super-object. In principle, super-objects that are directly associated with n−1^{st} order super-objects are considered as n^{th} order interactions with web objects or n^{th} order super-objects. For example, a third-order super-object may be programmed in association with the above mentioned second-order super-object—that enable users to annotate sections of 3D images—to further process the annotations or annotated sections, such as to collect statistical data.

Furthermore, super-objects may be used as junction points and users may interact with each other through first or higher order super-objects that act as network links. For example, a super-object may be programmed to dynamically process certain articles on news websites to identify and indicate inconsistencies or fallacies, and to respond critically according to the revisions that publishers make—if they do so. Further, an adjunct super-object may be programmed in association with the first order super-object to enable users—including the publisher and the reviewer—to communicate with each other, such as through adaptive post & comment interfaces, regarding the claimed fallacies right on the spot. In this context, the Superimposed Communication Framework (SCF) also paves the way for web-wide social networking without borders—which herein referred to as Superimposed Networking. On the whole, the framework provides a multi-layered interaction environment, in which advanced modular sub-systems may be developed and deployed in association with any web object of a data network in any imaginable way.

FIG. 11 is a diagram illustrating example modular sub-systems created by super-objects on the basis of web objects. The illustrated environment 1100 includes a plurality of web pages, APIs, and super-objects. 1102 and 1104 are dynamic web pages of two separate websites; namely an online review publishing website and an online video sharing website respectively. 1106 and 1108 are dynamic web pages of an adaptive website; namely a multi-purpose super-website for messaging, banking, shopping, social networking, etc. Each of the web pages is illustrated with various web objects and the ones that are associated with super-objects are shaded in grey (1102a, 1102b, 1104a, 1104b, 1106a, 1106b, 1108a, and 1108b). 1110 and 1112 are APIs associated with 1104 and 1106 respectively. 1140 is a cluster of independent APIs provided by a third-party service provider. 1114, 1116, 1118, 1120, 1122, 1130, 1132, and 1134 are first-order super-objects. 1124, 1128, 1136, and 1138 are second-order super-objects and 1126 is a third-order super-object. Associations between first-order super-objects and web objects are illustrated with dotted lines (including a sine wave symbol at the middle) representing the fuzzy nature of associations. Associations between super-objects themselves are illustrated with solid lines representing the precise nature of associations. Note: Establishment of analogue associations between super-objects are also possible; for example, to establish associations between super-objects of two or more rival SCF infrastructures that are not in coalition.

According to an embodiment, the super-object 1118 is associated with the video player interface 1104a (shaded in grey on the web page 1104) of the online video sharing website in order to dynamically integrate advanced features to the interface to be effective within the entire website, such as a color corrector or a 2D to 3D convertor, while collecting statistical data regarding the content played, such as viewing rates per-video. The super-object 1114 is associated with the link preview interface 1102b along with the search engine interface 1102a (both shaded in grey on the web page 1102) of the online review publishing website in order to dynamically manipulate the interfaces to use them as a source for retrieving metadata about services and products including their ratings and reviews. Because both the super-objects 1114 and 1118 also act as APIs of 1102a, 1102b, and 1104a, the super-object 1128 is developed and associated with both of them as a universal port to collect data and information in regard to 1102 and 1104a. In this context, 1118 is further modified to utilize the data and information provided by 1128 in order to process and display corresponding ratings and reviews of the videos that are being played. Similarly, 1114 is further modified also to utilize the data and information provided by 1128 in order to process and include the statistics collected by 1118. Meanwhile, said video sharing and review publishing websites decide to use 1128 to improve their services.

The super-object 1120 is associated with the core page of a particular video, thus it is also associated with the link preview of said video appearing on the page 1104 (shaded in grey)—as a preference of its developer. The super-object 1120 comprises only non-executable content, i.e., comprises no instructions, thus serves similarly to a conventional annotation, such as a post, comment, or tag. The super-objects 1116 and 1122 are individually associated with the API 1110 which is a service provided by the video sharing website that publishes the web page 1104. The super-object 1122 particularly acts as a universal API, i.e., provides API conformity among different conventions, in regard to the API 1110. The super-object 1124 is developed and associated with 1118, 1120 and 1122 in order to integrate the features of 1118 and 1122 while using the content shared in 1120 as a data input, such as to initiate a sub-process, etc. The super-object 1126 is developed and associated with the super-object 1124 in order to further enhance its capabilities. Meanwhile, the super-object 1130 is associated with various graphical user interfaces 1106a, 1106b, 1108a, and 1108b spread over two web pages of another website (shaded in grey on web pages 1106 and 1108), in order to dynamically manipulate the interfaces as a whole. Essentially, these are dispersed segments of a previously singular graphical user interface with which the super-object 1130 is associated. In addition, the super-objects 1136 and 1138 are developed and associated with the super-object 1130 in order to enhance and expand its abilities by utilizing the API 1112 provided by the same website and the cluster of APIs 1140 provided by a third-party website, according to the embodiment.

### Complex Control Problem—Ensuring Stability and Sustainability:

Web resources have evolved from relatively static documents into dynamic user interfaces and are becoming increasingly complex both contextually and structurally. On the other hand, in contrast to the adaptive websites—which are at the complex side of the spectrum—even the simplest static web documents can alter dramatically in time manually. Furthermore, interaction possibilities are infinitely many, and interaction procedures can be extremely complex. To illustrate the complexity of the problem of ‘ensuring stability and sustainability of interactions between super-objects and web objects’, the simplest possible case of annotating a static HTML page with very basic components can be considered. Since web annotations are among the simplest interaction options requiring only the establishment of associations between user generated contents and web objects—without the additional processing of the web objects.

As an exemplary case, annotating a static ‘article page’ that is consist of only elementary web objects, i.e., web elements, namely, a header and a footer—as components of the page—, a heading, a couple of paragraphs, a picture, and a video—as components of the article—can be discussed. For example, users can annotate components of the page—in whole or in part—such as, annotating the footer, the video, one of the paragraphs, or a sentence in one of the paragraphs, etc. Or users can annotate arbitrary clusters in the page such as, annotating the heading, the video, and the footer as a group selected randomly. Or users can annotate meaningful or purposeful clusters of the page such as, the article as a whole, i.e., the cluster including all web objects related to the article such as the heading, the paragraphs, the picture, and the video—but, not extraneous content, such as ads or other links scattered in the article. Furthermore, users can annotate the objects of the page contextually, which can vary greatly from ‘exact contents’ to ‘roles and functions’ of singular or clustered elementary web objects. For example, users can annotate the article based on its content, or they can annotate the article regardless of its content. Consequently, despite the simplicity of the page, the interaction possibilities are quite rich. On the other hand, contextual and structural alterations—which can occur manually in a static page—further increase the difficulty and complexity of the problem.

For example, contents of the web objects can be altered slightly or drastically, and/or existing objects can be deleted, and new objects can be added. Further, relative positions of the elementary objects (i.e., elements) can be altered slightly or drastically, such as the layout of the components or the layout of the whole page can be altered. Further, object identifiers can be altered along with the previous alterations, and as a result, object model of the web page—such as the Document Object Model (DOM)—can be altered completely. Thus, the page can be altered deeply both contextually and structurally in various levels, and all of these alterations can occur simultaneously and rapidly. For example, paragraphs of the article can be modified grammatically, or attributes of the image and the video—such as the resolution and format—can be altered. Further, the article displayed in the web page can be rearranged so that the number of paragraphs can increase or decrease, or the image can be replaced with another one within the same context. Further, a new paragraph, image, or video can be added to the article that are out of context, e.g., hidden advertisement content meticulously inserted as if it was part of the article. Further, the position of the new paragraph, image, or video within the article can be altered, thus the structure of the article can be altered. Despite the simplicity of the page, alteration possibilities are also very rich, and these examples could be multiplied further.

On the whole, both the interactions and alterations that can occur even in a simple web document can be very diverse and challenging. Besides,—as mentioned above—web resources have evolved from static documents to highly capable dynamic user interfaces, and the scope of the interaction options aimed to be provided by super-objects is far more complex than web annotations.

In principle, the difficulty of ensuring the stability and sustainability of a super-object depends on the task, environment, and alteration, which is a complex control problem involving multi-layered ontological problems, i.e., problems concerning existence and existential assumptions of bonds between super-objects and web objects. For example, in what context will the association be established; in what conditions will this association be preserved or terminated; if the association is preserved, how the task will be performed according to the current state. In this context, ensuring the stability and sustainability of a super-object may be defined briefly as ‘controlling how that super-object interacts with exactly what’ and ‘maintaining that interaction despite contextual and structural alterations’ by adapting to said alterations during encounters in real-time. Furthermore, besides prospective interactions between interactive web objects and super-objects, some web objects—interactive or not—may react with intelligent metamorphoses or transfigurations to the super-objects that they are associated with—for example—to destabilize the associations. For example, contextual and/or structural alterations related to a GUI and its surrounding environment may be adversarial interventions designed to destabilize the super-object with which the GUI is associated. In this context, a number of assumptions have been identified:
1. Assumption: Integration APIs are assumed to be always insufficient and/or unreliable to ensure the stability and sustainability of first order interactions. Rationale: Most websites do not provide APIs for integration or what is provided may not be adequate and/or permanent. Approach: Process control based on observable, reachable, fetchable data and information of web environments.
2. Assumption: Web environments are assumed to be always highly dynamic, even if they are static. Rationale: Any static web environment, including the web objects within, can be manually altered, both contextually and structurally, at any time drastically. Approach: Real-time process control.
3. Assumption: Manifestations of web environments are assumed to be always unique and specific to users. Rationale: Most of the web environments are behind log-in-walls or paywalls, and exclusive to their users, and as a consequence different users have different access to web objects. Approach: Processing web environments through clients individually.
4. Assumption: Alterations in web environments are assumed to be always adversarial responses in order to destabilize super-objects. Rationale: In order to be able to adapt to any alteration in any scenario, it is essential to assume that websites will react to super-objects with cleverly designed alterations to destabilize them. Approach: Processing web environments to semantically identify each web object at each viewing/rendering of a client.

Consequentially, said assumptions can be ultimately combined and represented by a generalized assumption to constitute the fundamental axiom of the framework: Web objects are assumed to always undergo unpredictable transformations in-between manifestations. More concretely, a web-object is postulated to be a transforming-object—or a t-object in short—which is an object that is assumed to transform unpredictably between manifestations, appearances, or observations. Indeed, web objects can be intentionally programmed to alter unpredictably both contextually and structurally at each manifestation, thus can be programmed to transform unpredictably between manifestations—just like the magical shape-shifters or transformers. In the light of this assumption, the key design parameter is identified as follows: Ensuring the stability and sustainability of interactions, i.e., ‘controlling how super-objects interact with exactly what’, and ‘maintaining those interactions despite alterations’, in real-time, in a self-contained manner, in any environment—including extremely dynamic, extremely complex, and rapidly altering harsh environments—within any scenario, such as adversarial attempts of websites in order to destabilize the operations of the system.

### Design Parameters & Design Constraints:

To recap, web resources have evolved from static pages to dynamic user interfaces, and they are evolving further to intelligent user interfaces that are capable of adapting to their users individually, providing personalized experiences. As a result, most of the web resources are individualized, structurally complex and subject to frequent alterations both contextually and structurally. Furthermore, adversarial attempts of websites such as making specially designed alterations in web pages as an attempt to create confusion by/regarding contextual/structural alterations in the web page is a potential threat. Consequently, the system should be able to adapt to any web environment (e.g., static, dynamic, adaptive etc.) within any scenario (e.g., rapidly and/or drastically altering complex web environments including adversarial attempts), in real-time, in a self-contained manner. In this context, some of the identified design constraints and consequent design parameters are as follows:

i) Any approach based solely relying on pre-scanning, pre-analyzing, pre-organizing, or archiving web resources as a primary method for the processes regarding establishing & maintaining associations, adaptation, etc. must be eliminated. For example, keeping track of the states and activities of web resources by data crawling or scraping and utilizing the collected information in order to recover intended previous versions and/or identifying the correct representations of altered web resources may provide a historical record that omits relevant details/information. Instead, each visited web resource must be analyzed individually for each client at each viewing/rendering cycle. ii) Any approach based solely relying on collaboration with websites as a primary method in operations regarding establishing & maintaining associations, adaptation, etc. must be eliminated since the tools provided by websites, such as integration APIs, are often insufficient or generally no tools are provided. Besides, even if a fully competent API is provided, its continuity cannot necessarily be guaranteed. Instead, the system must be able to be self-sufficient, i.e., self-contained, by using observable, reachable, retrievable data, and information of web resources. iii) Any approach based solely relying on image processing, e.g., page view analyses based on computer vision algorithms, must be eliminated. To exemplify this argument, a web object designed to perform a complex function—such as a graphical user interface (GUI) that includes forms and tables designed to operate some sort of interactive operation with users—may be considered. In such a scenario, the system must essentially analyze the related codes/scripts in order to identify the complete process besides analyzing visual features and aspects of the GUI. Furthermore, said GUI can be altered in such a way that it does not maintain its structural integrity. For example, the GUI can be divided into structurally different sub-clusters that are also positioned discretely in the page, which as a whole perform the same operation. Or the simplistic case of a video, such as an educational video shared in an educational website may also be considered. In such a case, depending on the process to be performed by the super-object to be associated, it can be essential to analyze the video content partially or wholly. Furthermore, said video can be altered in such a way that it does not maintain its contextual integrity anymore. For example, the video can be re-edited without any reliable metadata regarding the context of the alteration. In such a scenario, the system must also analyze the altered video content in order to extract the context of the most recent version. Instead, each visited web resource must be analyzed in-depth—both contextually and structurally including machine-readable content such as HTML and JavaScript code—for each client at each viewing/rendering cycle individually.

Note1: A ‘design parameter’ is a ‘qualitative and/or quantitative aspect of a physical and/or functional characteristic of a system that is input to its design process’. Note2: A ‘design constraint’ is a limitations or restrictions in the design process imposed by internal and external factors. Note3: Regarding the first assumption, a web object is inherently identifiable and anything that is identifiable is observable. Therefore, ensuring the stability and sustainability of first order interactions is feasible in terms of observability without utilizing integration APIs.

Technology Concept—Object-Aware Fuzzy Processing based on Analogies:

According to the W3C standards, a web annotation is considered to be a set of connected web objects, e.g., digital resources, typically including a body and target, and conveys that the body is related to the target. Unlike a web annotation, a super-object conveys a model of a relationship between a body and a root object, to be used as a reference to establish dynamic associations during encounters with similar objects. More concretely, a super-object conveys: i) a reference for an analogy comprising one or more of the attributes and/or functions of a root object that is used to identify similar web objects to be associated with; and ii) a set of instructions—developed in relation to the root object—for dynamically processing analogous web objects—including predefined rules to be used in the process of determining the adaptation procedures. The analogue reference conveyed is then compared with the recently extracted analogue references of the web objects for identifying similarities—postulated to be valid within predefined similarity thresholds—during the rendering of a target environment—such as a singular web page or multiple pages of various websites—by a client. Once an association is established then the adaptation procedures are determined based on the interpretation of the difference between ‘the analogue reference of the root object’ and ‘the analogue reference of the associated web object’ at the moment of encounter. Regarding some major differences between said mechanism and existing paradigms and state of the art; Since a model of a relationship—between a body and a root object—is used as a reference to establish associations during encounters with similar objects, i) in theory, conventional resource identifiers, such as URIs, may be totally excluded from the process of establishing and maintaining associations, and ii) unlike web annotations, since there is no target object to search for, there are no residual super-objects (or orphan annotations) or—more importantly—false associations and executions.

To exemplify, according to an embodiment, in order to ensure the stability and sustainability of interactions, the system controls web objects to be interacted with by determining ‘what exactly the objects of web resources are’ at a contextual level and deciding ‘how super-objects may interact with them’ according to system-defined interaction rules. In this process, the system analyzes and interprets web objects contextually, e.g., according to roles, functions, or other distinctive features, including identifying and clustering interrelated elementary objects, i.e., web elements, in rank order and assigns each singular elementary object and each cluster of interrelated elementary objects an analogue reference with respect to the corresponding context, and decide on the interaction possibilities accordingly. Thus, a user may select a web object to manipulate and develop interaction procedures between the prospective super-object and the selected web object with the assistance of the system. In this process, once the development of an interaction procedure between a prospective super-object and a web object—such as a graphical user interface with a certain function, or a content with a certain context—is completed, the system records both the analogue reference of the web object (e.g., UVEI/s, UCFI, etc. as described in the following sections) and the interaction procedure regarding that object (e.g., a set of instructions to manipulate the web object) as encapsulated within the prospective super-object. Following this step, the system establishes the association between the prospective super-object and the corresponding web object by recording the super-object in a database. Similarly, once an interacted web resource is revisited and/or subsequently rendered, the system re-processes the entire operation of analyzing, interpretating and referencing in order to compare recently extracted analogues references of web objects with previously recorded analogue references—encapsulated within the super-objects—to identify similarities within predefined similarity thresholds. Therefore, the system identifies components, i.e., web objects, for re-establishing the associations with the corresponding super-objects. Following this step, the system adapts itself to the recent state of the components contextually according to the interpretation of the differences between ‘the analogue references of associated web objects’ and ‘the analogue references of the corresponding root objects’ at the moment of encounter. As a final step, for each associated web object, the system executes the corresponding modified interaction procedure accordingly. Thus, for example, the system may identify a contextually and structurally altered complex component possessing a steady function and adapt the interaction procedures to the recent structure within a contextually and structurally altered complex web page when revisited, according to the embodiment.

### Building Blocks—Objects & Elements:

In the context of the disclosed technology, web objects are used as building blocks, i.e., a base for reference, in the process of establishing associations. However, because the majority of web resources on the Web are web pages and which are mostly complex graphical user interfaces, according to various embodiments, visual objects are used as ‘base for reference’ for associating super-objects. Visual objects are objects on a web page that form the structure of the web page. According to Kudelka M et al. (2010); Visual objects are independent in their content, have an ability to be classified in the meaning of their purpose, and identifiable in terms of labelling a certain physical part of the web page. Visual objects carry some information to a user and as a whole perform certain functions. A visual object generally performs one or more of the four basic functions: A visual object may be i) informative (e.g., may provide some basic semantic content to users), ii) navigational (e.g., may have a hyperlink to guide users to another object), iii) interactive (e.g., may have an interactive tool for users to communicate with the system), iv) decorative (e.g., may include elements for beautifying a page). (Ref: Kudelka M et al. (2010) Visual Similarity of Web Pages. In: AINSC volume 67, Springer.) On the other hand, a web object is essentially either a web element or a cluster of interrelated web elements, wherein a web element is an elementary or fundamental object that is not composed of other objects. In this context, a visual object is essentially either a visual element or a cluster of interrelated visual elements. More concretely, an elementary visual object is a visual element, and a meaningful cluster of elementary visual objects is a cluster of interrelated visual elements—wherein a meaningful cluster of elementary objects is not an arbitrary cluster but a cluster with a definable/identifiable role and/or function. In this context, visual elements are the visual building blocks of a web page, and any visual element of a web page may be used as a reference for associating super-objects.

Visual elements are defined to facilitate the description of the systems and methods of the current subject matter. According to various embodiments, a visual element is an elementary visual field that includes ‘content’ and ‘visual aspects’ of a web page element. For example, in the case of rendering hypertext markup language (HTML) and cascading style sheets (CSS), when laying out a document (i.e., web page), the browser's rendering engine may represent each HTML element as a rectangular box according to the standard CSS basic box model. While ‘HTML element’ provides the content, CSS determines the position and properties (size, border size, background color, etc.) of these example boxes. In principle, each CSS box (i.e., visual element field) with its content (i.e., content of visual element) is a visual building block (i.e., visual element) of a web page. Accordingly, every HTML element may correspond to a visual element, which may be a—singular—CSS box (i.e., visual element field) that includes the content of the corresponding HTML element (e.g., English text, markup text, hyperlink, image, audio, video etc.). Further, the same may apply for other markup languages supporting CSS, such as XHTML, XML, XUL, SVG, etc. Regarding the positioning of visual elements; In a web page, a visual element may have a fixed position (e.g., relative to canvas) or may be positioned relative to other visual elements (e.g., CSS structures). For example, a cluster of interrelated visual elements (e.g., a GUI object) may be positioned in a framing visual element, and that framing visual element may be positioned relative to another visual element (e.g., container of the header). In the case of rendering HTML and CSS, the layout of a web page may be specified by CSS. A rendering engine may interpret each style sheet and calculate precise graphical coordinates of CSS boxes (i.e., visual element fields) for the visual representation.

To elaborate on the characteristics of a visual element, according to the embodiments, content of a visual element may be textual, or visual, or audial, or combinations thereof. Alternatively, or in addition, a visual element may include no content at all, i.e., a visual element with null content. A content may be included to a visual element by various methods, for example by transclusion, i.e., inclusion of the content by reference, or embedding the raw data of the content into markup. Textual content of a visual element is character content that may be: i) text for humans (e.g., a paragraph of an article), and/or ii) text for machines (e.g., markup/script). Visual content of a visual element is any visual content excluding text (e.g., an image, an image sequence, a video without sound, etc.). Audial content of a visual element is any audial content (e.g., an audio file, a radio stream, etc.). A visual element may simultaneously contain textual, visual, and audial contents individually (e.g., a visual element may contain an image, an embedded invisible hyperlink, and a text simultaneously), or a visual element may contain textual, visual, and audial contents in a single pack (e.g., a single multimedia file containing text, audios, images, animations, videos, etc.). On the other hand, although a visual element with null content has no content at all, its field (i.e., visual element field) has properties such as, size and shape of the field, color and thickness of the border, color of the background fill, etc.

Note1: Although a textual content can be physically classified as a visual content, it is separated for clarity and simplicity. Note2: Besides the standard visual and audial interfaces, a computer system may also involve special interfaces such as, haptic or olfactive interfaces, and accordingly a visual element may also include other types of content according to data to be decoded. Note3: The web resource interaction system is not limited with the use of visual elements as landmarks/references. Embodiments may use any element of a web page as a landmark/reference for associating super-objects. However, to provide a clear description example embodiments described herein mainly use visual elements and/or clusters of visual elements as landmarks/references for associating super-objects. Note4: Elements, i.e., fundamental objects that are not composed of other objects, may vary from framework to framework. For example, while for CSS, each style sheet including its content—obviously excluding any other contained/framed style sheet and its content, if any—may be defined as a visual element, in another framework each individual pixel may be defined as a visual element.

Expanding upon this introduction, the description of the methods and systems presented herein progresses gradually from associating user generated contents with web objects (i.e., associating non-executable—passive—super-objects with web objects) to associating user generated applications with web objects (i.e., associating fully functional executable super-objects with web objects) including adaptation and execution processes of said super-objects within any scenario. Further, in the last part of the description, generalized methods and systems related to the disclosed technology—beyond web resource interaction—are described and exemplified.

The web resource interaction system disclosed herein is a fuzzy interaction control system—with real-time computing properties—based on analogies, includes a computer implemented method, a computer system, and a non-transitory computer readable medium. According to various embodiments, in brief, the computer implemented method and the computer system comprises/configured to perform the following processes: i) Analyzing a web page that a user is viewing, and identifying each visual element, i.e., extracting distinctive information about content—if any—, information about distinctive properties—if any—, relative position information of the corresponding visual element, and exact location information (e.g. URL) of the web page where the corresponding visual element belongs to. For each visual element, generating a uniform visual element identifier (UVEI) (i.e., an element identifier that includes distinctive information about content—if any—, information about distinctive properties—if any—, relative position information of the corresponding visual element, and exact location information of the web page where the corresponding visual element belongs to). Based on the analysis of the UVEIs, ii) Classifying and clustering visual elements (i.e., identifying the role/function and cluster information (CI) of each visual element, wherein clustering is based on positional and/or functional relationships of visual elements, and further, identifying the role/function of each cluster of interrelated visual elements and assigning a ‘uniform cluster function identifier’ (UCFI) for each of them as a contextual reference to be used for establishing associations with a cluster of interrelated visual elements besides the UVEIs of the visual elements belonging to the cluster). Based on the identified role/function of each visual element, and/or the identified role/function of each cluster of interrelated visual elements, iii) Deciding on interactions according to said interpretations of visual elements and predefined interaction rules (e.g., filtering visual elements for interaction according to a predefined filtering/decision criteria, wherein the filtering/decision criteria is based on context such as roles/functions of singular or clustered visual elements, {as clusters of interrelated visual elements according to their ‘positional’, or ‘positional and functional’ relationships}, and enabling filtered visual elements for interaction and disabling the remaining visual elements), and further indicating visual elements that are available for interaction with a visual indicator for selection by a user. Based on receipt of selection by a user of one of the filtered visual elements or visual element clusters, iv) Assisting the user for generating contents or applications that dynamically process/manipulate visual elements and/or clusters of visual elements, and further, setting adaptation rules for each corresponding user generated application in coordination with the user. Based on receipt of a user generated content or user generated application, v) Associating the user generated content or user generated software application with the selected visual element or visual element cluster (i.e., storing the user interaction, e.g., user generated application, with one of the visual elements or one of the clusters of visual elements as user input, i.e., super-object, in association with one of the UVEIs or with one of the sets of UVEIs, wherein each set represents the corresponding one of the clusters of visual elements, and further, if interacted web object is a cluster then storing the corresponding one of the uniform cluster function identifier (UCFI) within the user input record, i.e., super-object record). When the interacted web page is visited by another user and/or when the web page is subsequently rendered, processing the steps i and ii for the web page; Based on new uniform visual element identifiers (nUVEIs) generated, including each corresponding class and cluster information, and based on uniform cluster function identifiers (nUCFIs) generated, vi) Identifying associations based on analogue references and similarity comparison (e.g., comparing the nUVEIs with UVEIs stored in the database as recorded UVEIs (rUVEIs), and associating the nUVEIs with the rUVEIs based on a predefined threshold of similarity, and/or comparing the nUCFIs with UCFIs stored in the database as recorded UCFIs (rUCFIs), and associating the nUCFIs with the rUCFIs based on a predefined threshold of similarity). Further, adapting to the most recent state of each cluster of interrelated visual elements according to each user generated application associated by comparing the initial state representations constructed based on rUVEIs, and the most recent state representations constructed based on nUVEIs of the cluster in order to identify a procedure to adapt the respective execution procedures of the associated applications to the most recent state according to a predefined set of adaptation rules corresponds to each user generated application. Based on the identified associations, viii) Displaying metadata and content of user generated contents, and executing user generated software applications, and further connecting system users with each other through user generated contents and/or user generated software applications that act as network links on web pages, according to the embodiments.

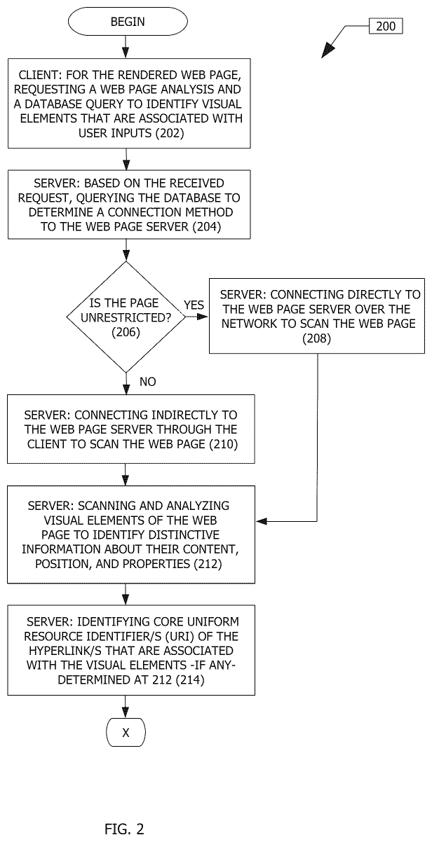

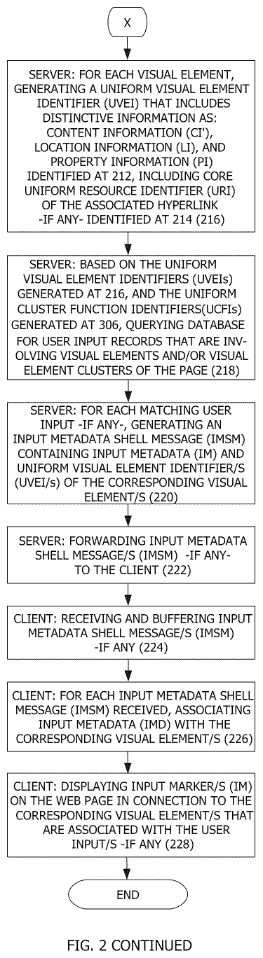

A detailed description of the web resource interaction system is presented through various examples, description and embodiments provided herein. According to various embodiments, the system includes a browser-based application at the client-side, that works in collaboration with an application server and a database server at the server-side. Client-side application, i.e., the client, in collaboration with the server-side application, i.e., the server, may perform processes within the system for enabling interaction of super-objects and/or users with elements of web pages and/or with other super-objects and/or users, on a data network. As described herein, FIGS. 2-5 provide respective example flowchart diagrams 200, 300, 400 and 500, which are configured to minimize the data processing load of the client-side, while maximizing the data processing load of the server-side. In other examples, other configurations are possible regarding the allocation of the processing load between client-side and server-side, including maximizing the processing load of the client-side, and minimizing the processing load of the server-side.

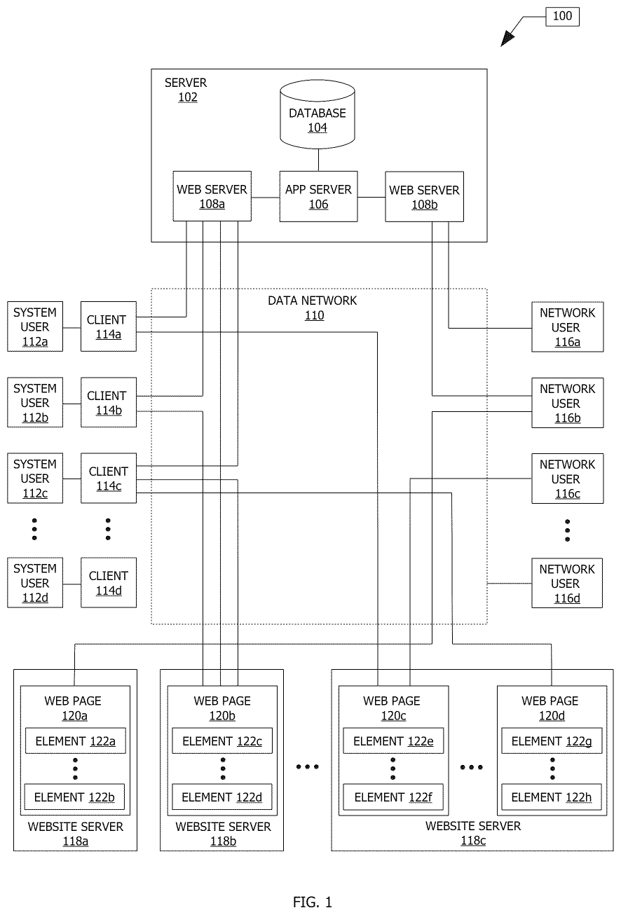

FIG. 1 is a high-level architecture of an exemplary web resource interaction system 100. The system 100 shown is a configuration for illustrating the functionality with exemplary components and architecture. One of ordinary skill in the art will appreciate that the system may include other features, components and/or modules to illustrate the functionality described herein and is not limited to the components and architecture illustrated in FIG. 1.

The server 102 of the system 100 includes—or has access to—the database 104 (including the database server), the application server 106, and two separate web servers 108a and 108b. The data network 110 may include gateways, routers, other servers, and clients, etc. which are not shown. The system 100 includes N number of system users (112a, 112b, 112c, 112d) and their clients (114a, 114b, 114c, 114d), respectively. For example, the client 114a is the client of the system user 112a. The system 100 also includes a plurality of network users. Four of the M number of network users (116a, 116b, 116c, 116d) are shown in FIG. 1. A network user may refer to a data network user who is not a system user. According to various embodiments, a system user is also a network user, but a network user is not a system user. The system 100 include a plurality of website servers. Three of the K number of website servers (118a, 118b, 118c) are connected to the network 110 are shown in FIG. 1. The website server 118a is shown with a first web page 120a, which also includes L number of visual elements. Two of the L number of visual elements are shown as 122a and 122b. The website server 118b is shown with a second web page 120b, which also includes H number of visual elements. Two of the H number of visual elements are shown as 122c and 122d. The website server 118c may be a server of a social media network (e.g., Facebook, Twitter, Instagram, etc.). The website server 118c may store P number of web pages including a third web page 120c and a fourth web page 120d. Web pages 120c and 120d may be social media user pages which include various visual elements. Four of the W number of visual elements are shown as 122e, 122f, 122g and 122h. Clients 114a to 114d are uniform client-side applications working on the web browsers of the system users 112a to 112d, in collaboration with the server-side application, i.e., the application server 106. Web servers 108a and 108b are connection ports of the server 102 to the data network 110. The web server 108a is dedicated for the system users (clients), while the web server 108b is dedicated for the network users. In addition to these, all user inputs of the system 100 also have their own accessible conventional web pages (not shown). Network users may reach to these web pages, if there is no restriction put in place by the system user who created the associated user input. System users also have accessible home pages within the system 100, similar to the conventional social media websites where the posts of a system user are listed on a personal home page.

Network user 116a is connected to the server 102. Network user 116a may be browsing web pages containing user inputs of the system 100 or may be interacting with particular user inputs of a system user. Network user 116b is connected both to the server 102 and the web page 120a. Network user 116c is connected to the web page 120c only and not related with the system 100. Network user 116d is connected to the network 110 but not connected to the system 100 or any other web page shown.

Client 114a is connected to the server 102 and the web page 120c of the website server 118c. The web page 120c is a social media user page which is open to a closed subgroup only. While the client 114a has permission to reach to the web page 120c, the server 102's access is prohibited. The system 100 scans (probes) the web page 120c indirectly through the client 114a, i.e., the system uses the client 114a as a data link between the server 102 and the web page 120c. Thus, the server 102 may scan the source code of the web page 120c and/or communicate with the website server 118c to retrieve information about hyperlinks and visual elements associated with the web page 120c, such as 122e or 122f.

Client 114b is connected to the server 102 and the web page 120b of the website server 118b. The web page 120b is accessible by any network user including the system users (e.g., a news website). The server 102 is connected directly to the web page 120b known to be unrestricted for all network users with intent to reduce the data transfer load of the client 114b. In this case the system 100 scans (probes) the web page 120b directly. Thus, the server 102 may scan the source code of the web page 120b and/or communicate with the website server 118b to retrieve information about hyperlinks and visual elements associated with the web page 120b, such as 122c and 122d.

Client 114c is connected to the server 102, the web page 120b of the website server 118b, and the web page 120d of the website server 118c. The web page 120d is another user page which is not accessible by all network users. On the other hand, the web page 120b is accessible by any network user including the server 102. While the server 102 is indirectly connected to the restricted web page 120d through the client 114c, it is connected directly to the web page 120b, known to be unrestricted for all network users. Thus, the server may scan the source code of the web pages 120b and 120d and/or communicate with the website servers 118b and 118c to retrieve information about hyperlinks and visual elements 122c, 122d, 122g and 122h associated with the web pages 120b and 120d.

The system user 112d and the corresponding client 114d are not connected to the network 110. They are passive members of the system 100.

Within the communication structure of the system 100, and via the execution of the example methods 200, 300, 400 and 500 explained below, system users 112a to 112d may associate user inputs with the visual elements 122a to 122h of the web pages 120a to 120d and set up a superimposed social network on the web pages of the data network 110 through user inputs that act as network links. Similarly, system users 112a to 112d may reach to any user input that is associated with the objects of web pages of the data network 110. However, a network user who is not a system user may also connect to the system through a client that acts as a proxy server. In one embodiment, one of the clients of the system is used as a proxy server at the system, in which some of the network users, who are not system users, are connected to the system through this client and immediately become system users.

To elaborate the concept of superimposed networking: Any system user, who is connected to the data network 110 via a client, may be interconnected with other system users through the data network 110 via communication protocols (e.g., TCP/IP), and various user interfaces. In this context, user inputs possessing communication modules and interfaces may connect users with each other for communication, and user inputs may act as network links of an overlay social network on web resources of a data network. For example, users may communicate through commenting, messaging, reacting interfaces deployed on user inputs, while adding some of the authors of the user inputs and/or comments on the user inputs to their follow list or friends list and join each other's social network. Therefore, system users may set up an overlay social network on web pages and connect with each other across the data network that the web resource interaction system is included in. Accordingly, each user generated content or application that is associated with objects of web pages, may become a junction point connecting users. Furthermore, a system user may connect to the publisher/developer (e.g., author) of a user input through the corresponding user input via particular interfaces. For example, a user who is an author may have a unique user identifier stored in the database record of his/her user input, which is associated with one or more visual element/s of a web page, such that rendering of the web page displays the user identifier as available to another user who may provide a connection request to the web page (e.g. through a system's user interface displayed on the web page) to initiate communication (e.g. P2P communication). Furthermore, interaction through a user input may be allowed to all users or may be restricted for use by a closed subgroup only, thus, sub social groups may be formed.

For brevity, the web server 108a and the application server 106 are together hereinafter referred to as ‘server’, and the database server with the database 104 are together hereinafter referred to as ‘database’.

FIG. 2 is a flowchart diagram 200 illustrating an example process to identify and mark visual elements—of a rendered web page—that are associated with user inputs.

The process begins with the manifestation/presentation of a web page by the web browser of a system user. At 202, for the rendered web page, the client requests a web page analysis and a database query from the server to identify visual elements that are associated with user inputs. Next, based on the received request, the server queries the database to determine a connection method in order to communicate with the web page server and scan the web page (204). In some embodiments, the server may connect directly to the target web page over the data network. In yet other embodiments, the server may connect indirectly to the target web page via linking up through the client, i.e., using client as a data link. Indirect connection is always reliable, because server may not have access to the target web page (e.g., the target web page may be a social media user page accessible to a closed subgroup only), or may have limited access, or there may be some restrictions for ordinary network users or for the system user itself. On the other hand, for various reasons such as reducing the data transfer load of the system user, the server may directly connect to the web pages known to be unrestricted for all network users (e.g., news websites, government websites, e-commerce websites, etc.). For this purpose, the system may use an URL list of unrestricted websites and may decide between direct or indirect connection by comparing the URL of the target web page with the URLs of the websites, i.e., domain names, in the list. In one embodiment, the server scans the unrestricted website list (UWL) for a match with the URL of the target website (204). Unrestricted website list (UWL), which includes the URLs of the websites that are known to be unrestricted for all network users (e.g., CNN.com, BBC.com, etc.), may be generated and updated manually and/or by software algorithms working under the system.

Next, the server decides the connection method (206). If the target web page is unrestricted then the server connects to the target web page directly over the network to scan the web page directly (208). If the target web page is restricted, then the server connects to the target web page indirectly through the client to scan the web page indirectly (210). According to an embodiment, the server prefers to connect to any web page server indirectly only, because the indirect connection method provides a reliable communication mechanism for all cases and may be preferred if extra data transfer load of the client is not a concern.

At 212, based on the source code (which may specify the content, layout, and structure of the web page, and may define the meaning of each element) and/or any information retrievable from the web page server, the server scans the rendered web page and analyzes each visual element to identify distinctive information about its content, position, and properties, in order to generate a visual element identifier. Content of a visual element may be a text, an image, an audio, a video, a hyperlink, an application etc., and the source code may contain the content itself (e.g., a container including a text and a hyperlink) or the identifier/locator of the content for retrieving it from the website server (e.g., a container including an image or a video). Position of a visual element on a web page is the relative position of the visual element according to other visual elements. Properties of a visual element varies, e.g., size, shape, border width, background color, etc. of the visual element field. Content and properties of a visual element are solid references for identification in most of the cases. However, in some cases, relative position information may be the only reference to identify a visual element since position of a visual element is always distinctive,—as long as content, and/or layout, and/or structure of the web page does not alter in a way to invalidate it. For example, there may be multiple visual elements with identical properties and content. On the other hand, there may be cases where the position itself may not be sufficient to identify a visual element. For example, layout of web page may be changed in time. Accordingly, a visual element of a web page may be identified more accurately by referencing all variables (i.e., content, relative position, and properties) simultaneously, or one of them individually, or in any combination that fits the needs of the application.

Next, the server analyzes the resource identifiers (e.g., URLs) of the hyperlinks that are associated with visual elements—if any—determined at 212, and identifies the core resource identifiers (e.g., core URLs) (214). Core resource identifiers are resource identifiers of hyperlinks isolated from the additional extensions, e.g., subsequently added auxiliary extensions by search engines.

Next, for each visual element, the server generates a uniform visual element identifier (UVEI) that includes distinctive information about content—if any—, information about distinctive properties—if any—, and relative position information of the visual element identified at 212 including exact location information (e.g., URL) of the web page (216). The server also assigns an ID for each uniform visual element identifier (UVEI) generated. In one embodiment, a uniform visual element identifier (UVEI) of a visual element includes: i) A sample of the content, an attribute of the content (e.g., the media type) and the associated URI of a hyperlink—if any—determined at 212, as the content information (CI′); ii) Resource identifier of the web page (e.g., URL) and relative position information of the visual element with respect to other visual elements determined at 212, as the location information (LI), iii) Information about the properties of the visual element field determined at 212, as the property information (PI). While distinctive information about the position and location, i.e., ‘relative position’ and ‘exact location’, always exists (at least in the moment of rendering), ‘distinctive information about content’ and ‘information about distinctive properties’ of a visual element may or may not exist. In this context, for example, a uniform visual element identifier (UVEI) within the CSS structure may include: i) ‘null content’ as content information (CI′); ii) CSS properties such as style sheet dimensions and color, as property information (PI); iii) URL of the web page and the relative position information of the style sheet, as the location information (LI). In such a case, LI is the only distinguishing parameter if there are other elements with exactly the same PI, i.e., CSS properties, in the source. According to another embodiment, uniform visual element identifier (UVEI) may also include core resource identifier (e.g., core URL) of the associated hyperlink isolated at 214, for example, i) Core URL of the hyperlink K of visual element Z; ii) URL of web page Y of website X, and relative position information of visual element Z on web page Y; iii) Property A and B of visual element Z, according to the embodiment.

Next, based on the uniform visual element identifiers (UVEI) generated at 216, the server queries the database for user input records that are involving visual elements and/or hyperlinks—if any—of the web page (218). Thus, the server queries the database for identifying matches between new UVEIs (i.e., nUVEIs) and recorded UVEIs (i.e., rUVEIs) of the user input records that are including the locator (e.g., URL) of the web page in the rUVEIs, based on various comparison methods such as relative position comparison and/or comparison based on similarity analysis of contents, etc. Further, based on the uniform cluster function identifiers (UCFIs) generated at 306, the server may also query the database for user input records that are involving visual element clusters of the web page. In this context, for example, based on a functional similarity comparison, the server queries the database for identifying matches between new UCFIs (i.e., nUCFIs) and recorded UCFIs (i.e., rUCFIs) of the user input records that are associated with the web page. Process 300 may be executed after the execution of 216 where the UVEIs are generated, thus, following the execution of process 300, process 218 may be executed, according to the embodiments.

In some embodiments, only one visual element may be associated with a user input if the user input is a user generated content, while one or more visual elements may be associated with a user input if the user input is a user generated software application. In this scenario, for user generated contents, the server may include contents partially in the UVEIs as the content information (CI′) by a predefined sampling procedure, for each UVEI generated at 216, and the server may execute a similarity comparison between the sampled contents included in the recently generated UVEIs (nUVEIs) at 216 and the sampled contents included in the recorded UVEIs (rUVEIs) of the rendered web page, which may represent interacted visual elements in the rendered web page. In other words, user input records may be stored to include the UVEIs of interacted visual elements which a user has interacted with to add user input thereto, e.g., into the database record of a user input. In addition, the server may also query database records for a match between the hyperlinks detected at 212 and interacted web pages, i.e., web pages associated with one or more user inputs. In this process, core URLs of the hyperlinks determined at 214, are compared with the URLs of the interacted web pages recorded in the database. Within an example scenario, for user generated software applications, the database may be also queried according to the cluster information (CI)—that is identified in process 300 according to positional and functional relationship of visual elements—besides the uniform visual element identifiers (UVEI) of the interacted visual elements. In this process, for each record of a user input associated with the web page, recently extracted cluster information (CI) is compared with the cluster information (CI) (or the portion related with the interacted cluster) that is recorded in the database in process 400, i.e., rUVEIs belonging to an interacted cluster are compared with each set of nUVEIs that belong to each identified cluster. —It should be noted herein that this comparison technique may be optimized by various sub-methods, such as preliminary image analyses based on computer vision techniques in order to eliminate irrelevant cluster pairs in the process of similarity comparison. In the process of identifying interacted clusters, cluster information (CI)—along with other information obtained at 300 such as, subjective function type (SFT), etc.—is used as a reference, in order to maintain the associations in case of occurrence of contextual and/or structural alterations in interacted clusters. Alternatively, or in addition, based on the uniform cluster function identifiers (UCFIs) generated at 306, the server may also query the database for user input records that are involving visual element clusters of the web page, i.e., querying the database for identifying matches between new UCFIs (i.e., nUCFIs) and recorded UCFIs (i.e., rUCFIs) of the user input records that are associated with the web page, based on a functional similarity comparison, according to the embodiments. In various embodiments, both user generated contents and software applications may be associated with singular visual elements, such as images, videos, paragraphs, or with clusters of interrelated visual elements, such as, link previews, social media posts, media players, tables, lists, articles, headers, footers, other predefined clusters etc.

Next, for each matching user input—if any—, the server generates an input metadata shell message (IMSM) containing input metadata (IMD), i.e., metadata of the user input, and uniform visual element identifier/s (nUVEI/s) of the corresponding visual element/s of the rendered web page (220).

Next, the server forwards input metadata shell messages (IMSM) to the client—if any (222). At this phase, no other information about the content of the user inputs is sent to the client. Thus, the process gains speed by decreasing the data transfer load. According to an embodiment, input metadata (IMD) contains brief information about the associated user input stored in the user input records of the database, e.g., publisher, heading, summary, popularity score, rank etc. of the user input. Next, the client receives and buffers input metadata shell messages (IMSM)—if any (224).

Next, for each input metadata shell message (IMSM) received, the client associates input metadata (IMD) with the corresponding visual element/s of the web page being rendered for the user (226).

Next, the client visually displays input markers (IM) on the web page in connection to the corresponding visual elements and/or clusters of visual elements that are associated with the user inputs—if any—in order to indicate the availability of the user inputs for user access (228). According to various embodiments, user input markers (IM) may be transparent, miniature, and/or inconspicuous icons marking discrete visual elements and/or clusters of visual elements of the web page in a manner which does not impede the usage of the web page. In one embodiment, the client places input markers (IM) at only certain points within visual element fields, e.g., top right corner of a visual element field. Thus, input markers (IM) may be integrated with the web page's sense of balance and esthetics due to their association with visual element fields. In case of a cluster of interrelated visual elements,—which are identified in the process 300—, the marker may be placed at a predetermined position, such as a top right corner, of the visual element field that is enclosing the group—if any. Else, the client may create a virtual frame that is enclosing the cluster of interrelated visual elements and mark it by the same way. Moreover, appearance of the input markers (IM) in an embodiment may vary and particular input markers (IM) may be used for particular user inputs. For example, in embodiments, while ordinary user comments that are associated with a visual element are marked with a circular input marker (IM), expert user comments associated with the same visual element are marked with a triangular input marker (IM) separately. Regarding the method of manipulation, client may change the source code of a page to include markings, or the browser may be programmed to mark the relevant positions without changing the source code. In case of HTML, the client may utilize DOM (Document Object Model) of the web page to manipulate the web page without changing the source code, according to the embodiments.

The process terminates after the execution of 228 unless the page is an infinite scrolling web page. In case of an infinite scrolling web page, for every additional manifestation of the web page the process loops between 212 to 228, i.e., all sub processes are executed in sequential order starting at 212 and ending at 228. As a result of the process 200, the client, in collaboration with the server, identifies and marks visual elements and/or clusters of visual elements that are associated with user inputs—if any—, according to an embodiment.

To elaborate on the process 200, i.e., the procedures to identify visual elements that are associated with user inputs in a rendered web page, and the primary function/purpose of the uniform visual element identifier (UVEI) concept: According to the embodiments, there may be two phases of identifying visual elements, and whenever a web page is rendered by a browser of a client, these procedures may be executed specifically for that client: Phase 1) ‘Analyzing a web page that a user is viewing, and identifying each visual element; for each visual element, generating a uniform visual element identifier (UVEI) that includes distinctive information about content—if any—, information about distinctive properties—if any—, relative position information of the corresponding visual element (e.g., with respect to neighboring visual elements), and exact location information (e.g., URL) of the web page where the corresponding visual element belongs to. An UVEI identified in the phase 1 may also be called as ‘new UVEI’ or ‘nUVEI’, which is a temporary reference of a visual element particular to the viewing session of a rendered web page of a client. An nUVEI becomes a recorded UVEI (i.e., rUVEI) and becomes stationary, if it is recorded in the database (e.g., in a field of a user input record) to associate a user input with the corresponding visual element. Phase 2) ‘Based on uniform visual element identifiers (UVEIs) of visual elements identified in phase 1 (i.e., nUVEIs), i) identifying visual elements that were previously interacted by comparing nUVEIs with rUVEIs stored in the database, and/or ii) identifying role/s of each visual elements and/or iii) identifying clusters of interrelated visual elements, and/or iv) identifying visual elements that are available for interaction. According to the embodiments, for each visual element, a uniform visual element identifier (UVEI) is generated in each viewing session of a client, because a stable reference—independent of source code dictated by website servers—is required, since content, and/or layout and/or structure of a web page (i.e., source code) may be altered—manually (e.g., by website admins) and/or automatically (e.g., by executing scripts/programs)—in progress of time, and such alterations may result in loss of association between the interacted visual elements and their corresponding user inputs associated therewith and stored in the database records. For example, element attributes may be changed in such a way that alteration invalidates a locator strategy. Accordingly, methods such as anchoring based on element IDs, or executing conventional fragment identification systems, may not work properly. Moreover, alterations can be done deliberately to jam such systems by more advanced procedures. For example, content of some visual elements of a web page may be altered in such a way that altered content (e.g., pictures, videos, etc.) may be identifiable only by the detailed analysis of the content itself. Consequently, any system depending on the identification of interacted visual elements based on source code of web pages is inevitably prone to loss of associations or false associations between the time the web page elements are interacted, and corresponding web pages are re-rendered. For example, associations may be lost, or user inputs may be associated with irrelevant visual elements. In principle, the UVEI serves as a stable reference to maintain that association by holding/containing any possible distinctive information about content and properties, and also relative position information of each visual element with respect to other visual elements. Thus, the UVEI creates a base for various locating/identifying strategies and procedures.

To elaborate on the subject of distinctive information about content of a visual element: According to the embodiments, distinctive information about content of a visual element may be the type of the content (e.g., media type), and/or general properties of the content (e.g., type, size, etc.), and/or the content itself,—and which can be considered a reliable reference for most of the cases if the extra data processing load is not a concern. Accordingly, a uniform visual element identifier (UVEI) of a visual element may include the content—of the visual element—itself partially or wholly as a reference for comparison. For example, if the content of a visual element is a text, a hyperlink, a script, or an image, then it may be included in UVEI directly. For larger files (e.g., audio or video files) where the data processing load may be a concern, general properties of the content (e.g., type, size, etc.) may be used in combination with the properties of the visual element. Furthermore, content—of a visual element—may be included in its UVEI partially, and sampling techniques may be used for estimation/approximation of the content, such as interpolation. On the other hand, not all visual elements do possess distinctive content. For example, in a web page, there may be multiple visual elements with identical content.

To elaborate on the subject of distinctive information about the properties of a visual element: According to the embodiments, distinctive information about properties of a visual element may be any property (e.g., shape, size, background, padding, border, margin size, etc.) of the visual element that are unique among all visual elements of a web page (e.g., a unique background color, size, font, etc.). For example, the size of a canvas element of a web page is a distinctive property for most of the cases since it contains all visual elements of a web page. On the other hand, not all visual elements possess distinctive properties. For example, in a web page, there may be multiple visual elements with identical properties. In the case of CSS, properties of a visual element field is as follows: animation properties, background properties, border properties, color properties, dimension properties, generated content properties, flexible box layout properties, font properties, list properties, margin properties, multi-column layout properties, outline properties, padding properties, print properties, table properties, text properties, transform properties, transitions properties, visual formatting properties, etc.

To elaborate on the subject of relative position information of a visual element: According to the embodiments, ‘relative position information’ and ‘exact location information’ of a visual element includes position of the visual element relative to other visual elements in a rendered web page, and the URL of the rendered web page that it belongs to. Unlike content and properties of a visual element, relative position information is always distinctive as long as content and/or structure of the web page does not alter in a way to invalidate it. In one embodiment, positioning rules of visual elements included in the string of relative position information of UVEIs are similar to the ones in the style sheets of CSS.

To elaborate on the subject of distinctive information in general: According to the embodiments, distinctive information about content, information about distinctive properties, relative position information, and exact location information that are all included in UVEI may be used in several combinations for associating/identifying interacted visual elements, according to needs. In all cases, ‘exact location information’ is essential,—even if the relative position of the visual element alters—, since it includes locator (URL) of the web page that the visual element belongs to. On the other hand, there can be special cases where content, properties, and relative position information of a visual element—all together—cannot be sufficient to identify the visual element depending on the level of alteration of content, and/or layout and/or structure of a web page. For example, there can be multiple visual elements with identical properties and content in a web page, where relative positions of visual elements alter frequently. Accordingly, maintaining associations in between interacted web page elements and their corresponding user inputs may not be possible in some special cases.

To elaborate on the possible identifying strategies: According to various embodiments, content of visual elements (which may be stored in the database within a corresponding UVEI generated by the system), may be used partially or wholly (e.g., depending on data size) as the primary reference for locating/identifying visual elements that are interacted, besides (or in addition to) the URL of the web page that the visual elements belong to. In this regard, content of a visual element may be included—partially or wholly—in the corresponding UVEI as the distinctive information about content. In embodiments, for associating user inputs with visual elements, and identifying visual elements that are associated with user inputs in web pages that are viewed by users; the system collects content fragments from visual elements that include media files, such as images, videos, audios, documents, etc. by appropriate sampling procedures particularly selected according to content properties (e.g., media type, size, format, etc.) of each visual element, and include collected content fragments to the corresponding UVEIs as the distinctive information about content, in order to reduce the data processing load. In this process, for content located in website servers (e.g., documents, videos, audios, or any kind of streaming media) the system fetch data from website servers for sampling (e.g., by sampling the first ‘one second’ of videos, or by sampling small segments from PDF documents, etc.). When the system queries the database for identifying interacted visual elements of a web page, recently generated UVEIs are compared with the recorded UVEIs of the said web page according to their content type (e.g., video with video, image with image, text file with text file, etc.). In this process, the system compares content fragments with each other according to their similarities, and for each tested pair calculates the similarity rate—or resemblance rate—based on the similarity analysis. If similarity percentage of a pair exceeds a predefined similarity threshold, then the system associates the pair, according to the embodiment. In such embodiments, various statistical similarity measures may be used as a base for similarity analysis of data sets, and various algorithms may be preferred or developed depending on the type of content (e.g., image, audio, video, text, etc.) of visual elements. Furthermore, even semantic similarity comparison may be used in some specific applications.

To elaborate on the subject of analyzing and identifying interacted visual elements, a hypothetical example is provided as following: In one embodiment, a system user SU interacts with a dynamic web page that he/she is viewing, by associating respective user inputs as APP1, POST1, and POST2, with a text T, which is the content of visual element VE1, with an image P, which is the content of visual element VE2, and with a video V, which is the content of visual element VE3. APP1 which is associated with the VE1 may be a translator program that translates text from one language to another and dynamically processes/manipulates the visual element in order to display the translated version of the original text. POST1 and POST2 which are associated with VE2 and VE3 respectively, are social media posts including pictures and ideas of SU about the content of the corresponding visual element. A database record is generated and stored by the system for each user input APP1, POST1 and POST2, wherein each record contains content information CI′, property information PI and relative position information LI of VE1, VE2 and VE3 in their corresponding UVEIs respectively. Properties information PI may be all available information about the properties of VE1, VE2, and VE3. Image P and text T may be included as a whole to their corresponding database records in their corresponding UVEIs respectively,—due to their relatively small data sizes—, and video V may be included partially (e.g., by collecting samples from the source file of the video, which are fetched from the website server),—due to its relatively large file size—, as content information CI′. For example, in this process, the system may associate each post or application with the corresponding visual element in the rendered web page by recording the posts or applications with corresponding UVEIs to the database. In the first attempt, the website server alters the layout and structure of the said web page deliberately to jam the system including formal alterations in the source code, such as altering element IDs, content identifiers etc. As a result, relative positions and properties of VE1, VE2 and VE3 becomes altered including corresponding element IDs, content IDs etc., and they become the derivatives DVE1, DVE2, and DVE3 of the original visual elements (except the contents). When SU—or any other system user-views the web page (e.g., when the web page is rendered), the system generates new UVEIs (nUVEIs) of DVE1, DVE2, DVE3 and compares them with the user input database records involving UVEIs (rUVEIs) that include the URL of the said web page. In this process, the system compares the original text T with other texts, image P with other images and video V with other videos (by comparing sampled fragments) of the web page based on recorded UVEIs (rUVEIs) and recent nUVEIs. Based on the query, recorded UVEIs of VE1, VE2 and VE3, match with the recent nUVEIs of DVE1, DVE2, and DVE3 on content basis with a predetermined similarity level, such as a 100% similarity. Consequently, based on the similarity comparison of the content, the system successfully associates SU's user inputs with the corresponding visual elements in the rendered web page, and visually marks them. By selection of these markers, SU—or any other system user—may reach to the corresponding metadata. In the second attempt, the website server alters the content of DVE1 by slightly changing the text T (thus becomes T′), alters the content of DVE2 by slightly degrading the image quality of P—by processing the image—(thus becomes P′), and finally modifies DVE3 by transforming the visual element into a dynamic one that alters video content randomly in progress of time from a list that include N number of different videos. In addition to that, the website server also alters the layout and structure of the web page including radical alterations in the source code. As a result, relative positions, properties and contents of DVE1, DVE2 and DVE3 becomes altered and they become the derivatives DDVE1, DDVE2, and DDVE3. When SU—or any other system user—views the web page, the system generates new UVEIs (nUVEIs) of DDVE1, DDVE2, DDVE3 and compares them with the user input database records involving UVEIs (rUVEIs) that include the URL of the said web page. In this process, the system compares the original text T with other texts, image P with other images and video V with other videos. Based on the query, i) recorded UVEI of VE1, partially match with the recent UVEI of DDVE1, on content basis with X % similarity, ii) recorded UVEI of VE2, partially match with the recent UVEI of DDVE2, on content basis with Y % similarity, iii) recorded UVEI of VE3, does not match with the recent UVEI of DDVE3 initially but thereafter with 100% similarity, based on the comparison of the sampled fragments of video V (included in the UVEI of VE3) with altering video content in any visual element of the web page during the viewing. Consequently, based on the similarity comparison of the content, the system successfully associates SU's user inputs with the corresponding visual elements and visually marks them, because the similarity rates X and Y exceed the predefined similarity threshold. On the other hand, the system visually marks the dynamic visual element DDVE3 whenever video V is loaded and deletes the marker whenever video V is altered with another video. By selection of these markers, SU—or any other system user—may reach to the corresponding metadata. In the third attempt, the web page server alters the content of DDVE1 by significantly changing the text T′ (thus becomes T″) and alters the content of DDVE2 by significantly degrading the image quality of P′ (thus becomes P″). Text T″ and image P″ diverge from originals in such a degree that similarity rates fall below the predefined similarity threshold. Consequently, while keeping the association of visual element DDVE3 with video V, the system terminates the association of visual elements DDDVE1 and DDDVE2 with text T and image P respectively, according to the embodiment.

According to the embodiments, the process of identifying/locating visual elements of web pages does not have to rely on any ID based on the source code of web pages (e.g., utilizing namespaces, etc.). If preferred, uniform visual element identifiers (UVEIs) of visual elements do not include IDs assigned by website servers such as fragment identifiers, content identifiers, etc. Methods and systems presented within the current disclosure include embodiments designed on the basis that source codes of web pages—including any ID assigned by website servers—can be deliberately changed to confuse, and/or damage, and/or jam such systems. Alternatively, or in addition, the web resource interaction system may also include processing IDs based on the source codes and is not limited to the methods presented.

Uniform visual element identifier (UVEI) is similar to URL, which is a reference to a web resource that specifies its location on a data network, and a mechanism for retrieving it. According to various embodiments, uniform visual element identifier (UVEI) is also a reference to a visual element that specifies its location on a data network, and a mechanism for retrieving it. However, conceptually the difference between conventional URIs and UVEIs is radical. Firstly, each UVEI is generated by analyses of the corresponding visual element in order to extract distinctive information about its content, properties, and position within a framework of universal standards, and the UVEI of a visual element may be recorded as rUVEI and used as a reference for comparison of similitude with the distinctive information of each visual element extracted subsequently as nUVEIs when the corresponding source (e.g., a web page that the visual element belongs to) is re-rendered in order to identify a match. Secondly, similitude may be compared on the basis of content, role, function, etc., i.e., context thus, a visual element may be linked according to content, role, function, etc., i.e., context. In this regard, the UVEI mechanism described herein may be defined as a fuzzy logic referencing mechanism based on pure analogies (i.e., a comparison between one thing and another), by which ‘a distinctive representation identified by the analyses of one thing’ (i.e., an analogue) is compared with ‘a distinctive representation identified by the analyses of another thing’ (i.e., another analogue) based on similitudes or partial similarities (analogies) in order to associate/link the former with the latter.

The above-listed elaborations with respect to the process 200 is not limited with the embodiments provided, thus many more embodiments and implementations are possible.

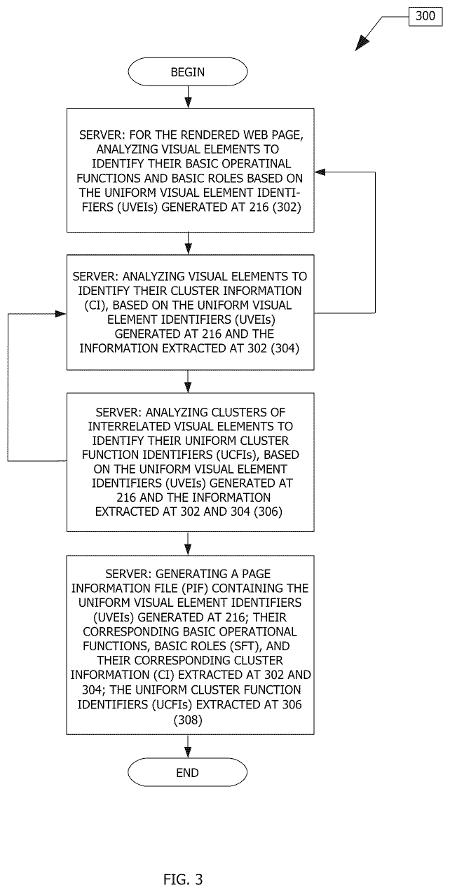

FIG. 3 is the flowchart diagram 300 illustrating an example process to classify each visual element, and identify each cluster of interrelated visual elements including corresponding function of each, in a rendered web page, according to an embodiment;

The process begins after the execution of 216, in which the server generates a uniform visual element identifier (UVEI) for each visual element of the rendered web page. At 302, for the rendered web page, based on the uniform visual element identifiers (UVEIs) the server analyzes the visual elements to identify the role/function of each visual element, i.e., extracting basic operational function/s (BOF) described in the elaborations regarding 300 and the basic role (i.e., subjective function type classification) of each visual element.

According to various embodiments subjective function type is classified/categorized as main content, side content and auxiliary element. In this context, main content is the main subject of a web page, e.g., the subject matter presented for consideration of the viewers. For example, in a news web page, news articles, news videos, link previews of other news article pages or videos etc. are main contents. Side content is the subaltern subject of a website such as ads, extraneous announcements, or any other extraneous content. Finally, auxiliary element is any visual element without a subjective function. For example, visual elements that are graphic components of GUI elements are auxiliary elements, such as containers—like canvases and frames—, buttons, sliders, text fields, list boxes, icons, navigation links, search boxes, lines, special shapes, etc. are auxiliary elements. Subjective function type (SFT) does not overlap among the visual elements. A visual element is either main content, or side content, or auxiliary element. In embodiments, to identify subjective function type (SFT) of the visual elements of a web page, the server identifies only the side contents and auxiliary elements. The remaining visual elements of the web page fall into the main content class. In this regard, identifying any 2 of the 3 classes/categories is sufficient in order to identify corresponding subjective function type (SFT) of each visual element of a web page, according to the embodiments.

Next, the server analyzes each visual element to identify cluster information (CI) of visual elements (304). Cluster information (CI) is information about the relationship of a visual element with other visual elements in a rendered web page and used as a reference to group interrelated visual elements of the rendered web page. For example, a group of visual elements within a framing visual element (e.g., a container) are identified as positionally interrelated visual elements. Moreover, by frames within frames, or groups within groups, cluster information may also include ranks of interrelationship. For example, a search field and a search button lined up next to each other may be a first order cluster, while the entire navigation bar containing them besides some link buttons may be a second order cluster. In this context, the highest rank of interrelationship may correspond to all visual elements of the web page framed/enclosed by the canvas, i.e., the web page itself. According to the embodiments, analysis of visual elements to identify cluster information (CI) is based on relative positional relationship of visual elements (e.g., a group of visual elements that is framed by another visual element), or functional relationship of visual elements (e.g., a group of visual elements serving for a particular purpose regardless of their positions), or ‘relative positional and functional’ relationship of visual elements together (e.g., a group of visual elements lined up next to each other serving for a particular purpose).

In embodiments, the server may utilize DOM (document object model) of the rendered web page to analyze parent, child, and sibling node relationships in order to identify the cluster information (CI) according to positional relationship of visual elements. Further, the server may utilize the classification of each visual element as ‘basic operational function/s’ (BOF) and ‘subjective function type’ (SFT) including any other information determined at 302, in order to identify the cluster information (CI) according to functional relationship of visual elements. Further, the server may also utilize the cluster information (CI) determined at 304 in a feedback loop structure, to identify the subjective function type (SFT) of previously unidentified visual elements, according to the embodiments. In various embodiments, cluster information (CI), identified according to ‘positional+functional’ relationship of visual elements, includes IDs of uniform visual element identifiers (UVEIs), where each cluster of ‘first degree relative visual elements’ is designated by a first order cluster ID—that is assigned for each first order cluster (i.e., first order sub-cluster), including information about the functional relationship of the visual elements—within the first order cluster—that is predicted or determined based on the interbedded process of 302 and 304 as discussed with reference to FIG. 3; and each cluster of ‘second degree relative visual elements’ is designated by a second order cluster ID—that is assigned for each second order cluster (i.e., second order sub-cluster), including information about the functional relationship of the first order sub-clusters—within the second order cluster—that is predicted or determined based on the interbedded process of 302 and 304; and so forth. Clustering based on ‘relative positional and functional’ relationship of visual elements (i.e., ‘positional and functional’ relationship in short) may be a more accurate and safer option than only ‘relative positional’ relationship of visual elements (i.e., only ‘positional’ relationship in short) for both normally structured web pages and structurally disorganized web pages with disorganized layouts. However, the interbedded process of 302 and 304 may impose more data processing load and thus it may be more time consuming. In order to gain speed and/or decrease the data processing load, the system may use artificial intelligence such as machine learning, and/or computer vison/pattern recognition algorithms to prefer only positional clustering and bypass the process 302 in order to identify the CI swiftly, and/or may decide which one to use according to the structure/layout of the rendered web page, based on a pre/rough analysis of the page. In one embodiment, the system scans and analyzes popular websites in order to identify and learn their page structures/layouts and use artificial intelligence to decide which method to be used, and records that decisions for each website and/or web page including their locators in a log that is stored in the database. Thus, the system may optimize the performance according to a predefined action.

Next, based on the uniform visual element identifiers (UVEIs) generated at 216; their corresponding basic operational functions (BOF) and basic roles (SFT), and their corresponding cluster information extracted at 302 and 304, the system may further analyze each identified cluster of interrelated visual elements to extract their high-level function/s (e.g., a standard video player with a color corrector and 2D to stereoscopic 3D convertor, or a search box with a search button within a container) (306). In this step, high-level functions of identified clusters may be extracted, for example, the high-level functions of high to low rank clusters may be ‘a header’ as the N−1^{st} rank, ‘a search box with a search button within a container in the header’ as the N−2^{nd} rank, ‘only the search box with the search button’ as the N−3^{rd} rank, and ‘only the search box’ alone as the N−4^{th} rank (0^{th} rank for this case) respectively, where the N^{th} rank cluster (4^{th} rank for this case) represents the whole web page. According to various embodiments, the system may further perform additional semantic analyses for the extraction of high-level function/s of each cluster of interrelated visual elements. For example, via utilizing various artificial intelligence algorithms based on—such as—natural language processing, machine learning, pattern recognition, etc. Thus, even more accurate, detailed, and comprehensive UCFIs may be extracted. Upon the extraction of the high-level function/s of a cluster, the system generates a ‘uniform cluster function identifier’ (UCFI) that includes/represents the extracted function/s of the corresponding cluster and assigns the extracted/interpreted function/s, i.e., UCFI, as a contextual reference to be used for establishing associations with a cluster of interrelated visual elements besides the UVEIs of the visual elements belonging to the cluster. Further, the system may also utilize the uniform cluster function identifiers (UCFIs) in a feedback loop structure to identify—especially—functional relationship of visual elements whose functional relationship with other visual elements is previously unidentified. For example, a pair of distantly positioned but functionally related clusters (similar to that of header-footer relationship) may be identified in a web page. Thus, via utilizing the process 306, functional relationship of distantly positioned visual elements may be identified at 304, and further this information extracted at 304 may lead to the extraction of additional information at 306, and so forth.

Next, the server generates a page information file (PIF) containing uniform visual element identifiers (UVEIs) generated at 216 including their corresponding basic operational functions (BOF) and basic roles (SFT), and their corresponding cluster information (CI) extracted at 302 and 304; and the uniform cluster function identifiers (UCFIs) extracted at 306 (308). More precisely, page information file (PIF) may include information obtained in processes 302, 304, and 306 including i) basic operational function/s of each visual element; ii) basic role, i.e., subjective function type (SFT), of each visual element; iii) cluster information (CI) of each visual element—identified according to positional and/or functional relationship of visual elements—in order to extract clusters of interrelated visual elements; iv) the uniform cluster function identifiers (UCFIs) as contextual references of clusters of interrelated visual elements and v) any other information may further be extracted or preferred. In this context, a client may use the information provided by a page information file (PIF) to reach all information extracted from the web page—so far—and may use this information for further analyses and/or as a further reference (e.g., via storing the PIF in the database and utilizing it later for constructing a reference that represents the initial state of the rendered web page). Thus, the client may identify for example the availability for interaction, according to a special (e.g., customized) or generalized predefined filtering criteria.

The process terminates after the execution of 308 unless the page is an infinite scrolling web page. In case of an infinite scrolling web page, for every additional manifestation of the web page the process loops between 302 to 308, i.e., all sub processes are executed in sequential order starting at 302 and ending at 308. As a result of the process 300, the client in collaboration with the server, classifies each visual element of a web page, and identifies each cluster of interrelated visual elements including corresponding function of each, thus provides information to the system such as for enabling/disabling visual elements and/or clusters of visual elements for interaction according to a set of predefined interaction rules (i.e., identifying web objects that are available to receive one or more user inputs), according to an embodiment.

To elaborate on the subjective function type (SFT): According to the embodiments, subjective function type (SFT) is a non-overlapping predetermined classification/categorization of each visual element in a web page according to its role. In an example, the predetermined classifications/categorization of the subjective function types may be based on three discrete types: i) main content, ii) side content, and iii) auxiliary element. According to this classification/categorization; an ‘auxiliary element’ is a visual element that possesses only operational function/s without a subjective function, while a ‘main content’ or a ‘side content’ is a visual element that possesses a subjective function besides its operational function/s, in which any additional function beyond operational functions is considered subjective. Essentially, this is a classification of 2 discrete—and naturally existing—parent types of page elements: i) elements without a subjective function; and ii) elements involving a subjective function besides their operational function/s.

A web page is an interface whose main purpose is to convey information to a user and receive information from the user. In this context, an auxiliary element is an element that provides only operational help and support in the process of conveying and receiving information without possessing a subjective function. For example; a check box for interaction, a frame grouping elements for ease of perception, an icon for attention, a background texture for decoration, a menu button or a search field for navigation are visual elements without a subjective function, and accordingly are auxiliary elements. However, a heading of a news item, a paragraph of an article, an image of a product or an add, a video of a movie, an audio of a musical piece, an application for gaming, a link preview of another web page, or a document including an e-book, are contents of visual elements possessing functions beyond operational functions about the web page and/or website that they belong to (e.g., content for the consideration of viewer/s), and accordingly are main or side contents. In this regard, while a visual element that functions as a navigation button including the name of the link location is an auxiliary element, a similar visual element that functions as a navigation button including a line of poetry or a mathematical formula—besides the name of the link location—is not, since the additional information that it is carrying is not operational, but for the consideration of the viewers, and accordingly, such a visual element is qualified as main or side content.

To elaborate on the principles to identify subjective function type (SFT): Similar to the visual objects as defined hereinbefore, a visual element may perform one or more of the four basic functions in a web page, besides a primal function: A visual element may be navigational, interactive, decorative, informative, or combinations thereof, and in addition to these four basic functions, a visual element inherently—and inevitably—performs an architectural/structural function by taking part in the formation of a web page,—just like a brick of a wall. These basic functions also define the said operational functions: i) Navigational: A navigational visual element helps viewers to navigate (e.g., through a hyperlink) in a single page and/or multiple pages of a website including links to external web pages. A navigational visual element may include visual/audial/textual content related to navigational processes including rmarkup/script; ii) Interactive: An interactive visual element helps viewers to interact (e.g., through a form) with the web page, and/or with the web page server. An interactive visual element may include visual/audial/textual content related to interactive processes including markup/script; iii) Decorative: A decorative visual element carries content for beautifying a page. A decorative visual element may include visual/audial/textual content with decorative features including markup/script (e.g., a script for fetching images from the server); iv) Informative: An informative visual element provides informative content to users. An informative visual element may include visual/audial/textual content with informative features including markup/script (e.g., a script for fetching text from the server). Note: According to the embodiments, in order to simplify the process 302, informative content used in navigational and/or interactive processes without possessing a subjective function are excluded, and considered as content with navigational and/or interactive features (e.g., purely operational GUI elements such as, addresses, icons, etc.); v) Architectural: An architectural/structural visual element helps viewers to perceive layout and content of a web page more accurately, easily and enjoyably by separating segments, framing interrelated visual elements, etc. Only visual elements with null content are purely architectural (e.g., containers like frames, separators, canvases, etc.), and inherently, every visual element is also architectural by taking part in the formation of the web page. And lastly, a visual element may also possess more than one of these functions simultaneously. For example, a navigational visual element may also be decorative by involving an image for beautifying the page, while being informative by involving a text relevant with the link location, e.g., the summary of the content of the link location.

In principle, informative, navigational, interactive, decorative and architectural functions are all operational functions. However, informative function differs from the rest, because only informative content (e.g., a paragraph or an image) may involve a subjective function, and if this is so, then the visual element is considered as main or side content, else it is auxiliary element. In the context of operational and subjective functions, it can be deduced that any visual element with navigational, and/or interactive, and/or decorative, and/or architectural function/s cannot involve any sort of subjective function, i.e., only a visual element with informative function may involve a subjective function. Although this deduction is important in the process of identifying SFT classes/categories, some navigational, interactive, and decorative visual elements may also possess informative content and thus, informative function, as described in examples herein. Therefore, in various embodiments, functional analysis of each content of a visual element is made according to the basic operational functions, in order to identify their functional relation with the respective visual element.

According to the embodiments, for identifying subjective function type (SFT) of each visual element in a web page that a user is viewing, example rules are listed based on the definitions and deductions presented about SFT classification/categorization: i) Basic operational functions of visual elements are: informative, navigational, interactive, decorative, architectural functions; A visual element may possess one or more of these functions simultaneously, and it always possesses an architectural function; ii) Any additional function of a visual element beside its basic operational function/s is considered subjective, and therefore the visual element is considered subjective, i.e., possessing a subjective function; iii) An auxiliary element is a visual element without a subjective function; A ‘main content’, or a ‘side content’ is a visual element that involves a subjective function besides its operational function/s; iv) Any visual element with null content (i.e., without any textual/visual/audial content) is auxiliary element; v) Only informative content may involve a subjective function; vi) An informative visual element is an auxiliary element as long as its content does not involve any sort of subjective function; vii) Any visual element whose function is ambiguous is considered decorative, and therefore considered as auxiliary element.

To elaborate on the process 302 to identify subjective function type (SFT), and the process 304 to identify cluster information (CI), an exemplary interbedded procedure is presented according to the embodiments: In embodiments, for identifying roles, such as main contents, side contents and auxiliary elements of a web page, the following sub-processes are executed in the process 302; In step 302/1: each visual element that includes textual/visual/audial content,—including related markup/script—is identified by the system analyzing content properties and/or content itself (e.g., for markup/script), based on the uniform visual element identifier (UVEI) of each visual element. If a visual element includes textual/visual/audial content then it is flagged as ‘unidentified element’; else, it is flagged as ‘auxiliary element’. In this step, visual elements with null content are identified (e.g., containers, separators, frames, etc.), and which are considered purely architectural. Although they are null in content, they possess properties such as, size, border size, border color, background color, etc. In one embodiment, the system—roughly—estimates the possible roles of visual elements with null contents by comparing their properties and relative positions with the known web page layouts when rendered.

In step 302/2, among the ‘unidentified elements’ that are flagged in step 302/1, each visual element with navigational and/or interactive features without possessing a subjective function is identified by the steps: For each visual element among the ‘unidentified elements’ that are flagged in step 302/1; 302/2.1) detecting textual content—including markup/script—related with the execution of navigational and/or interactive processes; 302/2.2) detecting visual content that is a component of a navigational and/or interactive user interface (GUI), 302/2.3) detecting audial content that is a component of a navigational and/or interactive user interface (AUI); 302/2.4) detecting textual content that is a component of a navigational and/or interactive user interface (GUI); Following the execution of the steps regarding functional analysis 302/2.1 to 302/2.4, executing process 304 for identifying cluster information (CI); 304/1) i) analyzing the position of each detected visual element relative to other visual elements of the web page, ii) analyzing the properties of each detected visual element, and iii) based on the detected roles, relative positions, and properties identifying related visual elements for each detected visual element and grouping the interrelated ones; 302/2.5) for each detected visual element, deciding whether the visual element is auxiliary element or not, based on the steps 302/2.1, 302/2.2, 302/2.3, 302/2.4, 304/1 and by utilizing the information obtained in the step 302/1. Flagging each visual element as ‘unidentified element’ or ‘auxiliary element’ according to the decision.

In one embodiment, for each visual element flagged as ‘unidentified element’ at 302/1; Regarding the step 302/2.1, textual content including markup is analyzed to detect a hyperlink associated with the visual element for detecting a navigational feature (e.g., URL), and any script associated with the visual element is analyzed for detecting an interactive feature (e.g., JavaScript); Next, the system executes the steps 302/2.2, or 302/2.3, or 302/2.4, or combinations thereof according to the content of the analyzed visual element, (whether or not a navigational and/or interactive feature is detected). Regarding the step 302/2.2, visual content is compared with known graphic components of navigational and interactive GUI elements of web pages such as, buttons, search fields, special shapes, icons (like play, pause record icons)—if any. Further, if the visual element is detected as navigational and/or interactive at the step 302/2.1, then a similarity comparison may be also executed in between the visual content and known graphic components of GUI elements for identifying the purpose of unique images, e.g., special icons, logos, avatars, etc. Regarding the step 302/2.3, audial content is compared with known audial components of navigational and interactive AUI elements of web pages such as, audio like clicks, buzzers, etc.—if any; Regarding the step 302/2.4, textual content is analyzed in order to detect text used only as a component of the GUI that it belongs t₀, such as an address, an instruction, etc.—if any; Regarding the step 304/1, the position of each detected visual element relative to other visual elements of the web page is analyzed, and based on the detected roles and relative positions, related visual elements for each detected visual element is identified. Accordingly, framing visual elements, i.e., containers, and framed visual elements are identified as groups of interrelated visual elements—if any; Regarding the step 302/2.5, for each detected visual element, based on 302/2.1, based on 302/2.2, or 302/2.3, or 302/2.4 or combinations thereof, and based on 304/1 the system evaluates the obtained information and decides whether the analyzed visual element is auxiliary element or not. For example, based on the features of the visual elements that are enclosed by a container, and based on the relative position of the framing container, the system may predict the purpose of the enclosed group (e.g., a navigation bar, a header, a footer, a social media post, etc.) and may deepen its evaluation for the role detection of the visual elements within the enclosed group. For a visual element that is detected as possessing navigational and/or interactive features in 302/2.1, possible outcomes are as follows: i) if the content (visual, and/or audial, and/or textual) is a component of a navigational and/or interactive user interface, then the visual element is flagged as auxiliary element. ii) if any of the content (visual, and/or audial, and/or textual) is not a component of a navigational and/or interactive user interface, then the visual element is flagged as ‘unidentified element’. For a visual element that is detected as ‘not possessing’ navigational and/or interactive features in 302/2.1, possible outcomes are as follows: i) if the content (visual, and/or audial, and/or textual) is a component of a navigational and/or interactive user interface, then—because its function is ambiguous—the visual element is flagged as auxiliary element; ii) if any of the content (visual, and/or audial, and/or textual) is not a component of a navigational and/or interactive user interface, then the visual element is flagged as ‘unidentified element’; according to the embodiment.

In step 302/3, among the ‘unidentified elements’ that are flagged in step 302/2, each visual element with decorative features without possessing a subjective function is identified by the steps: For each visual element among the ‘unidentified elements’ that are flagged in step 302/2; 302/3.1) detecting visual content with decorative features; 302/3.2) detecting audial content with decorative features; 302/3.3) detecting textual content with decorative features; Following the execution of the steps regarding functional analysis 302/3.1 to 302/3.3, executing the process 304 for identifying cluster information (CI); 304/2) i) analyzing the position of each detected visual element relative to other visual elements of the web page, ii) analyzing the properties of each detected visual element, and iii) based on the detected roles, relative positions, and properties identifying related visual elements for each detected visual element and grouping the interrelated ones; 302/3.4) for each detected visual element, deciding whether the visual element is auxiliary element or not, based on the steps 302/3.1, 302/3.2, 302/3.2, 304/2, and by utilizing the information obtained in the steps 302/1 and 302/2. Flagging each visual element as ‘unidentified element’ or ‘auxiliary element’ according to the decision.

Various strategies may be applied for the detection of visual, audial and textual content with decorative features, without possessing a subjective function. One strategy may be comparing positions of the visual content relative to other visual elements containing visual content for detection of overlapping sections. For example, any visual content that is positioned under another visible content may be considered as background image, and thus decorative. Similarly, a background music may be considered as decorative. Another strategy may be using size and position factors together for identifying images like logos, icons, etc. For example, a visual element containing a relatively small sized image positioned at the top left of a web page without possessing navigational or interactive features may be considered as an ornamental image with pure decorative features. In some cases, separating decorative content from informative ones may require more effort, e.g., due to the similarities of contents. Semantic analysis of textual, visual, and audial contents, may be used in such cases.

In one embodiment, for each visual element flagged as ‘unidentified element’ at 302/2; Regarding the step 302/3.1, visual elements including images or image sequences with overlaying visual elements including visible content upon them are detected, and also other images like icons, logos, etc. are detected based on their relative positions and their properties like size, shape, etc.; Regarding the step 302/3.2, audio used for decorative purposes such as background music, etc. are detected; Regarding the step 302/3.3, text used for decorative purposes such as, a background fill, ornamental patterns etc. are detected; Regarding the step 304/2, the position of each detected visual element relative to other visual elements of the web page is analyzed, and based on the detected roles and relative positions, related visual elements for each detected visual element are identified. Accordingly, framing visual elements, i.e., containers, and framed visual elements are identified as groups of interrelated visual elements—if any; Regarding the step 302/3.4, for each detected visual element, based on 302/3.1, or 302/3.2, or 302/3.3 or combinations thereof, and based on 304/2, and also utilizing the information obtained by the previous steps 302/1 and 302/2, the system evaluates all obtained information and decides whether the analyzed visual element is auxiliary element or not. For example, based on the features of the visual elements that are enclosed by a container, and based on the relative position of the framing container, the system may predict the purpose of the enclosed group (e.g., a header with a background picture or a canvas with ornamental patterns etc.) and may deepen its evaluation for the role detection of the visual elements within the enclosed group. For a visual element that is processed by the step 302/3, possible outcomes are as follows: i) if the visual element possesses only decorative function (i.e., visual, and/or audial, and/or textual content is decorative), then the visual element is flagged as ‘auxiliary element’; ii) if the visual element possesses only navigational and/or interactive function/s with a decorative function, then the visual element is flagged as ‘auxiliary element’; iii) else, the visual element is flagged as ‘unidentified element’; according to the embodiment.

In step 302/4, among the remaining ‘unidentified elements’ that are flagged in step 302/3, each visual element with informative features without possessing a subjective function is identified by the steps: For each visual element among the ‘unidentified elements’ that are flagged in step 302/3; 302/4.1) detecting visual content with informative features without a subjective function; 302/4.2) detecting audial content with informative features without a subjective function; 302/4.3) detecting textual content with informative features without a subjective function; Following the execution of the steps regarding functional analysis 302/4.1 to 302/4.3, executing the process 304 for identifying cluster information (CI); 304/3) i) analyzing the position of each detected visual element relative to other visual elements of the web page, ii) analyzing the properties of each detected visual element, and iii) based on the detected roles, relative positions, and properties identifying related visual elements for each detected visual element and grouping the interrelated ones; 302/4.4) for each detected visual element, deciding whether the visual element is auxiliary element or not, based on the steps 302/4.1, 302/4.2, 302/4.3, 304/3, and by utilizing the information obtained in the steps 302/1, 302/2, and 302/3. Flagging each visual element as ‘main or side content’ or ‘auxiliary element’ according to the decision.

Various strategies may be applied for the detection of visual, audial, and textual content with informative features without possessing a subjective function. According to the processes 302/1, 302/2 and 302/3, architectural, navigational and/or interactive, decorative visual elements including ambiguous ones (which are flagged as decorative) are identified and flagged as auxiliary elements. In addition, at 302/3, ‘navigational and/or interactive+decorative’ visual elements are also identified (based on 302/2) and flagged as auxiliary elements. Any remaining visual element that is flagged in step 302/3 as ‘unidentified element’ possesses an informative function,—with or without other basic operational functions—, and may or may not have a subjective function. These visual elements may be: ‘informative’, ‘informative+navigational and/or interactive’, ‘informative+decorative’, or ‘informative+navigational and/or interactive+decorative’. One strategy may be a rough elimination based on content type. Unlike text and images, most of the multimedia files (e.g., videos, audios, image sequences etc.) are main or side contents, and they may be flagged directly as main or side content. However, it is still possible to encounter with a video, audio or multimedia file in a web page that is used purely for operational purposes, e.g., an instructional video about an interactive feature of the web page, or an audio guide for navigating within the website. For precise identification of such content, semantic analysis may be a requirement. On the other hand, in steps 302/1, 302/2 and 302/3, since all operational functions of visual elements are identified (as architectural, navigational, interactive, and decorative respectively and the rest as informative), including clusters of interrelated visual elements (with the exception of the ones belonging to informative visual elements, which are being determined in this step), more practical approaches are also possible. In this context, one strategy may be identifying positional and functional relationship of the content with the cluster that it belongs t₀, based on: i) the properties of the content such as, size for images or number of characters for text; ii) previously identified function/s of the visual elements that are members of the cluster; iii) predicted or identified function of the cluster as a whole. For example, a relatively short text—that is purely informative without navigational and/or interactive features—positioned on the header may be considered as the name or label of the web page or website, and thus, informative content without a subjective function. However, a relatively long text positioned on the header may be considered as informative content with a subjective function. For example, it can be a quote or a message from the author of the web page. Further, clusters of visual elements with distinctive features may be defined to the system. For example, tables may be defined to the system, in which the content of a data cell element is informative with a subjective function, while the content in a column or row header (e.g., names of the variables) is informative without a subjective function. Furthermore, the system may identify the functions of higher rank clusters by prediction based on the identified functions of visual elements, identified functions of lower rank clusters, and consideration of the positional and functional relationship of lower rank clusters according to the know higher rank clusters with distinctive features. For example, a container including, a link preview with a commenting interface may be considered as a social network post. In general, this strategy may be applied for identifying text and/or image content of articles, social media posts, comments, comments related with the social media posts, etc. And may be supported with semantic analysis of contents.

In one embodiment, for each visual element flagged as ‘unidentified element’ at 302/3; Regarding the step 302/4.1, each visual element including an image is analyzed according to its content properties (e.g., size and shape), its positional and functional relationship with the cluster that it belongs to and predicted or determined function of the cluster as a whole—if available. Based on the analyses, each informative content without a subjective function is detected. All video and multimedia files, and all image sequences are considered as possessing a subjective function; Regarding the step 302/4.2, each visual element including a relatively small sized audio file is analyzed based on semantic analysis. Based on the analyses, each informative content without a subjective function is detected. The rest of the audio files—including the audio data of video files—are considered possessing a subjective function; Regarding the step 302/4.3, each visual element including text is analyzed according to its content properties (e.g., number of characters, words, sentences, etc.), its positional and functional relationship with the cluster that it belongs to and predicted or determined function of the cluster as a whole—if available. Based on the analyses, each informative content without a subjective function is detected; Regarding the step 304/3, the position of each detected visual element relative to other visual elements of the web page is analyzed, and based on the detected roles and relative positions, related visual elements for each detected visual element is identified. Accordingly, framing visual elements, i.e., containers, and framed visual elements are identified as groups of interrelated visual elements—if any; Regarding the step 302/4.4, for each detected visual element, based on 302/4.1, or 302/4.2, or 302/4.3 or combinations thereof, and based on 304/3, and also utilizing the information obtained by the previous steps 302/1, 302/2 and 302/3, the system evaluates all obtained information and decides whether the analyzed visual element is ‘main or side content’ or auxiliary element. For example, based on the features of the visual elements that are enclosed by a container, and based on the relative position of the framing container, the system may predict the purpose of the enclosed group and may deepen its evaluation for the role detection of the visual elements within the enclosed group. For a visual element that is processed by the step 302/4, possible outcomes are as follows: i) if the informative content of the visual element does not possess a subjective function (i.e., visual, and/or audial, and/or textual content without a subjective function) then the visual element is flagged as ‘auxiliary element’; ii) if the informative content of the visual element does possess a subjective function (i.e., visual, and/or audial, and/or textual content with a subjective function) then the visual element is flagged as ‘main or side content’; according to the embodiment.

In step 302/5, among the remaining visual elements that are flagged as ‘main or side content’ in step 302/4, each visual element with side content (i.e., extraneous content) is identified by the steps; For each visual element among the ‘main or side contents’ that are flagged in step 302/4; 302/5.1) detecting visual extraneous content; 302/5.2) detecting audial extraneous content; 302/5.3) detecting textual extraneous content; Flagging each detected visual element as ‘side content’ and flagging the rest as ‘main content’. Since the cluster information (CI) is identified for all visual elements of the web page in the previous steps 302/1, 302/2, 302/3 and 302/4, and since the final decision step is needles, process 304 and the final step are eliminated.

Various strategies may be applied for the detection of side content, i.e., extraneous content. One strategy may be detecting third party websites, e.g., by analyzing download/upload activities. Another strategy may be detecting ads based on the industrial standards that are being used, such as standardized banner sizes, or add fields etc. Another strategy may be semantic analysis of textual, visual, and audial contents, which may be considered as the most reliable but the costliest in terms of the data processing load.

In one embodiment, for each visual element flagged as ‘main or side contents’ at 302/4; Regarding the step 302/5.1, image and field size of the visual element is compared with known industry standards and flagged as suspicious if it matches. Next, download/upload activities of the—suspicious—visual element may be inspected based on the related markup/script and fetched data. As a result, third party ad resource and visual extraneous content is detected; Regarding the step 302/5.2, audial extraneous content is detected by detecting 3rd party streaming transmissions; Regarding the step 302/5.3, textual extraneous content is detected by semantic analysis; Regarding the outcome of the step 302/5, among the visual elements that are flagged as ‘main or side contents’ each visual element with ‘side content’ is identified, and accordingly each visual element with ‘main content’ is identified; according to the embodiment. In addition to all these, ‘main content’ may be sub-classified/sub-categorized and be used for further filtering of visual elements for interaction. In one embodiment, content published by the website (e.g., columns, articles, news items, etc.) and content published by the viewers (e.g., comments, etc.) are identified and only website's content is filtered for interaction (e.g., based on functional analysis, cluster information, etc.). In another embodiment, link previews of other web pages, and dynamic data displayed in tables (e.g., fetched data from the database of the website displayed in a HTML table upon a request) are identified and filtered out (e.g., based on functional analysis, cluster information, etc.).

To summarize the processes 302 and 304, which are interbedded according to the embodiment; In step 302/1, visual elements with null content, i.e., purely architectural visual elements, are identified, and the remaining visual elements may be flagged as ‘unidentified element’ and filtered for further evaluation. At this stage, ‘unidentified elements’ to be processed may include visual elements with navigational features, and/or interactive features, and/or decorative features, and/or informative features, or—as a special case—ambiguous features—which are considered as decorative—, with or without a subjective function. In step 302/2, visual elements with navigational and/or interactive features without possessing a subjective function are identified—if any. Furthermore, by the step 304/1 cluster information (CI) of the said visual elements are identified, and thus, clusters of interrelated visual elements regarding the said visual elements are determined—if any. In this process, any visual element containing a visual or audial or textual content that is not related with navigational and/or interactive functions is flagged as ‘unidentified element’ and filtered for further evaluation. In step 302/3, visual elements with decorative features without possessing a subjective function are identified—if any. Furthermore, by the step 304/2 cluster information (CI) of the said visual elements are identified, and thus, clusters of interrelated visual elements regarding the said visual elements are determined—if any. In this process, any visual element containing a visual or audial or textual content that is not related with the decorative functions is flagged as ‘unidentified element’ and filtered for further evaluation. In step 302/4, visual elements with informative features without possessing a subjective function are identified—if any—, and the rest of the visual elements are flagged as ‘main or side content’. Furthermore, by the step 304/3 cluster information (CI) of the said visual elements are identified, and thus, clusters of interrelated visual elements regarding the said visual elements are determined—if any. In step 302/5, each visual element with side content is identified—if any—, and accordingly remaining ones are flagged as main content. As a result, the system identifies basic operational function/s of each visual element, while identifying any subjective function classified/categorized as main or side content, and determines clusters of interrelated visual elements, according to the embodiment. In one embodiment, in order to speed up the process 302/1 to 302/5, for the uniform web pages of websites (e.g., Twitter, Instagram, Facebook etc.), before executing 302/1, common objects of web pages are identified such as, header, footer, local navigation boxes, scan columns, etc., by comparing the web pages of the website. Next, based on the common visual elements, the system—roughly—estimates the possible roles of the visual elements by comparing their properties and relative positions in the rendered web page with known web page layouts.

The above-listed elaborations with respect to the process 300 is not limited with the embodiments provided, thus many more embodiments and implementations are possible.

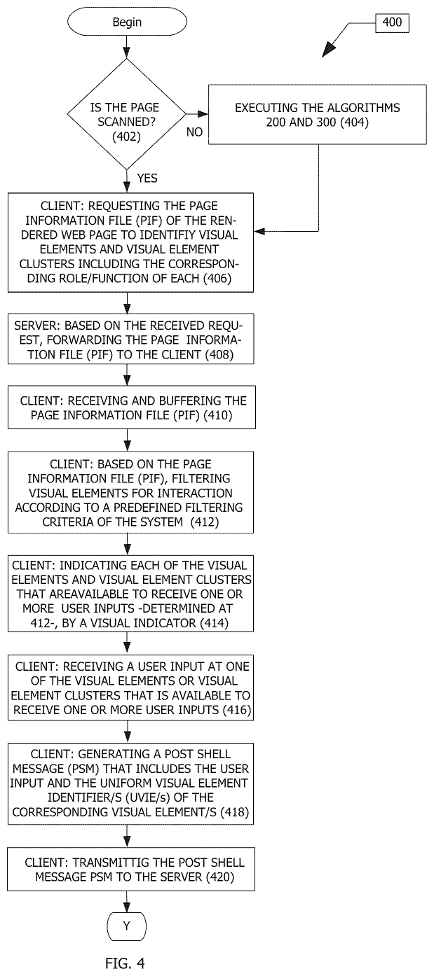

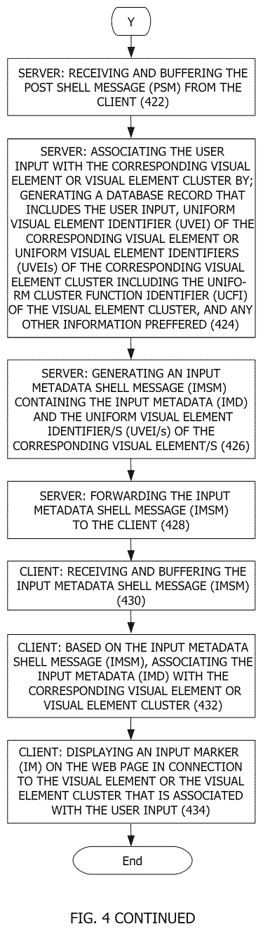

FIG. 4 is the flowchart diagram 400 illustrating an example process to filter visual elements and/or clusters of interrelated visual elements for interaction and based on user's selection among these filtered visual elements, to associate user inputs with selected visual elements and/or clusters of interrelated visual elements of a rendered web page, according to an embodiment.

The process begins with the request of a system user from the client to associate a user input with a visual element of a rendered web page. At 402, the client inquiries whether the rendered web page is scanned, i.e., processed by 200 and 300, or not. If the web page is not scanned, then the process 200 and the process 300 may be executed respectively at 404 before 406 is executed. Else, 406 is executed immediately after.

At 406, the client requests the page information file (PIF) of the rendered web page generated at 300 in order to contextually identify each visual element and cluster of interrelated visual elements via UVEIs and Cis including corresponding roles/functions of each, such as basic operational function/s (BOF), basic roles (SFT), and/or high-level function/s of each cluster of interrelated visual elements (UCFI), etc. Next, based on the received request, the server forwards the page information file (PIF) to the client (408), and the client receives and buffers the page information file (PIF) (410).

Next, based on the page information file (PIF), the client decides on the interactions, i.e., identifying the availability of each visual element and/or each cluster of interrelated visual elements for interaction according to a predefined filtering criteria of the system and flag the UVEIs as ‘available’ in the PIF, which is buffered in the client. More precisely, based on the role/function of each visual element and their interrelationship including the high-level functions of each corresponding cluster determined at 300, the client (or the server in another configuration) filters visual elements for interaction according to a predefined filtering criteria of the system, (e.g., as only main content, only side content, only auxiliary elements, or any combination thereof for associating user generated contents, and/or as clusters of interrelated visual elements according to their ‘positional’, or ‘positional+functional’ relationships for associating user generated software applications), and enables filtered visual elements for interaction, while disabling the remaining visual elements (412). Filtering criteria of the embodiments may vary. For example, for associating user generated contents, in order to focus on contextual information of web pages, e.g., news, articles, comments, videos, social media posts, etc., only visual elements including main content may be available for interaction. According to various embodiments, for associating a user generated content, the system may allow selection of only one visual element among the filtered ones. However, for associating a user generated software application, the system may allow selection of a cluster of visual elements among the filtered ones, and thus, may associate a user generated software application with one or more visual elements. In this process, the system may utilize the interrelated visual elements that are identified and grouped at 300,—where the relationship may be positional, and/or ‘positional+functional’, and/or any other predefined relationship criteria—, and filters them for interaction, according to a predefined filtering criteria. For associating user generated software applications, predefined filtering criteria may be filtering only clusters with ‘positional+functional’ relationships. However, predefined filtering criteria may be more specific about the clusters to be filtered for interaction. For example, some particular clusters with distinctive features may be predefined in the system,—which may be specific to certain websites or may be used in general—such as, link previews, social media posts, headers, footers, menu boxes, navigation bars, tables, commenting interfaces, etc., and they may be identified by analyzing the previously detected roles/functions and relationships at 300 (FIG. 3), according to the embodiments. In such embodiments, general features of clusters may be defined and introduced to the system by ‘positional and functional’ relationships of the visual elements together—instead of only positional—because layouts of clusters may alter in time. In this context,—for example—a social media post may be defined and introduced to the system as a cluster including at least 3 sub-clusters due to one of them including main content, one of them including author ID, and one of them including a commenting/reaction interface. Thus, the mediums/interfaces used in web pages such as, social media posts, link previews, commenting interfaces, tables, media players etc. may be introduced to the system according to their qualifications and characteristics instead of dictating raw positional data only,—which may be considered non-persistent for most of the cases. Alternatively, or in addition, the system may also enable a user to define a cluster of visual elements and introduce it to the system by manual selection of visual elements from among the visual elements of a rendered web page. Thus, a system user may define a unique cluster (e.g., according to its role and/or function) to be dynamically processed/manipulated by one or more software applications each developed for the defined cluster.

Next, the client indicates each of the visual elements and/or clusters of interrelated visual elements that are available to receive one or more user inputs—determined at 412—by a visual indicator, e.g., by highlighting the available (filtered) visual element field (414). Thus, the system user may select a visual element and/or a cluster of interrelated visual elements for associating a user input. In embodiments for associating user generated contents, the system highlights the available visual element fields in green, and for associating user generated software applications the system highlights the available visual element fields in blue.

Next, the client receives a user input for a visual element or a cluster of interrelated visual elements that is available to receive one or more user inputs (416). In various embodiments, system users create user inputs via an input interface that is particularly designed for generating user inputs. In embodiments, for enabling users to generate software applications, a software development tool is provided. According to the embodiments, the software development tool isolates a selected cluster, and indicates each sub-cluster according to the ranks of interrelationship within the selected cluster (similar to a DOM tree, where the document is the selected cluster), wherein a system user may include additional content—including scripts—, and/or alter the properties of visual elements, and/or add new visual elements, and/or define the fields or portions of the fields of visual elements to be dynamically processed/manipulated by the script that he/she is developing. In another embodiment, based on a user's selection of an available cluster, the system displays a list of—system executable—software applications that are particularly developed for the selected cluster of interrelated visual elements. Thus, the user may select an already existing user generated software application to process/manipulate a cluster.

Next, the client generates a post shell message (PSM) that includes all information pertaining to the user input and the uniform visual element identifier/s (UVEI) of the corresponding visual element/s including each corresponding subjective function type (SFT) and corresponding cluster information (CI) (418). In various embodiments, post shell message (PSM) also includes other information obtained in processes 302, 304, and 306 such as, basic operational function/s (BOF) of each visual element, and uniform cluster function identifier (UCFI) of each cluster of interrelated visual elements, etc.

Next, the client transmits the post shell message (PSM) to the server (420), and the server receives and buffers the post shell message (PSM) (422).

Next, in the case of establishing an association with a singular visual element, the server associates the user input with both the corresponding visual element and the hyperlink that is associated with the visual element—if any—by generating a database record that includes the user input (i.e., the content of user input such as images, texts, scripts, etc.), uniform visual element identifier (UVEI) of the corresponding visual element including its corresponding basic operational function/s (BOF), subjective function type (SFT) and corresponding cluster information (CI) and any other information preferred (424). In the case of establishing an association with a cluster of interrelated visual element, the system may associate the user input with the corresponding cluster of interrelated visual elements by generating a database record that includes the user input (i.e., the content of user input such as images, texts, scripts, etc.), the uniform cluster function identifier (UCFI) of the corresponding visual element cluster, each uniform visual element identifier (UVEI) of the visual elements that belong to the cluster including each corresponding basic operational function/s (BOF), subjective function type (SFT), and cluster information (CI), and any other information preferred (424).

In one embodiment, the server appoints a unique resource identifier (e.g., an URL) for the user input as the database ID and creates a database record for the user input under this ID where the server records all information according to the database fields of the user input such as UVEI, BOF, SFT, CI, UCFI of the associated visual element or the associated cluster of interrelated visual elements, contents of the user input, further interactions with the user input such as comments, etc. In this scenario database record of the user input may be updated whenever the user input is edited, or comments are added. In another embodiment, for each user input, a dedicated web page that includes the content of the user input may be generated also, and the web page may be addressed with the appointed resource identifier that is used as the database ID. In various embodiments, only one visual element may be associated with a user input if the user input is a user generated content, while one or more visual elements may be associated with a user input if the user input is a user generated software application. In addition to that, in case of user generated contents, subjective function type (SFT) and cluster information (CI) may be temporary references used for each viewing session of a client, and thus they are not recorded in the database and not included to post shell message (PSM). On the other hand, in case of user generated software applications, subjective function type (SFT) and cluster information (CI) may be permanent references used against contextual and/or structural alterations of interacted clusters of web pages/websites, and thus they may be included to post shell message (PSM) and recorded in the database. Thus, positional and functional relationship of visual elements within an interacted cluster may be used as a reference to identify the cluster if it alters, and further, may be used for adapting the associated software applications to the existing state of the altered cluster. For example, the structure/layout of uniform social media posts (e.g., post interfaces) of a social media website may alter in a way that relative positions of all sub-clusters such as, ‘author information’, ‘main content’, ‘reaction interface’, ‘commenting interface’ may completely change. Furthermore, content and properties of the visual elements, such as icons, shapes, background colors, etc., may also alter completely. However, the system may still identify the altered ‘post interface’ based on the analysis of the initial state and recent state according to the positional and functional relationship within the clusters of the pages of the said social media website, according to the embodiments.

Next, for the user input, the server generates an input metadata shell message (IMSM) containing input metadata (IMD), i.e., metadata of the user input, and uniform visual element identifier/s (UVEI) of the corresponding visual element/s (426).

Next, the server forwards input metadata shell message (IMSM) to the client (428), and the client receives and buffers input metadata shell message (IMSM) (430).

Next, for the input metadata shell message (IMSM) received, the client associates input metadata (IMD) with the corresponding visual element or cluster of interrelated visual elements of the web page (432).

Next, the client displays an input marker (IM) on the web page in connection to the corresponding visual element and/or cluster of interrelated visual elements that is associated with the user input (434).

The process terminates after the execution of 434. As a result of the process 400, the client, in collaboration with the server, associates a user input with a visual element and/or a cluster of interrelated visual elements that are available to receive one or more user inputs, according to an embodiment.

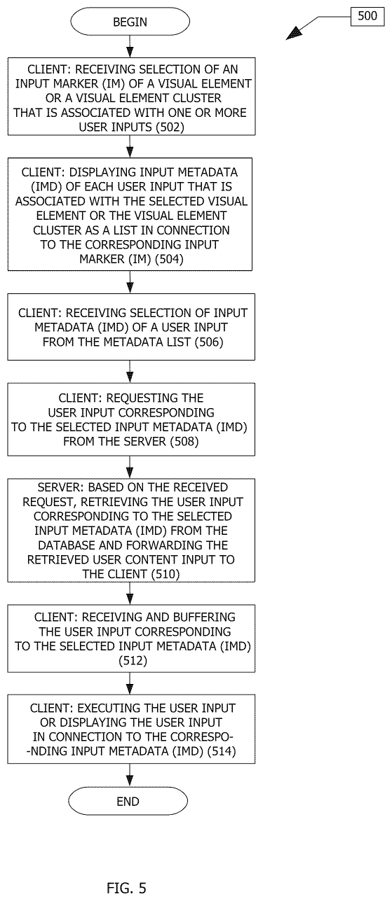

FIG. 5 is the flowchart diagram 500 illustrating a process to display metadata of user inputs, to display content of user inputs and/or to execute program instructions of user inputs in connection to the corresponding visual elements and/or clusters of interrelated visual elements of a rendered web page, according to an embodiment;

The process begins with the selection of an input marker (IM) of a visual element or a cluster of interrelated visual elements—of a rendered web page—that is associated with one or more user inputs, by the system user. In one embodiment, system user selects the input marker (IM) by clicking a pointing device. At 502, the client receives the selection.

Next, based on the received selection and input metadata shell messages (IMSM) received and buffered at 224 and/or 430, the client displays input metadata (IMD) of each user input that is associated with the selected visual element or cluster of interrelated visual elements as a list in connection to the corresponding/selected input marker (IM) (504). In one embodiment, N number of input metadata (IMD) is listed in rows for N number of corresponding user inputs. The user browses metadata list that is ranked according to various ranking algorithms for display on the web page. The list scrolls downward if needed. Input metadata (IMD) contains summary info such as heading, rank, popularity score, publisher etc., and the system user may decide whether to reach content pertaining to a user input or not according to metadata.

Next, the client receives selection of input metadata (IMD) of a user input from the metadata list (506). In one embodiment, a system user selects one of the input metadata (IMD) from the metadata list manually by a pointing device.

Next, the client requests content pertaining to the user input corresponding to the selected input metadata (IMD) from the server (508).

Next, based on the received request, the server retrieves the requested content pertaining to the user input corresponding to the selected input metadata (IMD) from the database and forwards it to the client (510).

Next, the client receives and buffers the content pertaining to the user input corresponding to the selected input metadata (IMD) (512).

Next, if the user input is user generated content, then the client displays the content pertaining to the user input in connection to the corresponding input metadata (IMD), else the client executes program instructions of the user generated software application in connection to the corresponding visual element and/or cluster of interrelated visual elements (514). As a result of the process 500, the client, in collaboration with the server, displays metadata and content of user inputs in connection to the corresponding visual elements and/or clusters of interrelated visual elements, and/or displays metadata of user generated software applications and executes the selected ones according to an embodiment.

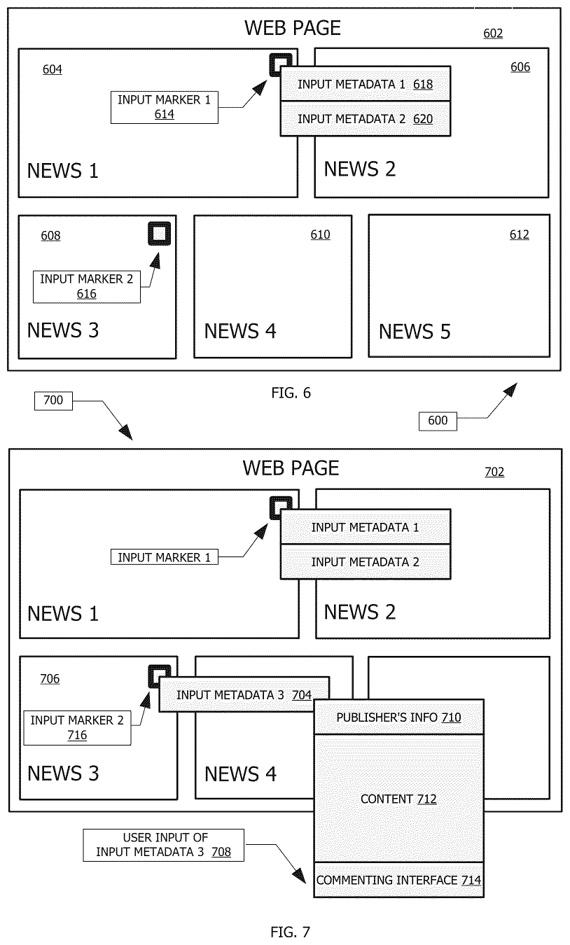

FIG. 6 is an exemplary user interface 600 displaying a plurality of input markers (IM) and input metadata (IMD) of various user inputs that are associated with a web page 602, according to an embodiment. The web page 602 includes several visual objects, shown as 604, 606, 608, 610, and 612. A plurality of user inputs is associated with visual objects 604 and 608, and they are marked with input markers 614 and 616 respectively. 618 and 620 are input metadata (IMD) of previously received user inputs associated with the visual object 604. Input metadata 618 and 620 are displayed on the web page 602 as a list, in connection to the associated visual object 604. Infinite numbers of input metadata (IMD) associated with a visual object may be displayed by a system user via scrolling down the list.

FIG. 7 is an exemplary user interface 700 displaying a user input corresponding to a selected input metadata (IMD) at a web page 702, according to an embodiment. As shown, a system user selects input metadata 704 corresponding to the input marker 716 displayed in connection to the associated visual object 706 and based on the selection, the user input 708 that includes publisher's information 710, content 712, and a commenting interface 714, is displayed in connection to the corresponding input metadata 704 on the web page 702.

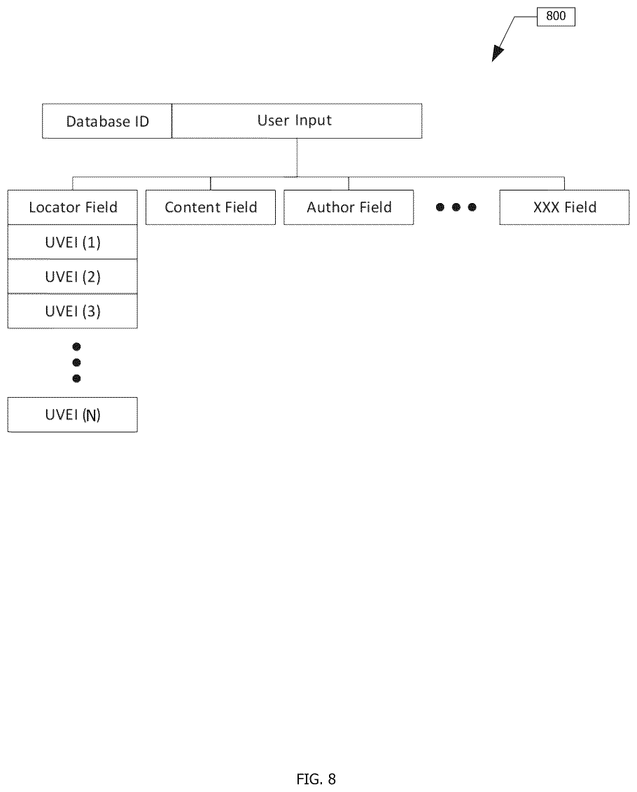

FIG. 8 is an exemplary database record structure 800 representing a database record for a user input. As illustrated in FIG. 8, the database record structure 800 includes a database ID for each user input stored in the database. In database record structure 800, fields of a user input record are displayed as locator field, content field, author field, and any other field etc. The association of a user input may be identified by the UVEI/s recorded in the locator field. The content field includes the content of the user input. The database record structure 800 may also include an author field to identify the author of the user input, as well as other fields related to the user input or the author, such as a date of generation/revision of the user input, contact information for the author, and other such information. As discussed hereinbefore, the UVEIs stored in the database record structure 800 are only recorded UVEIs (rUVEIs) and a visual element with which a user has interacted is associated through an rUVEI, such as within the user input database record structure 800. In this regard, database is queried based on the comparison of rUVEIs with the nUVEIs that are identified in each viewing session of a client on a rendered web page. Any number of rUVEIs may be stored in the database record structure 800. A user input may be associated with a cluster of visual elements, thus multiple UVEIs may be recorded in the locator field of the user input record, and thus these UVEIs become rUVEIs. Alternatively, or in addition, a user input may be associated with only a single visual element through a single rUVEI, according to the embodiments.

FIG. 9 is the flowchart diagram 900 illustrating an example process that includes steps with respect to processing of/interacting with a rendered web page, according to an embodiment. The process 900 includes the whole system as both the client and server executing the steps in coordination with each other while interacting with a system user through the client. Processes 902 to 920 are processes/steps A to I respectively (excluding the decision process/step 906 which is also a process/step of 900 but without an assigned letter for simplification of the description). The sequence of the steps A→B→C represents the process of establishing a new association between a super-object and a web object (i.e., associating a user generated content or application with a web object of a web page for the first time), while steps A→D represents the process of identifying pre-existing associations (i.e., identifying each association between existing super-objects and web objects) and for each associated web object, adapting to the contextual and/or structural alterations that occur between the initial state (i.e., the state when an association is first established) and the recent state (i.e., current state). The process steps A→B→C as a whole may—in general—correspond to the processes 200, 300 and 400 as a whole, while the process steps A→D as a whole may—in general—correspond to the processes 200 and 300 as a whole. Both processes A→B→C and A→D are executed for each client individually at each viewing/rendering. The steps A→B→C and A→D together ensures the stability (consistency) and sustainability (persistency) of interactions. The steps E, F, and G are about recommending, previewing, displaying, and execution processes of super-objects, e.g., integrated contents or features; while the step H is about providing users with the ability to connect and interact with each other through super-objects. Finally, the step I is about generating contents and developing applications, i.e., generating prospective super-objects, to be associated with web objects. In this context, the system also provides an intelligent tool for assisting both layman and expert users to develop applications that dynamically process/manipulate web objects based on hybrid intelligence.

According to various embodiments, the process 900 begins with the rendering of a web page—partially or wholly—by the web browser of a system user.

Process A—902—includes the interbedded steps of analyzing, classifying, and clustering visual elements of the rendered portions of a web resource that a user is viewing. In this process, the system analyses rendered visual elements for extracting corresponding UVEIs to be used as a contextual reference of the corresponding respective visual element for further analyses such as for classifying visual elements (i.e., elementary web objects such as images, videos, audios, texts, etc.) into one or more of a plurality of predetermined classes (e.g., basic operational functions and subjective function types) and clustering interrelated visual elements (i.e., meaningful clusters of elementary web objects, such as GUIs, forms, tables, lists, articles, etc.) according to their positional and/or functional relationships in rank orders, including extracting/interpreting the role/function of each cluster in rank orders.

In the first sub-step of 902, the system analyzes each visual element individually, including related markup/script and fetched content (such as web images, videos, audios, etc.) to collect distinctive information about the visual element (i.e., to extract the basic context) and generates a ‘uniform visual element identifier’ UVEI for each of the identified visual elements, which uniquely identifies a corresponding one of the visual elements. More precisely, the system associates with each of the UVEIs, information regarding the web page, distinctive information and/or properties of content of the corresponding one of the visual elements, and a relative position information of the corresponding one of the visual elements. As a result, the system assigns a UVEI to each visual element (i.e., elementary visual object) to be used both as a base for further analysis and as a reference (e.g., an analogue) for establishing associations between super-objects and web objects.

Next, based on the UVEIs generated, the system analyzes the visual elements for classifying each of the visual elements into one of the basic operational functions classified as, for example, navigational, interactive, informative, decorative, structural, or combinations thereof. In this process, the system may further classify each visual element into one of the basic roles, i.e., subjective function types classified as ‘main content’ and ‘auxiliary element’. Subjective function type (SFT) is a non-overlapping classification of each visual element according to its basic role in a page. In this context, further sub-classes/sub-categories may be created according to the operational needs. For example, according to the embodiments, ‘main content’ may also be sub-categorized as ‘main content’ and ‘side content’ per se. According to the classification mechanism of the system: i) all elements possess one or more basic operational function/s; ii) an ‘auxiliary element’ is an element that possesses only operational function/s, i.e., having only an operational role without a subjective role; iii) a ‘main content’ or a ‘side content’ is an element that also possesses a subjective function besides operational function/s, i.e., conveying a subject matter, i.e., a matter presented for consideration of the viewers. For example, in YouTube™, a scroll bar or a play button may be identified as an auxiliary element, a video or a link preview of a video may be identified as a main content, while an ad or any other extraneous content may be considered as side content. As a result, the system classifies each visual element (i.e., each elementary visual object) into, for example, one or more of the basic operational functions and further classifies each visual element into, for example, only one of the subjective function types, i.e., one of the basic roles.

Further, in this process, based on the classification of the basic operational functions and utilizing the extracted information regarding the classification of the subjective function types, the system analyzes respective relative positions and respective functional relationships of the elements with other elements, in order to cluster functionally interrelated elements in rank orders and extract the function of each cluster. In this context, unlike conventional segmentation of elements, clustering includes all ranks of interrelationship. For example, a search field and a search button lined up next to each other serving for the same purpose is a first order cluster, while the entire navigation bar containing these two elements besides a couple of link buttons is a second order cluster and so forth. Accordingly, the highest order cluster corresponds to all visual elements of a web page framed/enclosed by the canvas, i.e., the web page itself. Further, the system extracts high-level function/s of each identified cluster of interrelated visual elements and assigns a ‘uniform cluster function identifier’ (UCFI) for each as a contextual reference to be used for establishing associations with a cluster of interrelated visual elements—in addition to the set of UVEIs that belongs to the cluster.

Referring again to Process A: i) Uniform cluster function identifier (UCFI) may also be used for individual visual elements by considering each visual element as a zeroth order cluster. ii) The process of ‘classifying and clustering’ are interbedded processes, i.e., the information obtained in one process is used to obtain information in the other and vice versa, as shown with a loop in the flowchart 300 (FIG. 3). iii) Although insufficient, stand-alone analyses purely based on the page view (i.e., image processing based on computer vision such as implementing Gestalt Principles as proximity, similarity, continuity, and closure), may be used as a supportive process such as, in the process of identifying the positional interrelationship of visual elements, or as a preliminary analysis of web resources in order to optimize the process of deep analysis of the HTML/JS code, fetched data, structure, etc.

As a result of Process A, i.e., the process of analyzing, classifying, and clustering web objects, the system determines/interprets at a contextual level ‘what exactly the web objects are’ in the rendered web page. Following the execution of Process A, the processes B and D may be initiated and executed independent of each other. In some examples, the processes B and D may be initiated simultaneously and executed independent of each other.

Process B—904—includes the step of deciding on interactions with respect to the rendered portions of the web resource that the user is viewing. In this process, based on i) each UVEI generated; ii) the role of each visual element identified; iii) each cluster of interrelated visual elements identified including the corresponding UCFI; and iv) the predefined set of interaction rules that is set according to the operational and implementational needs; the system controls user interaction with web objects—in respect of the development and deployment process of super-objects—by recommending interaction options and enabling/disabling web objects for interaction according to the selected interaction type. The predefined set of interaction rules is a library of operational rules that is set for ‘how a user can interact with which visual element or cluster of interrelated visual elements based on an interaction type’. In other words, for each interaction type—which represents a unique interaction option for either associating contents, or associating applications—special and general rules are assigned according to the interaction needs and based on the criteria of ensuring the stability and sustainability. For example, as a general rule, interaction with a cluster of randomly selected visual elements is prohibited—due to the violation of the stability/sustainability criteria—, unless a determinable function of the cluster is introduced into the system by the user. Or, for example, as a special rule, only visual elements with particular roles—such as only main content and side content—may be enabled for interaction. In this context, the system recommends interaction options to a user, and based on the preferences of the user, the system enables visual elements and/or clusters of interrelated visual elements for interaction and disables the rest (e.g., filtering visual elements for interaction) according to the corresponding interaction rules and indicates each available visual element or cluster of interrelated visual elements, e.g., with a visual indicator, for the selection of the user.

Referring again to Process B: i) the interaction rules that can be set are infinitely many and take shape individually according to the needs of each implementation possibility. ii) In order to reduce the processing load of the system, Process B may be initiated with a receival of an interaction request of the user.

As a result of Process B, i.e., the process of deciding on interactions, the system decides ‘how the user can interact with web objects in respect of the development and deployment process of super-objects’ in the rendered web page. Following the execution of Process B, Process C may be initiated if the user wishes to associate a content or application that is available/ready for association.

Process C—908—includes the step of establishing associations. In this process, based on the receipt of the user's selection of a visual element or a cluster of interrelated visual elements, the system associates the prospective super-object developed by the user with the selected visual element or cluster of interrelated visual elements by generating a database record that includes the contextual reference of the visual element or cluster of interrelated visual elements being interacted with. In this context, for each super-object, a unique database record is generated, containing a locator field, a uniform cluster function identifier (UCFI) field, a content field, an author field, and/or any other field, etc. Contextual references are recorded under the locator field and uniform cluster function identifier (UCFI) field—or under any other field that is created for this purpose. If interacted web object is a visual element, then the UVEI of the interacted visual element is recorded under the locator field, and the uniform cluster function identifier (UCFI) field remains empty—unless it is preferred to treat the interacted visual element as a cluster, i.e., a cluster that includes a single element, itself. If an interacted web object is a cluster of interrelated visual elements, then each of the UVEIs belonging to the interacted cluster are recorded under the locator field, while extracted function of the interacted web object is recorded under the uniform cluster function identifier (UCFI) field. Finally, the content of the super-object (e.g., general contents and/or executable contents such as a set of instructions for the system for execution) and information about the author are recorded under content field and author field respectively. In some embodiments, extracted basic operational functions and basic roles of visual elements are also included in the database records of super-objects to be used as further references. In this context, both basic operational function/s and basic role of a visual element are used as a secondary (supportive) reference for the establishment of an association, according to the embodiments.

In various embodiments, the primary reference used for establishing an association with a visual element is a UVEI, while the primary reference used for establishing an association with a cluster of interrelated visual elements is the extracted function of the cluster, i.e., the uniform cluster function identifier (UCFI), along with the UVEIs of the visual elements belonging to the cluster. According to other embodiments, uniform cluster function identifier (UCFI) is used as the only reference for establishing an association with a cluster. For example, a cluster identified as a GUI having the primary function of being a ‘video player’ with the secondary functions identified as being a color corrector and a 2D to stereoscopic 3D convertor. On the other hand, the UVEIs of the visual elements belonging to the cluster may be used only as a reference for the adaptation process between the initial state of the cluster—i.e., the contextual and structural state of the cluster when the super-object was associated with it—and the recent state of the cluster—i.e., the contextual and structural state of the cluster when the web resource that the cluster belongs to is re-visited/re-rendered. For example when the abovementioned GUI (video player) is re-visited; via i) constructing a reference that represents the initial state of the cluster based on the rUVEIs, ii) constructing a reference that represents the recent state of the cluster based on the nUVEIs, iii) comparing the constructed references to identify the differences between the states, and iv) considering a predefined set of adaptation rules; the system may identify the adaptation procedures, thus the system may not only identify an altered cluster that was previously interacted, but may also identify how to dynamically process/manipulate the most recent cluster, according to the embodiments.

In addition, hybrid referencing is also possible via using both the reference of a visual element and the reference of a cluster of interrelated visual elements simultaneously to establish an association, such as, referencing a GUI with a certain function (e.g., a video interface) that includes a particular content (e.g., a particular video, such as ‘2001: A Space Odyssey’). Last but not least, contextual reference of a cluster of interrelated visual elements—which inherently may correspond to a set of analogue references to be chosen in various combinations for each super-object & web object pair due to the very nature of contextuality—may be often a composite of multiple attributes, functions, roles, etc. For example, relative position or any feature of a web object may also be used as a part of the reference. In this context, the system may suggest different combinations of references to the user and/or allow users to compose custom references for establishing associations. Further, non-existent features at the initial state of an interacted web object may also be added to the reference. Furthermore, web objects that do not yet exist may be introduced to the system in advance and based on such references the system may be programmed for possible interactions that may occur in the future. Therefore, the presented referencing mechanism herein,—which is in principle based on contextual references and analogies—, provides an extremely wide variety of association possibilities. In this context, the scope of a reference may be broadened up or narrowed down via subtraction/addition of further contexts. Furthermore, via addition of specific information to references, such as fragment IDs of web resources, the references may be too narrowed down such that the analogue referencing mechanism described herein may act like a conventional referencing mechanism. In this context, the analogue referencing mechanism described herein is not an alternative to the conventional referencing mechanisms but a technological advancement that may also provide the solutions of conventional mechanism while enhancing the stability and sustainability of associations dramatically in extremely complex and dynamic web environments.

Referring again to Process C: i) According to the embodiments, ‘a visual element’ or ‘a cluster of interrelated visual elements’ may also be associated with ‘a visual element’ or ‘a cluster of interrelated visual elements’ based on the same principles and methods that are applied for associating a super-object with a web object. ii) Because each UVEI also includes the relative position information of the corresponding visual element with respect to other visual elements, it may be possible for the system to construct a comprehensive reference for the initial state of a cluster based on recorded UVEIs (rUVEIs). On the other hand, cluster information (CI) may also be utilized in this process and cluster information (CI) of each visual element of an interacted cluster may also be included in the database record of the corresponding super-object if preferred, e.g., by adding a sub-field to the locator field of the database record structure 800 and storing thereto. iii) Once an association is identified between a super-object and a cluster of interrelated visual elements, in order to compare the initial state of the cluster with the recent state, the system may construct a reference for the initial state of the cluster based on rUVEIs and construct a reference of the recent state of the cluster based on nUVEIs. The reference for the initial state may be constructed since a UVEI (i.e., a uniform visual element identifier generated based on analyses and interpretation of the visual element) include contextual information ready for executing the process of comparison since each UVEI includes distinctive information extracted based on analyses, such as distinctive information about content of the corresponding visual element. iv) Constructing the initial state or recent state of a cluster based on UVEIs is actually constructing a reference for each state for the process of comparison in order to identify the adaptation procedures to the recent state rather than constructing the actual clusters themselves, since a UVEI includes only distinctive information—identified via analyses—rather than the whole content in most of the cases.

As a result of Process C, i.e., the process of establishing associations, the system associates a super-object with one or more web objects in the rendered web page. Following the execution of Process C, the process terminates.

Process D—910—is executed following the execution of Process A. Process D includes the step of identifying already established associations, i.e., identifying each association between existing super-objects and web objects and adapting to contextual/structural alterations of the web page content that may have occurred between the initial state and the recent state of each associated web object. In this process, based on the comparison of recently extracted contextual references with previously recorded contextual references (which comparison methods are described in the following sections), the system identifies associations between web objects, i.e., visual elements or clusters of interrelated visual elements, and super-objects, i.e., user generated contents and/or applications. In this context, the system queries the database for records of super-objects that are associated with the web page and identifies each of them—if any. After the completion of the extraction of each reference of each visual element and each cluster of interrelated visual elements of the rendered web page in Process A, the system initiates the comparison process of recently extracted references with previously recorded references. For visual elements, the system compares each recorded uniform visual element identifier (rUVEI) with each recently generated uniform visual element identifier (nUVEI)—preferably between elements with similar properties in order to speed up the process. The system may also utilize the identified classes of visual elements, such as basic operational functions, subjective function types, etc., to optimize the process. For clusters of interrelated visual elements, the system compares each recorded ‘uniform cluster function identifier’ (rUCFI)—recorded under the cluster reference field of a super-object—with each of the recently extracted uniform cluster function identifiers (nUCFIs). Next, for a corresponding or matching couple (rUCFI and nUCFI), if the super-object is active, i.e., an application, then, based on the recorded uniform visual element identifiers (rUVEIs) the system constructs a representation of the initial state of the cluster (i.e. the contextual and structural representation of the interacted web object at the instant when the association with the corresponding super-object is established for the first time) and compares it with the representation of the current state (i.e., the contextual and structural representation of the interacted web object at the instant when the association with the corresponding super-object is re-established upon being subsequently rendered or viewed by another user) constructed based on the recently generated uniform visual element identifiers (nUVEIs) in order to identify a procedure to adapt the respective execution procedures of the associated application to the recent state according to a predefined set of adaptation rules. In this context, the system may identify a structurally altered cluster (e.g., a GUI) with a steady function, and adapt itself to the recent structure within a contextually and structurally altered web page.

On the other hand, since the references (UVEIs and UCFIs) are collected/extracted/identified under different conditions they cannot be expected to match exactly for most of the cases. Therefore, the system evaluates the similitude levels of the references and decide whether there is a match. For example, the system may collect content fragments from visual elements that include media files, such as images, videos, audios, documents, etc.—by appropriate sampling procedures particularly selected according to the content properties such as media type, size, format, etc. of each visual element—and include the collected content fragments to the corresponding uniform visual element identifiers (UVEIs) as the distinctive information about content. In such a case, the system may compare content fragments with each other according to their similarities, and for each compared pair of collected content fragments for UVEIs calculates the similarity rate—or resemblance rate—based on the similarity analysis. If similarity percentage of a pair of collected content fragments for UVEIs exceeds a predefined similarity threshold, then the system associates the pair of collected content fragments and therefore the corresponding nUVEis and rUVEIs. Accordingly, various statistical similarity measures may be used as a base for similarity analysis of datasets and various algorithms may be preferred or developed depending on the type of content (e.g., image, audio, video, text, etc.) of elements. Further, semantic similarity comparison of UVEIs, UCFIs, and/or parts thereof may be based on advanced AI algorithms. For example, functional similarities of two clusters may be compared (e.g., comparing the ‘social media post interfaces’ of Facebook™ and Twitter™, which have functional similarities at a certain level). In this context, the system may identify both a contextually and structurally altered cluster (e.g., a GUI) with slightly altered functions in such a degree that comparing the recently extracted UCFIs (nUCFIs) with UCFIs stored in the database as recorded UCFIs (rUCFIs) may result in exceeding a predefined threshold of similarity (i.e., identifying functionally analogous clusters and matching them based on a predefined threshold of functional similarity), thus the system may associate a super-object with the intended cluster and further may adapt itself to the recent state of the cluster both contextually and structurally for execution—based on the comparison of the constructed representation of the initial state (via the corresponding rUVEIs) and constructed representation of the recent state (via the corresponding nUVEIs) and also according to the predefined set of adaptation rules.

The predefined set of adaptation rules is a library of operational rules that is set as regulatory for the system in the process of adapting itself to the most recent state of an interacted web object, i.e., a root-object, in order to execute the associated instructions conveyed through a user generated application that is programmed for the initial state, based on the comparison of initial and recent state representations that are constructed via the corresponding rUVEIs and nUVEIs. In essence, each adaptation rule is set in accordance with both the root-object (e.g., in accordance with its content, structure, role/function, etc.) and the instructions to be executed (i.e., the user generated application developed) to dynamically process/manipulate that web object. The adaptation rules of a user generated application in relation to the web object to be dynamically processed/manipulated by the application is set in the process I, i.e., the process of generating contents and developing applications. According to various embodiments, adaptation rules are set individually for each application in accordance with the web object to be dynamically processed/manipulated by the application. The process of adapting to a web object is significantly more complex and challenging for clusters of visual elements (e.g., GUIs) than that of singular visual elements. In this process, based on the extracted information in the processes A→B→C and A→D, the system identifies possible contextual and/or structural alteration scenarios of a web object to which a user generated application is associated. Next, in cooperation with the developer user, the system semi-automatically determines each adaptation rule that corresponds to an identified alteration scenario. For example, in the case of integrating a functional thumbs down button to a social media post interface, the system determines N number of permutations of structural alterations and accordance with input from the user, determines the position of the thumbs down button and the counter for each permutation. In this process, the user may introduce the positioning condition to the system of the thumbs down button and counter set, i.e., the sub-cluster. An exemplary instruction may be: define ‘thumbs up button and its counter’ as sub-cluster A (i.e., the already existing sub-cluster in the GUI); define ‘thumbs down button and its counter’ as sub-cluster B (i.e., the sub-cluster to be integrated by the system); if possible, position sub-cluster B to the right of sub-cluster A as the first choice; or position sub-cluster B to the left of sub-cluster A as the second choice; else (i.e., if not possible) identify the most similar layout arrangement of the GUI among the N number of layout permutations previously determined and position sub-cluster B accordingly. It is important to note that for complex clusters with many elements and features, such as graphical user interfaces (e.g., a social media post interface), even without the addition of any further elements into, total number of permutations of structural alterations (e.g., alterations in the layout of a GUI without the addition or reduction of visual elements) can be relatively large. Further, the cluster can be structurally divided into sub-clusters, each having different roles/functions and distant positions from each other. Furthermore, the total number of combinations of contextual alterations (e.g., addition of features or alteration of contents including a web image content of an auxiliary element such as a play/pause button icon) can be many, such as infinitely many. In this context, artificial intelligence algorithms may be further developed in accordance with the processes described herein in order to meet the operational needs.

Referring again to Process D: i) Adaptation rules that can be set may be infinitely many or less and may take shape individually or in groups according to each web object and each application to dynamically process/manipulate that web object. In this context, it is believed that the description—including the examples given-regarding the concept of ‘setting and utilizing an adaptation rules library’ fully enables implement of the systems and methods described herein without undue experimentation. ii) As shown in FIG. 9, for applications that are already associated with a web page and may be set to be executed directly, the system may bypass the step E—912—and directly execute the process G—916—for such applications. New applications selected in Process E may be processed in step D—before being executed in process G—in order to identify the corresponding adaptation rules of each. iii) Since a visual element may be technically considered as a single-element cluster, any process applied for a visual element cluster may also be applicable to a visual element, such as identifying UCFIs of visual elements and recording them as rUCFIs to be used as references, or setting up an interaction rule according to a user generated application that is associated with a visual element, etc.

As a result of Process D, i.e., identifying already established associations, the system identifies each web object associated with at least one super-object—if any—and further adapts itself to the most recent state of the interacted web object/s, and thus the system may execute the associated applications—properly—in the rendered web page. Following the execution of Process D, Process E may be initiated.

Process E—912—includes the step of displaying metadata of associated super-objects in a web page. In this process, based on identified associations in the web page that the user is viewing and based on ‘user specific’ recommendations of the system, the system displays metadata of super-objects for user's selection. For super-objects that are identified as available according to the recommendations, the system displays metadata in relation with the associated web objects through intelligent interfaces for the selection of the user. In this context, the system may sort available super-objects according to their quality score, popularity, suitability, etc. and the highest-ranking ones may be displayed. Although the system may always display metadata of passive super-objects, as a special case for the active super-objects that have been previously associated, the system may automatically execute the applications without displaying any metadata and bypass this step in some examples.

As a result of Process E, i.e., displaying metadata of super-objects, the system enables the user to select super-objects to be display or executed based on the user specific recommendations of the system in the rendered web page. Following the execution of Process E, Process F—914—and/or Process G—916—may be initiated depending on, for example, the selection/s and/or instructions of the user.

Process F—914—includes the step of displaying superimposed contents, i.e., passive super-objects. In this process, based on the user's selection of a preview of a passive super-object from a metadata list, the system displays the selected passive super-object through intelligent interfaces in relation with the web object that the passive super-object is associated with. The system may be controlled to avoid interference with the content and structure of the web page, and instead only display markers that indicate the existence of associated metadata of passive super-objects and smart interfaces that convey user generated contents if preferred or required by the user and/or system. Such content manipulation controls may be configured in the system based on global system wide settings, country wide settings, statewide settings, city wide settings, content provider level settings, website level settings, web page level settings, web page element level settings or any other granularity and/or criteria that selectively avoids interference with the content and structure of web pages. For example, the system may be set to allow interference with the content and structure for a first country, uniform resource locator (URL), or web page and may be set to prohibit such activity for another country, URL and/or web page. In other words, the system may be configured to selectively allow or not allow direct content integration in web pages in order to maintain and control any legal, ethical, and/or fair use conditions that may be desired or present. In this context, for example, users may be prohibited to replace a web page content with a user generated one including replacement of advertisements.

As a result of Process F, i.e., displaying passive super-objects, the system enables users to view a user generated content that is selected from a metadata list that is related to a web object in the rendered web page. Following the execution of Process F, Process H—918—may be initiated.

Process G—916—includes the step of executing superimposed applications, i.e., super-objects. In this process, based on the adaptation procedures identified in Process D,—which are identified in order to adapt the respective execution procedures developed for the corresponding root-object (i.e., the initial state of the corresponding element or element cluster) to the recent state—the system executes each super-object that is either selected from a metadata preview or already associated into the web page by the user.

As a result of Process G, i.e., executing super-objects, the system executes each selected user generated application that is developed to dynamically process/manipulate the associated web object by adapting to the recent state. Following the execution of Process G, Process H may be initiated.

Process H—918—includes the step of enabling interactions with/through super-objects. In this process, the system enables the user to connect and interact with other users through the super-objects that act as network links. For example, the user may interact with other users through commenting interfaces integrated with passive super-objects—similar to that of social media posts—and further may communicate with other users independently, for example, via private messengers operating on a peer-to-peer (P2P) basis. In this context, the system provides users with the ability to create a webwide social network upon web resources through super-objects, thus providing a boundless and versatile social networking alternative (i.e., superimposed networking) to conventional social networking platforms, such as Facebook™, Twitter™ Instagram™, etc. Furthermore, Process H enables further interactions with super-objects, such as enabling users to further associate user generated contents and applications, i.e., second-order super-objects, with first-order super-objects via utilizing the algorithms described herein—if needed—and/or other external applications and/or algorithms.

As a result of Process H, i.e., enabling further interactions with/through super-objects, the system i) enables the user to connect and interact with other users through super-objects and to interact with super-objects themselves via associating second-order super-objects with them in a rendered web page.

Process I—920—includes the step of generating contents and developing applications. In this process, the system enables the user to generate contents and develop applications to be associated with web objects. In the process of generating contents, the system provides the user with tools to create, arrange, and edit texts, images, videos, audios, documents, etc. that may be separate and distinct from a web page and/or may be included in a web page. The processes to create, arrange, and edit texts, images, videos, audios, documents, etc., may be conventional processes, such as being similar to that of generating social media posts. In the process of developing applications, the system provides a set of tools and frameworks (e.g., a superimposed software development framework) in order to assist the user—who may be an expert web developer or a non-expert layman—to develop applications that dynamically process/manipulate visual elements and/or clusters of interrelated visual elements. In this context, based on the user's expertise level in programming, and also for example, his/her occupation, socio-economic class, fields of interest, etc. the system may share application examples—if any—according to the web objects that the user wishes to process/manipulate, and further may assist him/her in the development process. Further, the system may utilize algorithms of explainable AI to help the user to understand and interpret the decisions or predictions made by the system. Thus, the user may debug and improve application performance. Furthermore, the system may utilize hybrid intelligence workflow patterns for the co-creation, deployment, and adoption. Thus, users' engagement, willingness to adopt and willingness to co-create may be increased. Furthermore, utilizing hybrid intelligence, the system, in collaboration with the user, may set adaptation rules individually for each application developed in accordance with the web object to be processed/manipulated by the application—as elaborated in Process D.

Referring again to Process I: The superimposed software development framework (SSDF) is an envisioned framework to be provided by the system in order to facilitate the development of superimposed software applications. SSDF may leverage capabilities of the system (i.e., all operations performed based on the processes 902, 904, 906, 908, 910, 912, 914, 916, 918, etc.) such as the interpretations of web objects based on analyzing, classifying, clustering, referencing, comparing, etc. In principle SSDF utilizes both the interpretations of the system such as UVEIs, BOFs, SFTs, Cis, UCFIs, and rule libraries such as system-defined interaction rules, in order to identify programming options for each identified visual element and/or cluster of interrelated visual elements in a web page. In this context, one of the interesting features of the SSDF is ‘contextual programing’ which emerges based on the above-mentioned facilities provided by the system. Contextual programing is a high-level programing approach which may enable both expert and non-expert (layman) users to develop user generated applications that process/manipulate web objects. Alternatively, or in addition, such user generated applications may be retrieved from an applications library of pre-stored user generated applications. Such an applications library may be for access by a particular user, a group of users, and/or all users. Automated programming by the system of such user generated applications may include AI (artificial intelligence) algorithm-based population, by the system, of the user generated applications with webpage specific information obtained by the system's interpretation of web objects and based on analyzing, classifying, clustering, analogue referencing, etc. For example, SSDF may recommend the user to adapt from the application library and/or develop an application for a particular GUI (e.g., a video player interface, a social media post interface, etc.) regardless of any web source and may automatically adapt the developed application for any web resource that includes similar GUIs that are within the proximity of a certain similarity rate—or resemblance rate—that is set by, for example, the system, or the user, or the system and the user collaboratively together. Thus, the system may customize a developed application for a particular web page the user wishes to associate with the developed application according to the interpretation, by the system, of the web objects of the particular web page based on AI, where the AI is further trained by the collaborative interaction of the user with the system during adaptation/development of the developed application for the particular web page. Alternatively, or in addition, the user may introduce to the system the function/s of a previously unidentified cluster (e.g., a table with certain functions) and the system/user may develop and/or adapt an application/program that process and manipulate similar clusters. Further, SSDF may use previously developed user generated application(s) from the library as samples/examples to identify and recommend programing possibilities to the users by utilizing AI algorithms (such as machine learning models) that may be specially developed for this purpose and further refined/taught based on the user interaction with the system. Furthermore, SSDF may record each corresponding development and deployment process of user generated applications—that are developed in SSDF—to accumulate a big data of software development and deployment processes and may process the big data by specially designed advanced AI algorithms to extract information for conceptualization of software development ideas. Moreover, the system may automatically adapt such developed and associated applications according to changes in web pages as discussed herein.

As a result of Process I, i.e., generating contents and developing applications, the system enables the user—even if he/she is a layman—to develop web-based applications that dynamically process/manipulate web objects,—thus enables the user to become a service provider—while providing a conventional tool for generating contents.

The steps A→B and A→D are automatically re-executed if the visited web page is subsequently rendered. However, the steps C, E, F, G, and H may be selectively re-executed according to the demand of the user while the user is browsing the rendered web page—without any subsequent renderings. For example, the user may wish to develop an application and may wish to associate the application with a web object. Thus Process I and Process C may be re-executed. Or the user may wish to select, display, and execute other super-objects from various metadata lists that are associated with various web objects. Thus, Process E, Process F, Process G, and Process H may be re-executed. The process 900 terminates when browsing of the visited web page is finalized, according to the embodiments.

As a result of the steps A→B→C, the system: i) controls web objects to be interacted with via determining ‘what exactly the objects of web resources are’ at a contextual level, and deciding ‘how users may interact with them’ according to system-defined interaction rules with respect to the development and deployment process of super-objects; and further ii) establishes associations between ‘prospective super-objects developed’ and ‘corresponding web objects interacted’ via storing ‘respective contextual references extracted’ and ‘interaction procedures developed’ for each pair. As a result of the steps A→D, the system: i) re-establishes associations between super-objects and web objects despite contextual and/or structural alterations—i.e., all kinds of alterations of objects in respective environments—via re-determining ‘what exactly the objects of web resources are’ at a contextual level, and comparing ‘recently extracted contextual references’ with ‘contextual references stored’; and further ii) adapts the interaction procedures developed for the initial state to the recent state via constructing and comparing ‘initial state representations’ with ‘recent state representations’ of the associated web objects. Thus, as a result of the steps A→B→C and A→D, the system ensures the stability and sustainability of interactions. Or more comprehensively, as a result of the steps A→B→C, or A→I→B→C and A→D→E→F→H, or A→D→G→H, or A→D→E→D→G→H, the system ensures the consistency and persistency of interactions in any web environment within any scenario, in real-time, in a self-contained manner while enabling human and machine users to select, display, execute, and interact with super-objects including interacting with each other through the super-objects that act as network links.

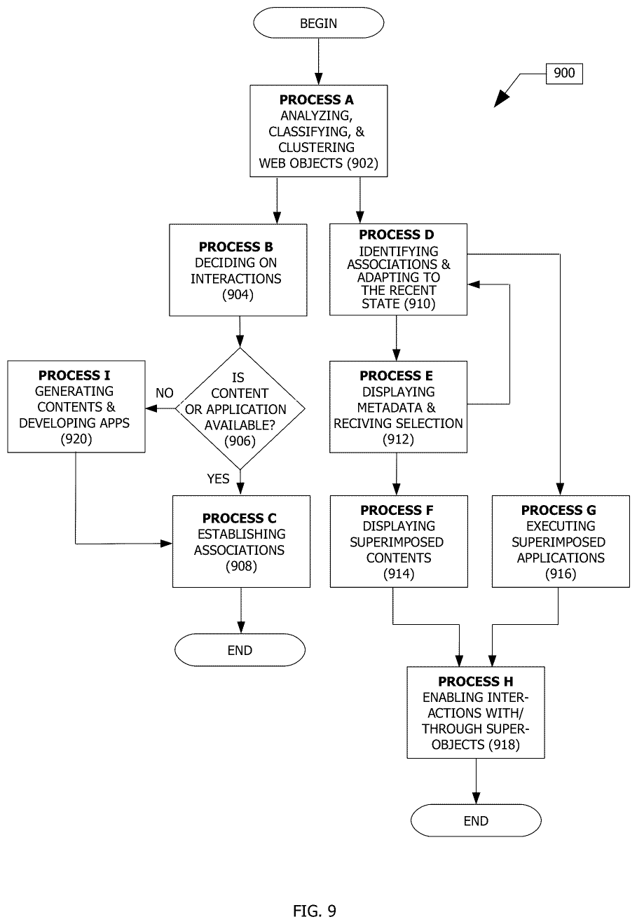

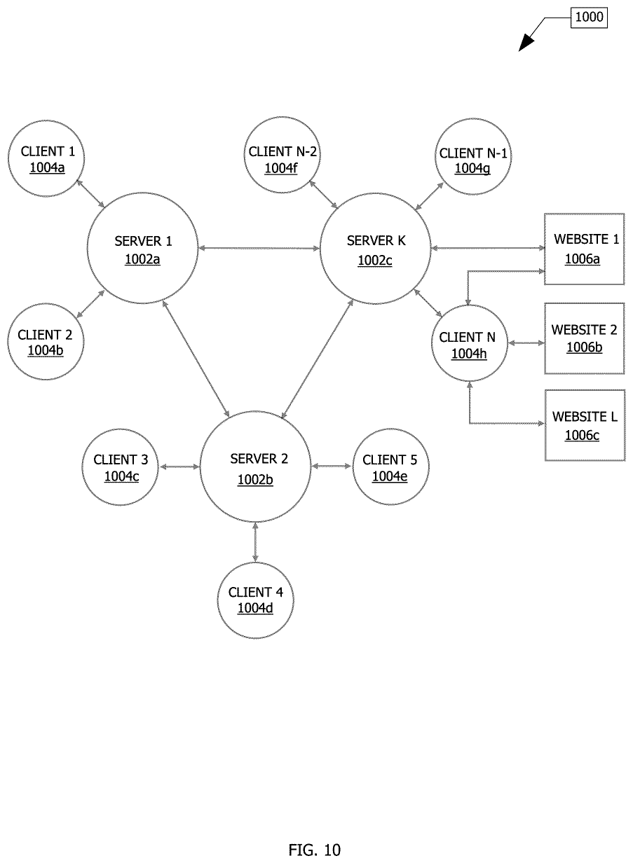

FIG. 10 is a high-level architecture of an exemplary web resource interaction system 1000 consisting of multiple servers 1002 deployed in various locations working in sync with each other (for example, in an administratively decentralized federative structure), according to an embodiment. In this configuration 3 of the K number of servers (1002a, 1002b and 1002c) and 8 of the N number of clients (1004a, 1004b, 1004c, 1004d, 1004e, 1004f, 1004g and 1004h) are shown. Client N (1004h) is shown connected to 3 arbitrary websites (1006a, 1006b and 1006c) and Server K (1002c) is also shown directly connected to the arbitrary website 1006a. At least one client-side application is integrated with the corresponding web browser of each client and executed—along with the web browser—autonomously or in coordination with the server 1002 according t₀, or depending on, the operation. A server-side application may be executed by an application server in coordination with a database server and a web server. In essence, aside from being an intermediary for interaction, the primary task of a client N may be interaction control. On the other hand, a primary task of a server may be to provide a database and to perform database related operations in coordination with the clients connected. In this context, at each viewing/rendering of a web page, Client N (1004h) autonomously processes: i) analyzing, classifying, and clustering web objects of the rendered portions of the web page; ii) deciding on interactions of the rendered portions of the web page; and iii) assisting users—if requested—in the process of generating contents and/or developing applications to be associated with the web objects of the web page. On the other hand, Server K (1002c) and Client N (1004h) collectively process: i) establishing associations with web objects; ii) identifying already established associations with web objects; iii) displaying metadata of established associations of web objects; iv) displaying passive super-objects according to the associations; and v) executing super-objects, including adapting the super-objects in accordance with the contextual and structural alterations of the web page. In this configuration data exchange between the system and the website servers may be, for example, provided primarily through the clients (shown with the network connections 1004h to 1006a, 1006b and 1006c). In other words, a server may not be directly connected and/or in direct communication with web resources, instead, access and data exchange may be provided through the clients only. This may minimize the system load—particularly data processing load—on the server side and could be inevitably essential for all personalized and restricted web resources such as web pages of adaptive web sites or individualized social media web pages. Even so, the server may also scan or otherwise communicate directly with the web resources (shown with the network connection 1002c to 1006a), such as for preliminary analyses, or for allocating system load in a preferred proportion between the client side and server-side, where it is applicable, according to the embodiment.

To recap; According to various embodiments, the web resource interaction system comprises the following processes: i) analyzing a rendered web page being viewed by a user; ii) identifying visual elements in the web page; generating, for each of the identified visual elements, uniform visual element identifiers (UVEIs), each of the UVEIs uniquely identifying a corresponding one of the identified visual elements; associating, with each of the UVEIs, information regarding the web page, distinctive information and/or properties of content of the corresponding one of the visual elements, and a relative position of the corresponding one of the visual elements in the web page; iii) classifying each of the visual elements into one of a plurality of predetermined classes; identifying, for each of the visual elements, cluster information to interrelate the visual elements within the web page, the cluster information identified for each of the visual elements based on respective relative position of the visual elements, respective functional relationships of the visual elements with other visual elements, or both; iv) identifying, for each of the clusters of interrelated visual elements, function/s within the web page, and generating, for each of the clusters of interrelated visual elements, uniform cluster function identifiers (UCFIs), each of the UCFIs including a corresponding one of the function/s of clusters of interrelated visual elements; v) deciding on the visual elements and clusters of interrelated visual elements to identify those of the visual elements and clusters of interrelated visual elements suitable for user interaction in respect of the development and deployment process of super-objects, the decision is based on a set of predefined interaction rules comprising the cluster information and the classification of visual elements and the uniform cluster function identifiers (UCFIs) of clusters of interrelated visual elements; vi) receiving the user's selection of one of the visual elements or clusters of interrelated visual elements among the available ones for interaction; vii) assisting the user to develop an application that dynamically process and/or manipulate the selected visual element or cluster of interrelated visual elements; setting adaptation rules in coordination with the user for the user generated application according to the corresponding visual element or cluster of interrelated visual elements that the user generated application is to be associated with; viii) receiving an input representative of a user interaction, e.g., a user generated application, with one of the visual elements or clusters of interrelated visual elements available for user interaction in respect of the development and deployment process of super-objects; ix) storing the user interaction, e.g., user generated application, with the one of the visual elements as super-object in association with the one of the UVEIs; or, storing the user interaction, e.g., user generated application, with the one of the clusters of interrelated visual elements as super-object in association with the corresponding set of the UVEIs that belong to the cluster and recording the corresponding UCF of the cluster and/or recording for each of the UVEIs that belong to the cluster the corresponding one of the identified classes and cluster information; x) re-analyzing the rendered web page being viewed by another user and/or when the web page is subsequently rendered; xi) re-identifying the visual elements in the web page; generating, for each of the identified visual elements, new uniform visual identifiers (nUVEIs), each of the nUVEIs uniquely identifying a corresponding one of the identified visual elements; associating, with each of the nUVEIs, information regarding the web page, distinctive information and/or properties of content of the corresponding one of the visual elements, and a relative position of the corresponding one of the visual elements in the web page; xii) re-classifying each of the visual elements into one of a plurality of predetermined classes; re-identifying, for each of the visual elements, cluster information to interrelate the visual elements within the web page, the cluster information identified for each of the visual elements based on respective relative position of the visual elements, respective functional relationships of the visual elements with other visual elements, or both; xiii) re-identifying, for each of the clusters of interrelated visual elements, function/s within the web page, and generating, for each of the clusters of interrelated visual elements, new uniform cluster function identifiers (nUCFIs), each of the nUCFIs including a corresponding one of the function/s of clusters of interrelated visual elements; xiv) comparing the nUVEIs with UVEIs stored in a database as recorded UVEIs (rUVEIs) and associating the nUVEIs with the rUVEIs based on a predefined threshold of similarity; and/or comparing the nUCFIs with UCFIs stored in a database as recorded UCFIs (rUCFIs) and associating the nUCFIs with the rUCFIs based on a predefined threshold of similarity, thus re-establishing a previously established association between a super-object and a visual element or a cluster of interrelated visual elements—in the context of analogies; and xv) constructing based on rUVEIs the initial state representation and based on nUVEIs the recent state representation of each cluster of interrelated visual elements that is associated with one or more user generated application; and comparing the initial state representation with the recent state representation to identify contextual and structural differences—if any—between the states of each associated cluster of interrelated visual elements; and identifying a procedure to adapt the respective execution procedures to the most recent state of each associated cluster of interrelated visual elements according to the identified contextual and structural differences—if any—and a predefined set of adaptation rules defined for each corresponding user generated application and associated cluster pair; according to the embodiments.

### Generalization of the Methods and Systems—From Web Objects to Physical Objects:

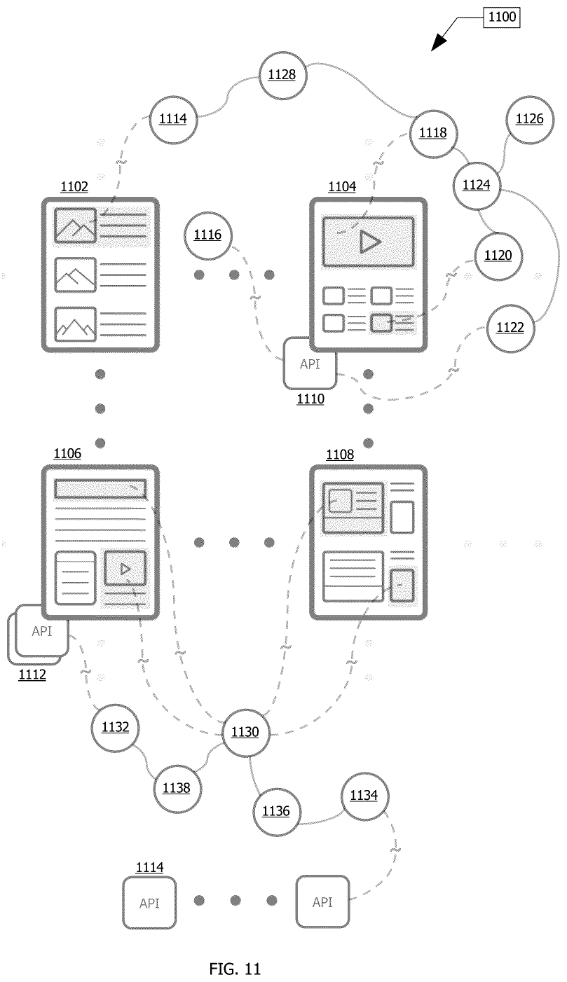

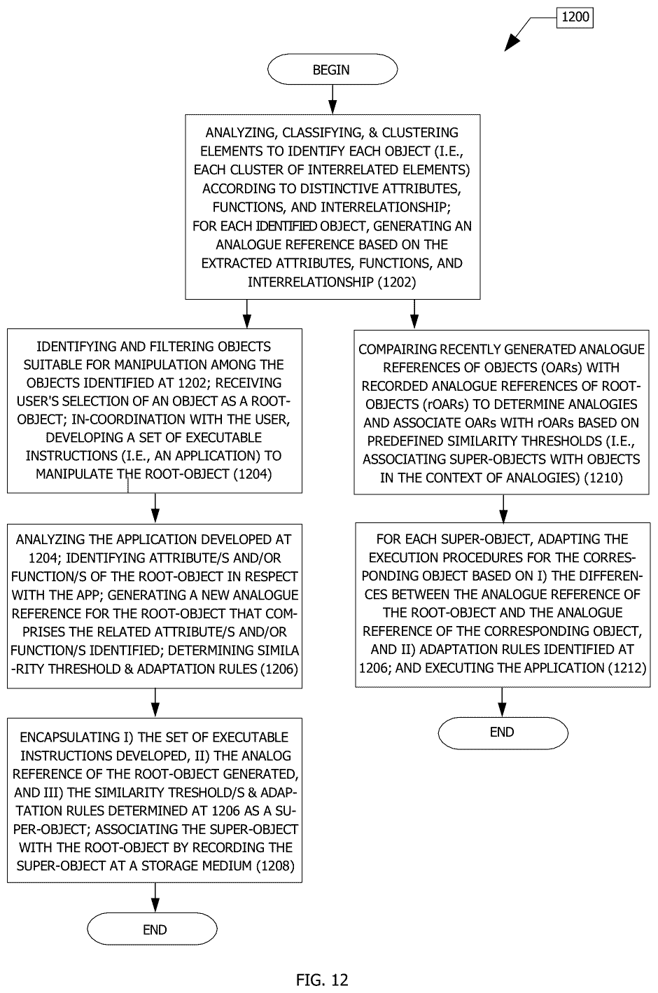

FIG. 12 is the flowchart diagram 1200 illustrating a process that includes steps with respect to processing of/interacting with any virtual and/or physical object, according to an embodiment. The methods and principles used in process 1200 are the same methods and principles used in the processes described earlier, the only difference is that this time the process is applied to any virtual or physical object in general, rather than specifically to web objects;

The process begins with an encounter of the system with one or more object/s in an environment—which may be an automation system, such as a robot, encountering physical objects, such as physical structures. The system may involve various sensors, transducers, actuators, and controllers designed to interact with the environment, i.e., objects in the environment, to be used in the process of i) analyzing, classifying, and clustering elements in order to identify each sub-object that belongs to the main object that is being processed and ii) manipulating those elements in order to execute existing or future—executable—procedures developed.

At 1202, the system analyzes, classifies, and clusters elements to identify each object (i.e., each element and each cluster of interrelated elements) according to distinctive attributes, functions, and interrelationship. Next, for each identified object, i.e., for each element and cluster of interrelated elements, the system generates an analogue reference based on the extracted attributes, functions, and interrelationship. Following the execution of process 1202, process 1204 and process 1210 may be initiated individually and simultaneously since they are independent of each other.

At 1204, based on the analogue references generated at 1202, the system identifies and filters objects suitable for manipulation, for example, based on system-defined interaction rules. Next, the system receives user's selection of an object as a root-object. Next, in coordination with the system, the user develops a set of instructions, i.e., execution procedures or application, to manipulate the root-object. The process also includes generating contents related with the execution procedures or the application.

At 1206, the system analyzes the application developed at 1204 and identifies attribute/s and/or function/s of the root-object—specially—related with the application. Next, the system generates a new analogue reference for the root-object that comprises the related attribute/s and/or function/s identified. Next, based on the analogue reference of the root-object, the system determines similarity threshold/s & adaptation rules.

At 1208, the system encapsulates: i) the set of instructions developed including related contents created; ii) the analogue reference of the root-object generated; and iii) the similarity threshold/s and adaptation rules determined; at 1206 as a super-object. Next, the system associates the super-object with the root-object by recording the super-object at a storage medium.

As a result of 1202, 1204, 1206 and 1208 the system: i) controls objects to be interacted with via determining ‘what exactly the encountered objects are’ at a contextual level, and deciding ‘how users may interact with them’ according to system-defined interaction rules with respect to the development and deployment process of super-objects; and further ii) establishes associations between ‘prospective super-objects developed’ and ‘corresponding objects interacted’ via storing ‘respective analogue references extracted’ and ‘interaction procedures developed’ for each pair.

At 1210, the system compares recently generated ‘analogue references of objects’ (OARs) with ‘recorded analogue references of root-objects’ (rOARs) to determine analogies and associates OARs with rOARs based on predefined similarity thresholds. Next, for each matching pair, the system associates the super-object with the corresponding object. Thus, the system re-associates super-objects with objects in the context of analogies.

At 1212, for each super-object, the system adapts the execution procedures developed for the root-object to the corresponding object based on i) the difference between the analogue reference of the root-object and the analogue reference of the corresponding object, and ii) adaptation rules identified at 1206. Next, the system executes the new execution procedures accordingly.

As a result of 1202, 1210, and 1212 the system: i) re-establishes associations between super-objects and objects despite contextual and/or structural alterations—i.e., all kinds of alterations of objects in respective environments—via re-determining ‘what exactly the objects are’ at a contextual level, and comparing ‘recently extracted analogue references’ with ‘analogue references stored’; and further ii) adapts the interaction procedures developed for the initial state to the recent state via constructing and comparing ‘initial state representations’ with ‘recent state representations’ of the associated objects.

Consequently, by the processes 1202→1204→1206→1208 and 1202→1210→1212, the system ensures the stability and sustainability of interactions with virtual or physical objects in any environment, within any scenario, in real-time, in a self-contained manner.

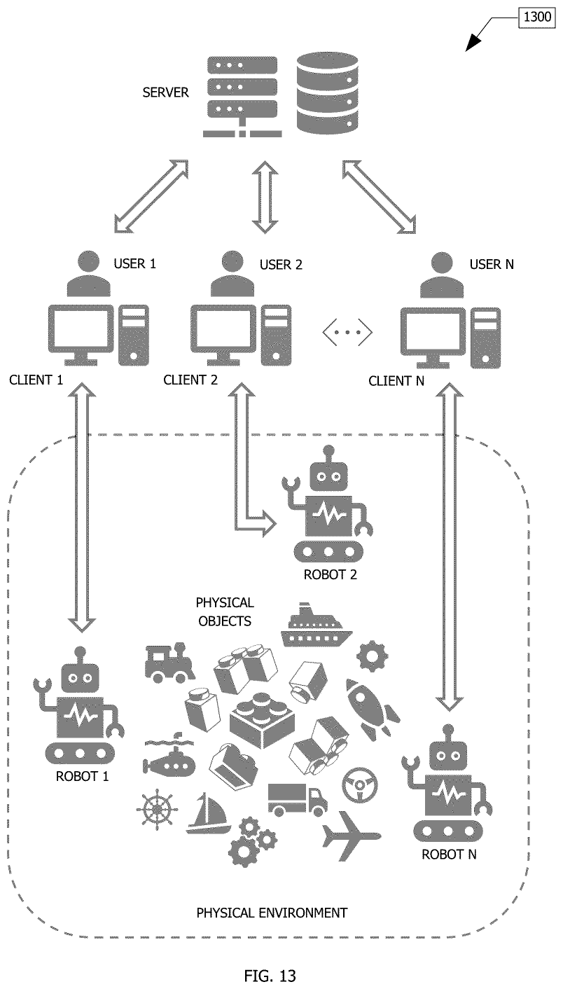

FIG. 13 is a high-level architecture of an exemplary system processing both virtual and physical objects, according to an embodiment. A server, N number of clients, N number of users, N number of robots, and various physical objects in a physical environment are shown. The server and the clients of the system are connected with each other through a data network, such as the Internet. Through the same—or another—data network, each client is further connected to a robot that performs at a remote environment where the robots interact with physical objects, such as lego structures that are created and modified by children at a playground. The robots are used as agents between the users and the objects in the environment—similar to the function of a browser in Web environments, according to the embodiment.

According to another embodiment, the robots are equipped with advanced optic, ultrasonic, and x-ray imaging sensors, robotic arms and end-effectors designed to interact specially with lego structures. Within the environment, all sorts of lego structures and pieces exist, such as planes, trains, automobiles, snow mobiles, houses, cities, robots, space stations, etc., including sub-structures such as engines, wings, tracks, etc., and all sorts of lego pieces, wherein each lego piece corresponds to an element, i.e., elementary object. By the optical, ultrasonic and x-ray imaging a robot may perceive each element in detail including the enclosed ones within lego structures. While, by robotic arms and end-effectors a robot may manipulate lego structures and pieces precisely, such as assembling, disassembling, installing, etc. The task of the robots may be: i) assisting users to create prospective super-objects that include virtual and physical contents—such as links for the Internet of things (IoT) and other lego pieces or lego structures for coupling—and instructions with respect to lego pieces, sub-structures or whole structures—such as the brick, engine, or whole structure of a lego car; ii) associating prospective super-objects with corresponding lego structures, i.e., storing user interactions with corresponding lego structures such as storing a set of instructions developed to modify a particular sub-structure of a particular lego structure when encountered; iii) re-establishing associations during subsequential encounters with lego structures; iv) adapting execution procedures developed for the initial state to the recent state of lego structures; and v) executing corresponding execution procedures for each association—such as executing particular instructions to modify a particular sub-structure of a lego structure with various lego pieces or sub-structures or whole structures included in the corresponding super-object; according to the embodiment. In the process, although the children may try to confuse the system by manipulating lego structures with clever alterations, the system may cope with such adversary interventions by the methods and principles described herein.

To recap; According to various embodiments, the system comprises the following processes: i) analyzing an object or a cluster of objects encountered in a virtual or physical environment; ii) identifying elements of the object/s; generating, for each of the identified elements, uniform element identifiers (UEIs), each of the UEIs uniquely identifying a corresponding one of the identified elements; associating, with each of the UEIs, information regarding the affiliated main object and the environment in which the main object is located, distinctive information and/or properties of content of the corresponding one of the elements, and a relative position of the corresponding one of the elements in the main object; iii) classifying each of the elements into one of a plurality of predetermined classes; identifying, for each of the elements, cluster information to interrelate the elements within the main object, the cluster information identified for each of the elements based on respective relative position of the elements, respective functional relationships of the elements with other elements, or both; iv) identifying, for each of the clusters of interrelated elements, function/s within the main object, and generating, for each of the clusters of interrelated elements, uniform cluster function identifiers (UCFIs), each of the UCFIs including a corresponding one of the function/s of clusters of interrelated elements; v) deciding on the elements and clusters of interrelated elements to identify those of the elements and clusters of interrelated elements suitable for user interaction in respect of the development and deployment process of super-objects, the decision is based on a set of predefined interaction rules comprising the cluster information and the classification of elements and the uniform cluster function identifiers (UCFIs) of clusters of interrelated elements: vi) receiving the user's selection of one of the elements or clusters of interrelated elements among the available ones for interaction; vii) assisting the user to develop an application that dynamically process and/or manipulate the selected element or cluster of interrelated elements; setting adaptation rules in coordination with the user for the user generated application according to the corresponding element or cluster of interrelated elements that the user generated application is to be associated with: viii) receiving an input representative of a user interaction, e.g., a user generated application, with one of the elements or clusters of interrelated elements available for user interaction in respect of the development and deployment process of super-objects; ix) storing the user interaction, e.g., user generated application, with the one of the elements as super-object in association with the one of the UEIs; or, storing the user interaction, e.g., user generated application, with the one of the clusters of interrelated elements as super-object in association with the corresponding set of the UEIs that belong to the cluster and recording the corresponding UCFI of the cluster and/or recording for each of the UEIs that belong to the cluster the corresponding one of the identified classes and cluster information; x) re-analyzing an object or a cluster of objects re-encountered—or suspected to be interacted before—in a virtual or physical environment; xi) re-identifying the elements of the object/s; generating, for each of the identified elements, new uniform element identifiers (nUEIs), each of the nUEIs uniquely identifying a corresponding one of the identified elements; associating, with each of the nUEIs, information regarding the affiliated main object and the environment in which the main object is located, distinctive information and/or properties of content of the corresponding one of the elements, and a relative position of the corresponding one of the elements in the main object; xii) re-classifying each of the elements into one of a plurality of predetermined classes; re-identifying, for each of the elements, cluster information to interrelate the elements within the main object, the cluster information identified for each of the elements based on respective relative position of the elements, respective functional relationships of the elements with other elements, or both; iv) re-identifying, for each of the clusters of interrelated elements, function/s within the main object, and generating, for each of the clusters of interrelated elements, new uniform cluster function identifiers (nUCFIs), each of the nUCFIs including a corresponding one of the function/s of clusters of interrelated elements; xiv) comparing the nUEIs with UEIs stored in a database as recorded UEIs (rUEIs) and associating the nUEIs with the rUEIs based on a predefined threshold of similarity; and/or comparing the nUCFIs with UCFIs stored in a database as recorded UCFIs (rUCFIs) and associating the nUCFIs with the rUCFIs based on a predefined threshold of similarity, thus re-establishing a previously established association between a super-object and an element or a cluster of interrelated elements—in the context of analogies; and xv) constructing based on rUEIs the initial state representation and based on nUEIs the recent state representation of each cluster of interrelated elements that is associated with one or more user generated application; and comparing the initial state representation with the recent state representation to identify contextual and structural differences—if any—between the states of each associated cluster of interrelated elements; and identifying a procedure to adapt the respective execution procedures to the most recent state of each associated cluster of interrelated elements according to the identified contextual and structural differences—if any—and a predefined set of adaptation rules defined for each corresponding user generated application and associated cluster pair; according to the embodiments.

### Ontological Consequences of the Disclosed Methods and Principles—Transforming-Objects, Transforming-Classes, and Analogue Relationships:

An ontology involves representing knowledge in the form of a formal, explicit specification of the ‘concepts’ (classes), ‘properties’, and ‘relationships between them within a particular domain’. In other words, there are three main components to an ontology, which are i) concepts: the distinct types of things, i.e., classes, that exist in our data; ii) relationships: properties that connect two concepts; and iii) attributes: properties that describe an individual concept. Within the context of ontologies, one of the approaches to represent knowledge is semantic networks or knowledge graphs. A semantic network involves representing knowledge through nodes and links, where nodes represent objects or concepts and links represent their relationships.

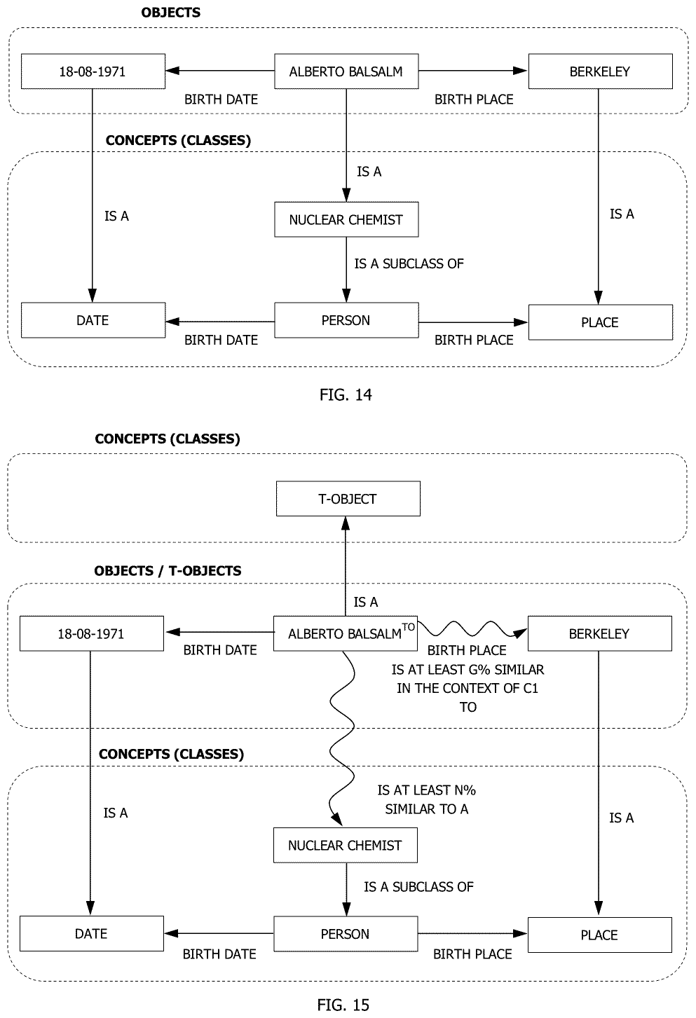

FIG. 14 is an example semantic network, i.e., knowledge graph, of an arbitrarily chosen ontology model involving objects, concepts, and their relationships. The example semantic network presented at FIG. 14 has been modified gradually in FIGS. 15, 16 and 17 in order to describe the ontological consequences of the disclosed methods and principles.

In the example semantic network presented at FIG. 14, a person named ‘Alberto Balsalm’, the city of ‘Berkeley’ and the date ‘18-08-1971’ are objects, while ‘date’, ‘person’, ‘place’, and ‘nuclear chemist’ are concepts (classes) of the model. According to the ontology model, ‘Alberto Balsam’ is a ‘nuclear chemist’ whose birth date is ‘18-08-1971’ and birthplace is ‘Berkeley’. Further, the model states that ‘18-08-1971’ is a ‘date’ and ‘Berkeley’ is a ‘place’, while ‘nuclear chemist’ is a subclass of ‘person’, ‘birth date’ is a subclass of ‘date’ and ‘birthplace’ is a subclass of ‘place’. Note: 18-08-1971 is a data object conveying a specific date information.

Semantically i) ‘Alberto Balsam is a nuclear chemist’ means that ‘the object named Alberto Balsalm possesses all of the properties (attributes) of the concept of nuclear chemist’, ii) ‘18-08-1971 is a date’ means that ‘the object named 18-08-1971 possesses all of the properties (attributes) of the concept of date’, and iii) ‘Berkeley is a place’ means that ‘the object named Berkeley possesses all of the properties (attributes) of the concept of place’. Further, i) ‘nuclear chemist is a subclass of person’ means that ‘the concept of nuclear chemist possesses all of the properties (attributes) of the concept of person’, ii) ‘birthplace is place’ means that ‘the concept of birthplace possesses all of the properties (attributes) of the concept of place’, and iii) ‘birth date is date’ means that ‘the concept of birth date possesses all of the properties (attributes) of the concept of date’, thus they are subclasses—or sub concepts—of their parent classes or parent concepts.

FIG. 15 is an example semantic network, i.e., knowledge graph, created by modifying the ontology model presented at FIG. 14 according to the disclosed methods and principles. The example semantic network involves a ‘transforming-object’—or a ‘t-object’ in short—and ‘its analogue relationship with other objects and concepts’, including a graphical method for representing t-objects and their analogue relationships within semantic networks.

As previously stated, a transforming-object is an object that is assumed to transform unpredictably between manifestations, appearances, or observations (accordingly nick named as ‘transformer’ inspired by the transforming biomechanical robot concept of Marvel Comics). More precisely, a t-object is an object that is assumed to involve multiple states within a certain context, where each state represents a corresponding one of the possible manifestations of the t-object in a non-deterministic and non-hysteresis manner. Further, a t-object is postulated to be related to another object within a particular context if the similarity rate—with respect to the compared object—is greater than or equal to a certain threshold of similarity. Hence, the relationship of a t-object with another object is not binary, i.e., having the values 0 or 1, for example, defined as either ‘is’ or ‘is not’ for representing identicality and irrelevance respectively in the context of a particular concept. Instead, the relationship of a t-object with another object is fuzzy, i.e., having infinitely many values in the unit interval [0, 1], for example, postulated to be related at a certain degree if the extracted similarity rate is greater than or equal to a similarity threshold where the similarity threshold is greater than 0 (i.e., 0<similarity threshold≤similarity rate≤1) in the context of a particular concept. Consequentially, the concept of t-objects and processing such objects including controlling the associations between them and adaptation directly relates to fuzzy-set theory, fuzz-logic, and fuzzy control. In the context of the disclosed subject matter, i.e., Object Aware Fuzzy Processing Based on Analogies, the concept of ‘transforming-object’ or—t-object in short—is defined as follows:

In a universe wherein each elementary object (i.e., objects that are not compositions of other objects, i.e., building blocks) and each elementary interaction (i.e., interactions between elementary objects) are postulated to be precisely observable, a transforming-object—or t-object in short—possesses the following properties; i) Existence: A t-object involves multiple states, where each state represents a corresponding one of the possible manifestations of the t-object, which may be any object that is a member of the set of all possible objects that the t-object may involve. ii) Transformation: A t-object is postulated to be transforming (or hopping) from one state to another unpredictably between manifestations in a non-hysteresis manner—even if it seems to behave in a predictable manner. iii) Composition: Each manifestation of a t-object is a composition of—one or more—precise elementary objects. iv) Observability: Each manifestation of a t-object is precisely observable (hence t-objects are isolated from the fuzziness or uncertainties caused by observational limitations). v) Relationship: A t-object is postulated to be related to another object within a certain context if its similarity rate with respect to the reference object is greater than or equal to a predefined similarity threshold. vi) Limits: if a t-object is said to be bounded then it transforms within a certain context within the capacity of the universe to which it belongs. Similarly, if a t-object is said to be unbounded then it transforms without any contextual limitations within the capacity of the universe to which it belongs. vii) Manifestations: Each manifestation of a t-object is a member of a subset that comprises all arrangements of ‘elementary objects and their interactions with each other’ that does not violate the rules dictated by the context that the t-object is bounded.

According to various embodiments, with respect to similarity comparison, such as between a manifestation of a t-object and a reference concept—which identifies the context—, a basic approach may be: For k∈Z+, ω∈R|0≤ω≤1, P=0 or 1, Similarity Rate=100%×(ω₁P₁+ω₂P₂+ω₃P₃+ . . . +ωₖPₖ)/k, where Pₖ is the membership value of the object or concept—that is being compared—with respect to k^{th} property of the reference concept—i.e., class—, while ωₖ is the weight of the same k^{th} property. Further, property weightings o, which may be based on priority, reliability, consistency, etc., may be altered dynamically, such as based on particular outputs of the network that the object being processed belongs. Further, binary membership values P may be fuzzified into a fuzzy membership function, thus binary truth values (i.e., 0 or 1) can be transformed into fuzzy truth values (i.e., real numbers between 0 and 1). Thus, for the manifestations involving uncertainty with respect to properties—for example, when encountered with an unprecedented manifestation of a t-object involving properties that are absolutely novel to mankind—similarity rates may still be identified reliably, according to the embodiments. According to other embodiments, said rules for similarity comparison and relationship status may be modified in accordance with the applicational needs, such as each membership value Pₖ—of a t-object that is being compared with a reference class—may also be required to individually exceed a minimum threshold in order to consider said object related to the reference class.

In FIG. 15, ‘Alberto Balsalm’ is replaced with a hypothetical transforming ‘Alberto Balsalm’, which is indicated with “TO”-short for transforming-object—at the upper right corner of the identifier and the concept of t-object is added as a new class to the semantic network. According to the knowledge graph, t-Alberto Balsalm has a full membership to the ‘t-object’ class, i.e., possessing all properties that the respective class—t-object—possesses. On the other hand, it can be deducted from the knowledge graph that t-Alberto Balsalm is a member of the ‘bounded t-object’ subclass of the ‘t-object’ super-class since he is bounded at least with his birthday (crisp), place of birth (fuzzy) and education (fuzzy). According to the knowledge graph, t-Alberto Balsalm is not necessarily a nuclear chemist, rather he is at least N % similar to a nuclear chemist at all times where the degree of similarity alters between N % and 100% based on a certain similarity measure, while below N % it is assumed that there exists no relationship. For example, t-Alberto Balsalm's education may transform gradually between nuclear physics (N %) and nuclear chemistry (100%), while the range in between may include all possible majors within the context including currently undefined or uninvented ones, n.b., one of the significant features of the disclosed framework.

As presented on the knowledge graph, such analogue relationships are indicated with a wavy arrow including ‘a statement of similarity threshold’ and whenever needed, also including ‘a statement of respective context’. Unlike an analogue relationship between ‘an object and a concept’ or ‘a concept and a concept’ where the context is defined by the concept itself, an analogue relationship between two objects must include the respective context that the similarities are measured since objects are comparable to each other in many different ways. In this respect, according to the knowledge graph, t-Alberto Balsalm's birthplace is at least G % similar ‘in the context of C₁ to the City of Berkeley. For example, the context C₁ may be a combination of topographic, demographic, architectural, and locational properties. And t-Alberto Balsalm's birthplace may be transforming gradually between the City of Las Vegas (G %) and the City of Berkeley (100%) in the context of C₁.

More precisely, the modified ontology model states that any manifestation of t-Alberto Balsalm's birthplace possesses at least one subset of properties such that the subset as a whole (i.e., irrespective of the individual properties belonging to the set, which may alter at each manifestation) is at least G % similar to the properties of the city of Berkeley in the context of C₁, where C₁ is a reference concept—or a set of concepts—that the similarity comparison is based on. To generalize this statement, if t-object A is said to be at least S % similar to object B in the context of C’ then ‘any manifestation of t-object A possesses at least one subset of properties such that the subset as a whole (i.e., irrespective of the individual properties belonging to the set, which may alter at each manifestation) is at least S % similar to the properties of object B in the context of C, where C is a reference concept (class) or a set of concepts (classes), that the similarity comparison is based on. In other words, any manifestation of A possesses at least one subset of properties such that the subset as a whole is at least S % similar to the properties of C, while B also has at least S % similar properties to the properties of C. Hence, ‘t-object B’ is also at least S % similar to ‘t-object A’ in the context of C, thus relationship can be represented with a double-headed arrow.

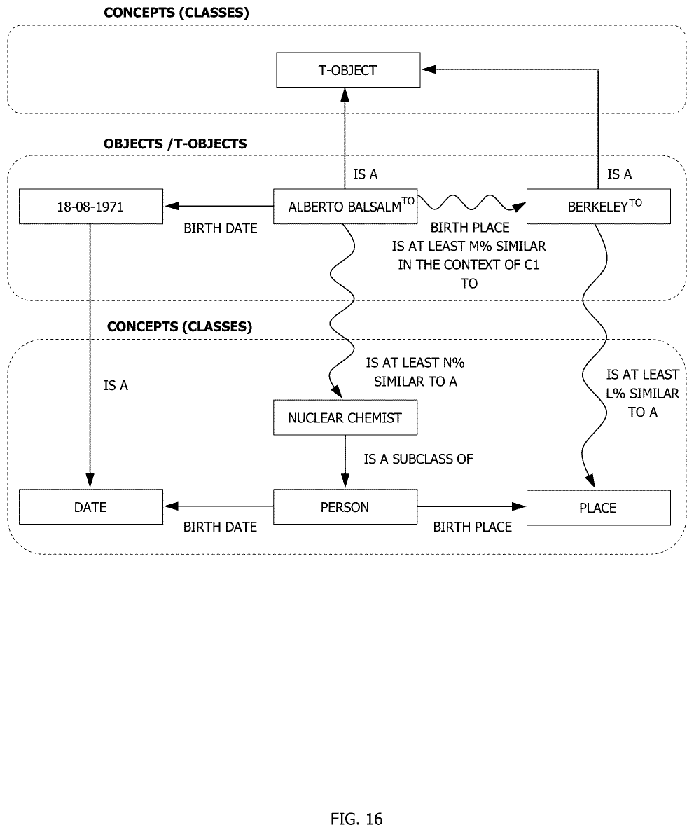

FIG. 16 is a slightly altered version of the semantic network presented at FIG. 15, where Berkeley is also replaced with a hypothetical transforming ‘Berkeley’ or t-Berkeley in short. According to the knowledge graph, t-Berkeley is at least L % similar to a place. More precisely, ‘for any manifestation, t-Berkeley always possesses at least one subset of properties such that said subset as a whole—irrespective of the individual properties belonging to the set, which may alter at each manifestation—is at least L % similar to the set of all properties of the concept of ‘place’ as a whole’. To generalize this statement, If ‘t-object A is said to be at least S % similar to concept B’ then ‘for any manifestation, t-object A possesses at least one subset of properties such that said subset as a whole (i.e., irrespective of the individual properties belonging to the set, which may alter at each manifestation) is at least S % similar to the set of all properties of concept B as a whole’.

As indicated on the knowledge graph, t-Alberto Balsalm's birthplace is at least M % similar to t-Berkeley in the context of C₁, n.b., previous threshold G % is now M % in the same context. More precisely, for any manifestation, each of the ‘t-Alberto Balsam's birthplace’ and ‘t-Berkeley’ simultaneously possess at least one subset of properties such that each of the subsets as a whole—irrespective of the individual properties belonging to the set, which may alter at each manifestation—is at least M % similar to the other in the context of C₁, where C₁ is a reference concept (class) or a set of concepts (classes), that the similarity comparison is based on. Hence, ‘t-Berkeley’ is also at least M % similar to ‘t-Alberto Balsalm's birthplace’ in the context of C₁, n.b., but not to t-Alberto Balsalm himself, thus the relationship cannot be represented with a double headed arrow. To generalize this statement, if ‘t-object A is said to be at least S % similar to t-object B in the context of C’ then ‘for any manifestation, each of the t-object A and t-object B simultaneously possess at least one subset of properties such that each of the subsets as a whole (i.e., irrespective of the individual properties belonging to the set, which may alter at each manifestation) is at least S % similar to the other in the context of C, where C is a reference concept (class) or a set of concepts (classes), that the similarity comparison is based on. Hence, ‘t-object B’ is also at least S % similar to ‘t-object A’ in the context of C, thus relationship may be represented with a double-headed arrow.

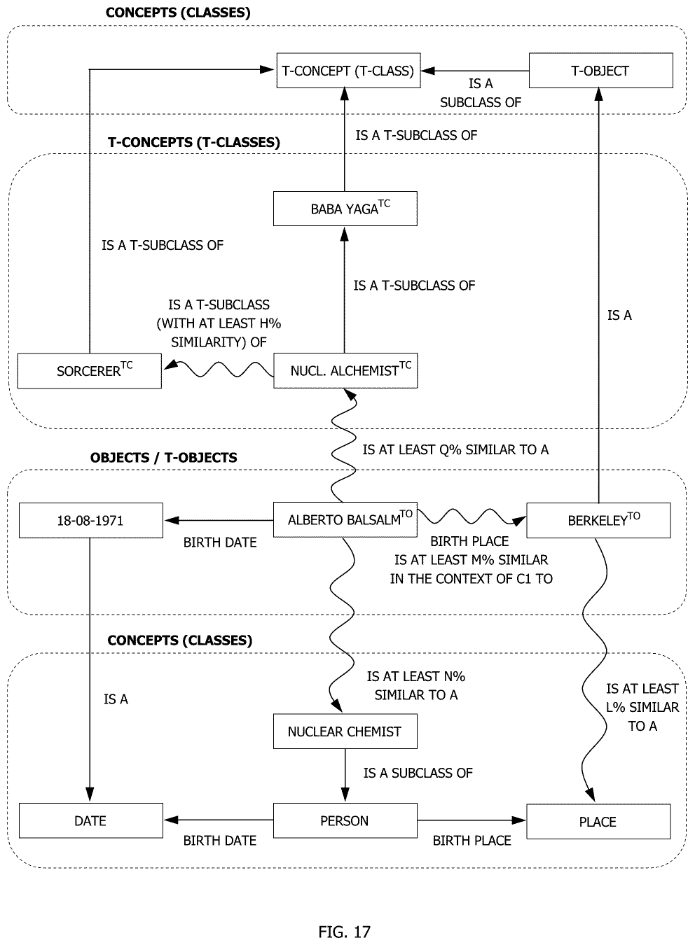

FIG. 17 is an example semantic network, i.e., knowledge graph, created by modifying the ontology model presented at FIG. 16 to further involve ‘transforming concepts’—t-concepts in short—or equally ‘transforming-classes’—t-classes in short—according to the disclosed methods and principles. The example semantic network involves multiple t-concepts and their analogue relationships with other objects, concepts, t-objects, t-concepts, including a graphical method for representing t-concepts and their analogue relationships within semantic networks—which is the same as that of the t-objects.

Concepts are distinct types of things, i.e., classes, that exist in a universe. Each individual concept has a unique set of attributes, i.e., a unique set of properties that describe that individual concept, in the universe to which it belongs. On the other hand, according to the embodiments, an object may be conceptualized according to its set of attributes that comprises ‘all properties that may arise as a result of the interactions between elementary objects that the object possesses’, n.b., but not necessarily the individual properties of the elementary objects themselves since they may alter or cancel out each other depending on the interactions between the elementary objects. Similarly, a concept may be described as a set of attributes that comprises all properties that may arise as a result of the interactions between all elementary concepts that the concept possesses’. In the context of the disclosed subject matter, the concept of ‘transforming-concept—or t-concept in short—is defined as follows:

In a universe wherein each elementary concept (i.e., concepts that are not compositions of other concepts, i.e., building block concepts, e.g. logical connectives such as ‘and’, ‘or’, ‘not’, ‘if’, ‘then’, etc.) and each elementary conceptual interaction (i.e., conceptual interactions between elementary concepts, e.g., logical operations) are postulated to be precisely perceivable, a transforming-concept—or t-concept in short—possesses the following properties; i) Existence: A t-concept involves multiple states, where each state represents a corresponding one of the possible conceptual manifestations of the t-concept, which may be any concept that is a member of the set of all possible concepts that the t-concept may involve. ii) Transformation: A t-concept is postulated to be transforming (or hopping) from one state to another unpredictably between conceptual manifestations in a non-hysteresis manner—even if it seems to behave in a predictable manner. iii) Composition: Each conceptual manifestation of a t-concept is a composition of—one or more—precise elementary concepts. iv) Perceivability: Each manifestation of a t-concept is precisely perceivable (hence t-concepts are isolated from the fuzziness or uncertainties caused by limitations with respect to perceivability). v) Relationship: A t-concept is postulated to be related to another concept if its similarity rate with respect to the reference concept is greater than or equal to a predefined similarity threshold. vi) Limits: if a t-concept is said to be bounded then it transforms within a certain context within the capacity of the universe to which it belongs. Similarly, if a t-concept is said to be unbounded then it transforms without any contextual limitations within the capacity of the universe to which it belongs. vii) Conceptual Manifestations: Each conceptual manifestation of a t-concept is a member of a subset that comprises all arrangements of ‘elementary concepts and their conceptual interactions with each other’ that does not violate the rules dictated by the context that the t-concept is bounded.

In FIG. 17, hypothetical transforming-concepts—or transforming-classes-‘Nuclear Alchemist’, ‘Sorcerer’, and ‘Baba Yaga’ are presented, which are indicated with “TC”-short for transforming-concept or transforming-class—at the upper right corner of the identifier and the concept of ‘t-concept’ is also added as a new class to the semantic network besides the transforming-subclasses, i.e., Nuclear Alchemist, Sorcerer and Baba Yaga. According to the knowledge graph, the concept of t-object is a subclass—or sub concept—of the concept of t-concept—or t-class. In other words, t-object has a full membership to the class of ‘t-concept, i.e., a full member possessing all properties that the respective class possesses. Indeed,—analogically—if a t-object is a device that generates objects within certain contextual boundaries, a t-concept is a device that generates concepts within certain contextual boundaries. According to the knowledge graph, Baba Yaga is a transforming-subclass of t-concept with a full membership, such that each conceptual manifestation of Baba Yaga, with respect to attributes, is at least 100% similar to the class of t-concept—among all properties that the conceptual manifestation possesses. Similarly, Sorcerer is a transforming-subclass of t-concept with a full membership, such that each conceptual manifestation of Sorcerer, with respect to attributes, is at least 100% similar to the class of t-concept—among all properties that the conceptual manifestation possesses. With respect to the analogies ‘Nuclear Alchemist: Baba Yaga’ and ‘Nuclear Alchemist: Sorcerer’, both nodes are transforming in each case. According to the knowledge graph, Nuclear Alchemist is a transforming-subclass of transforming-class Baba Yaga with a full membership, such that each conceptual manifestation of Nuclear Alchemist, with respect to attributes, is at least 100% similar to any conceptual manifestation of Baba Yaga—among all properties that the conceptual manifestation of Nuclear Alchemist possesses. On the other hand, Nuclear Alchemist is said to be a ‘partial-transforming—subclass’ of transforming-class Sorcerer because of its fuzzy membership such that each conceptual manifestation of Nuclear Alchemist, with respect to attributes, is at least H % similar to any conceptual manifestation of Sorcerer—among all properties that the conceptual manifestation of Nuclear Alchemist possesses—but not 100% similar to any conceptual manifestation of Sorcerer—where H $100. Further, Nuclear Alchemist, Sorcerer and Baba Yaga are—obviously—‘bounded t-concepts’ or ‘bounded t-classes’. Lastly, according to the knowledge graph, t-Alberto Balsalm is at least Q % similar to a Nuclear Alchemist in the context of being a Nuclear Alchemist. In other words, each manifestation of t-Alberto Balsalmi, with respect to the attributes of Nuclear Alchemist, such as knowledge and skills of a person with respect to nuclear alchemistry, is at least Q % similar to any conceptual manifestation of Nuclear Alchemist—in an ontological framework where only the ‘contextual boundaries’ are defined precisely for certain type of concepts, i.e., transforming-concepts.

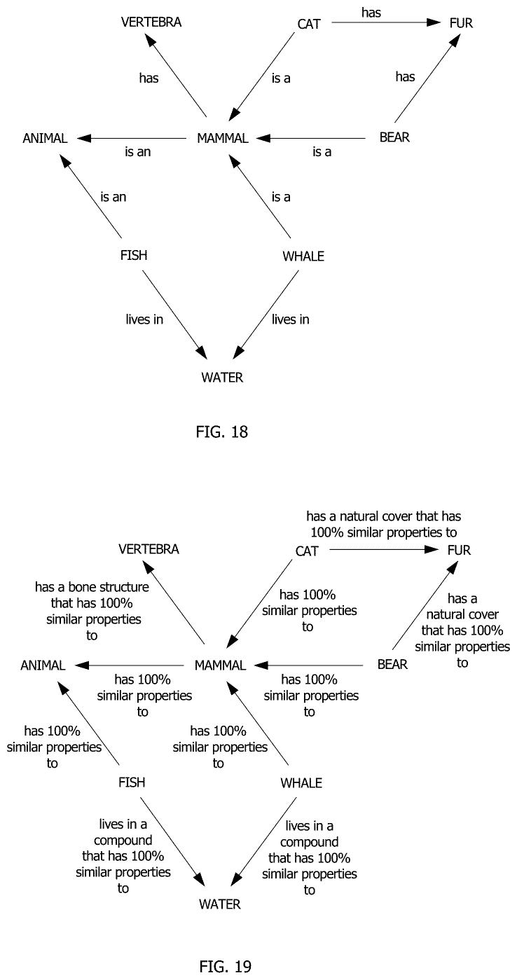

FIG. 18 is an example semantic network, i.e., knowledge graph, of an arbitrarily chosen standard ontology model involving—well known—concepts (classes) and their relationships. Said arbitrarily chosen semantic network is presented in order to demonstrate a transition to a semantic network that involves transforming-concepts besides conventional concepts. According to the semantic network in FIG. 18, ‘Cat is a Mammal’; ‘Cat has a Fur’; ‘Bear is a Mammal’; ‘Bear has Fur’; ‘Mammal is an Animal’; ‘Mammal has Vertebra’; ‘Whale is a Mammal’; ‘Whale lives in Water’; ‘Fish is an Animal’; and ‘Fish lives in Water’.

FIG. 19 is another representation of the same ontology model presented at FIG. 18. As can be seen, previous statements are replaced with new statements that have exactly the same meaning but involving similarity ratios—which are naturally %100. ‘Cat is a Mammal’ is now ‘Cat has 100% similar properties to Mammal’; ‘Cat has Fur’ is now ‘Cat has a natural cover that has 100% similar properties to Fur’; ‘Bear is Mammal’ is now ‘Bear has 100% similar properties to Mammal’; ‘Bear has Fur’ is now ‘Bear has a natural cover that has 100% similar properties to Fur’; ‘Mammal is an Animal’ is now ‘Mammal has 100% similar properties to Animal’; ‘Mammal has Vertebra’ is now ‘Mammal has a bone structure that has 100% similar properties to Vertebra’; ‘Whale is a Mammal’ is now ‘Whale has 100% similar properties to Mammal’; ‘Whale lives in Water’ is now ‘Whale lives in a compound that has 100% similar properties to Water’; ‘Fish is an Animal’ is now ‘Fish has 100% similar properties to Animal’; and ‘Fish lives in Water’ is now ‘Fish lives in a compound that has 100% similar properties to Water’.

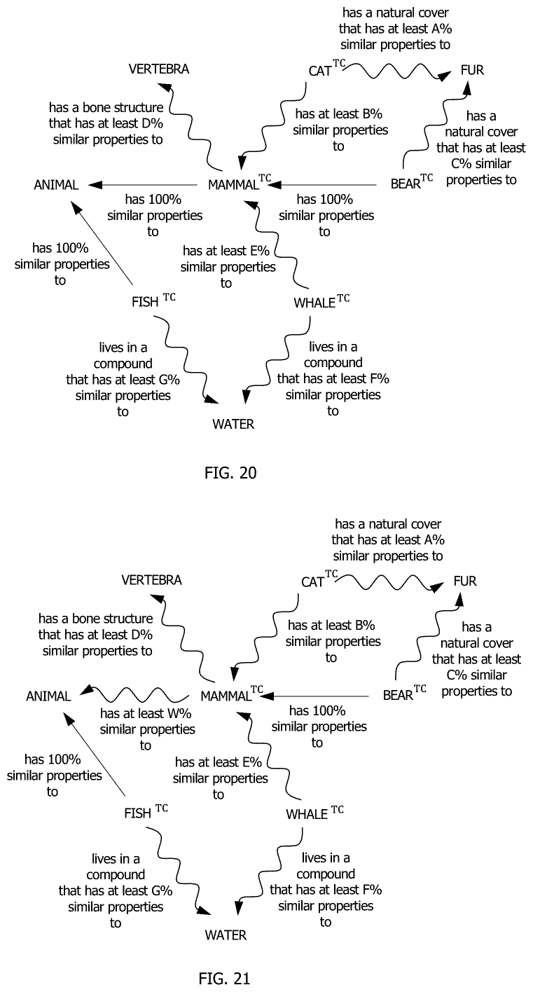

FIG. 20 is an example semantic network—created based on the ontology model presented at FIG. 18—involving t-concepts and their relationships according to the disclosed ontologies, wherein the t-concepts are the exemplary transforming correspondences of the concepts presented at FIG. 18. The semantic network in FIG. 19, which is semantically equal to the semantic network presented at FIG. 18, is altered such that the concepts Cat, Bear, Mammal, Whale, and Fish have become transforming concepts—indicated with “TC” at the upper right corner of the identifier. According to the semantic network: ‘t-Cat has B % similar properties to t-Mammal’; ‘t-Cat has a natural cover that has A % similar properties to Fur’; ‘t-Bear has 100% similar properties to t-Mammal’; ‘t-Bear has a natural cover that has C % similar properties to Fur’; ‘t-Mammal has 100% similar properties to Animal’; ‘t-Mammal has a bone structure that has D % similar properties to Vertebra’; ‘t-Whale has E % similar properties to t-Mammal’; ‘t-Whale lives in a compound that has F % similar properties to Water’; ‘t-Fish has 100% similar properties to Animal’; and ‘t-Fish lives in a compound that has G % similar properties to Water’; where ‘t-class A has at least S % similar properties to t-class B’ means that ‘Based on a predefined universal rule for similarity comparison (e.g., based on the previously disclosed similarity comparison rules/methods) each conceptual manifestation of A, with respect to attributes, is at least S % similar to any conceptual manifestation of B, among all properties that the conceptual manifestation of A possesses.

FIG. 21 is a slightly altered version of the example semantic network presented at FIG. 20. The relationship between t-Mammal and Animal is altered such that the statement ‘t-Mammal has 100% similar properties to Animal’ has become ‘t-Mammal has at least W % similar properties to Animal’. As can be seen, a class is only a special case of the corresponding family of transforming classes wherein each member of the family is defined by a similarity threshold. Further, the similarity threshold may be constant or variable such as a function of time or a set of functions applied based on certain events.

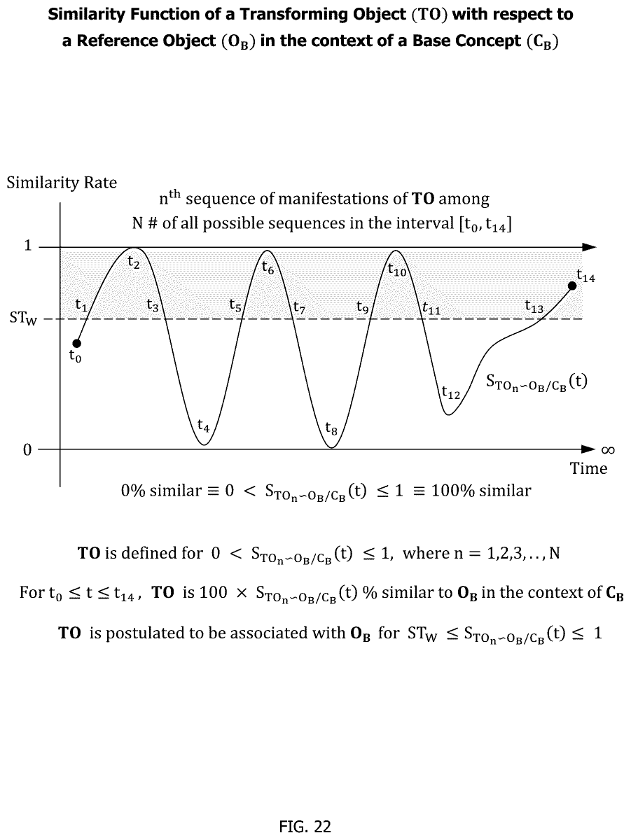

FIG. 22 is a similarity function of a bounded transforming-object (TO) with respect to a reference object—or base object—(O_{B}) in the context of a base concept—or base class—(C_{B}), where the similarity function may be an interpolation of the outcomes of comparisons of manifestations in a certain period of time. The example similarity function represents n^{th} arbitrary sequence of manifestations among N number (#) of all possible sequences of manifestations that TO may generate in the interval [t₀,t₁₄]. More concretely, given that all manifestations belong to the transforming object TO in particular, S_{To}_{ₙ}_{˜O}_{_{B}}_{/C}_{_{B}}(t) represents the similarity rate between the n^{th} sequence of manifestations of TO and a reference object O_{B} in the context of a base concept C_{B} with respect to time, where TOₙ represents an arbitrary sequence (n^{th} sequence) among all sequences of manifestations that can be generated within the contextual boundaries 0<S_{To}_{ₙ}_{˜O}_{_{B}}_{/C}_{_{B}}(t)≤1 in a certain period of time. In other words, TO is defined for 0<S_{To}_{ₙ}_{˜O}_{_{B}}_{/C}_{_{B}}(t)≤1, where n=1, 2, 3, . . . , N in the interval [tᵢₙᵢₜᵢₐₗ,t_{final}]. According to the similarity function, for t₀≤t≤t₁₄, TO is 100×S_{TO}_{ₙ}_{˜O}_{_{B}}_{/C}_{_{B}} (t) % similar to O_{B} in the context of C_{B}. The first manifestation occurs at t₀ and the last manifestation occurs at t₁₄. The similarity rate oscillates between 1 and 0, peaking at t₂ thus becoming 1 and bottoming out at t₈ becoming very close to 0—but not 0, which is not possible for a bounded transforming object according to the disclosed definition. Further, TO is postulated to be associated with O_{B} for ST_{W}S_{To}_{ₙ}_{˜O}_{_{B}}_{/C}_{_{B}}(t)≤1 where ST_{W} is the similarity threshold defining the minimum similarity limit for the establishment of the association. ST_{W} may have any reel value for 0<ST_{W}≤1 including dynamic values, thus ST_{W} itself may also be defined as a function, or a parametric equation, etc., such as an event-based function, or a rule based parametric equation. According to the FIG. 22, any manifestation that falls into the area that is bounded by ST_{W} and 1 (the grey area) is assumed to be associated with O_{B}, thus TO is postulated to be associated with O_{B} for the intervals [t₁,t₃], [t₅,t₇], [t₉,t₁₁], and [t₃,t₁₄]. Further, besides TO, any manifestation of any other transforming-object that meets said conditions is also postulated to be associated with O_{B}. Thus, the rule ST_{W} S_{TO}_{ₙ}_{˜O}_{_{B}}_{/C}_{_{B}}(t)≤1 becomes a universal rule for establishing associations between any transforming (or non-transforming) object and the reference object O_{B} in the context of C_{B}. Indeed, according to various embodiments, the rule ‘ST_{W} S_{TO}_{ₙ}_{˜O}_{_{B}}_{/C}_{_{B}}(t)≤1’ corresponds to the rule that is embedded with each super-object with respect to the establishment of associations with various objects where TOₙ corresponds to any encountered object, ST_{W} corresponds to the similarity threshold, O_{B} corresponds to the root-object, and C_{B} corresponds to the base concept (such as a certain function in certain type of object) that determines the context of the similarity comparison to be executed between an encountered object and the root object.

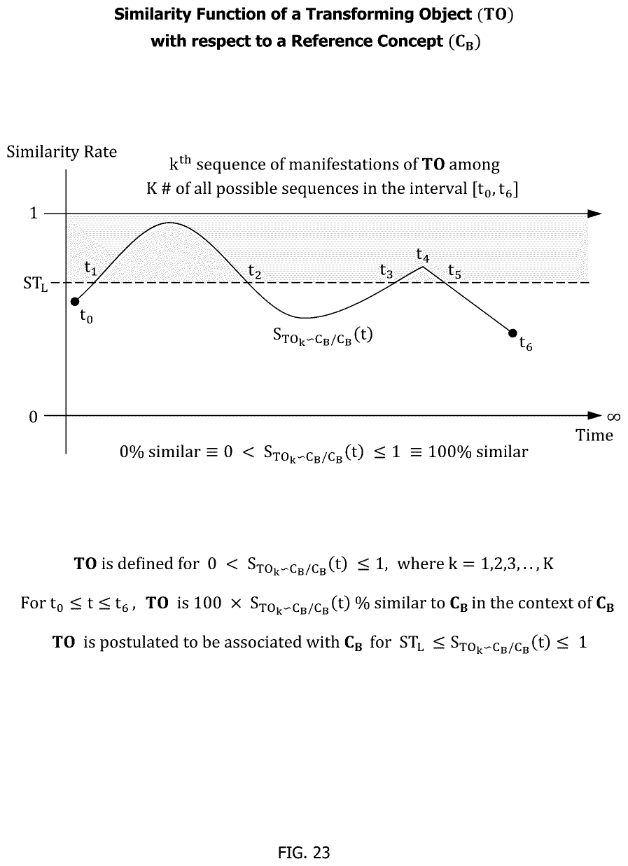

FIG. 23 is a similarity function of a bounded transforming-object (TO) with respect to a reference concept—or base concept—(C_{B}) in the context of the same reference concept—or base concept—(C_{B}), where the similarity function may be an interpolation of the outcomes of comparisons of manifestations in a certain period of time. The example similarity function represents k^{th} arbitrary sequence of manifestations among K number (#) of all possible sequences of manifestations that TO may generate in the interval [t₀,t₆]. More concretely, given that all manifestations belong to the transforming object TO in particular, S_{TO}_{ₖ}_{˜C}_{_{B}}_{/C}_{_{B}}(t) represents the similarity rate between the k^{th} sequence of manifestations of TO and a reference concept C_{B} in the context of C_{B} with respect to time, where TOₖ represents an arbitrary sequence (k^{th} sequence) among all sequences of manifestations that can be generated within the contextual boundaries 0<S_{TO}_{ₖ}_{˜C}_{_{B}}_{/C}_{_{B}}(t)≤1 in a certain period of time. In other words, TO is defined for 0<S_{TO}_{ₖ}_{˜C}_{_{B}}_{/C}_{_{B}}(t)≤1, where k=1, 2, 3, . . . , K in the interval [tᵢₙᵢₜᵢₐₗ,t_{final}]. According to the similarity function, for t₀≤t≤t₆, TO is 100×S_{TO}_{_{k˜C}}_{_{B}}_{/C}_{_{B}} (t) % similar to C_{B} in the context of C_{B}. The first manifestation occurs at t₀ and the last manifestation occurs at t₆. The similarity rate oscillates smoothly between t₀ to t₃ and turns sharply into a linear decline at t₄. Further, TO is postulated to be associated with C_{B} for ST_{L}≤S_{TO}_{ₖ}_{˜C}_{_{B}}_{/C}_{_{B}}(t)≤1 where ST_{L} is the similarity threshold defining the minimum similarity limit for the establishment of the association. ST_{L} may have any reel value for 0<ST_{L}≤1 including dynamic values, thus ST_{L} itself may also be defined as a function, or a parametric equation, etc., such as an event-based function, or a rule based parametric equation. According to the FIG. 23, any manifestation that falls into the area that is bounded by ST_{L} and 1 (the grey area) is assumed to be associated with C_{B}, thus TO is postulated to be associated with C_{B} for the intervals [t₁,t₂] and [t₃,t₅]. Further, besides TO, any manifestation of any other transforming-object that meets said conditions is also postulated to be associated with C_{B}. Thus, the rule ST_{L}<S_{TO}_{ₖ}_{˜C}_{_{B}}_{/C}_{_{B}}(t)≤1 becomes a universal rule for establishing associations between any transforming (or non-transforming) object and the reference concept C_{B} in the context of C_{B}. Consequently, the rule ‘ST_{L}<S_{TO}_{ₖ}_{˜C}_{_{B}}_{/C}_{_{B}}(t)≤1’ may be used as a general rule—such as embedded with a super-object—for establishing an association between an object and a concept where TOₖ corresponds to any encountered object, ST_{L} corresponds to the similarity threshold, C_{B} corresponds to any root-concept and also the context of the similarity comparison to be executed between an encountered object and the root-concept. Further, the rule ST_{L}≤S_{TO}_{ₖ}_{˜C}_{_{B}}_{/C}_{_{B}}(t)≤1 may be expanded to become

$$S {T}_{L} \leq {S}_{{TO}_{k} \sim {C}_{{B}_{1}} / {C}_{{B}_{2}}} ( t ) \leq 1$$

where TOₖ corresponds to any encountered object, ST_{L} corresponds to the similarity threshold, C_{B}_{₁} corresponds to any root-concept and C_{B}_{₂} corresponds to any concept that determines the context of the similarity comparison to be executed between an encountered object and the root-concept.

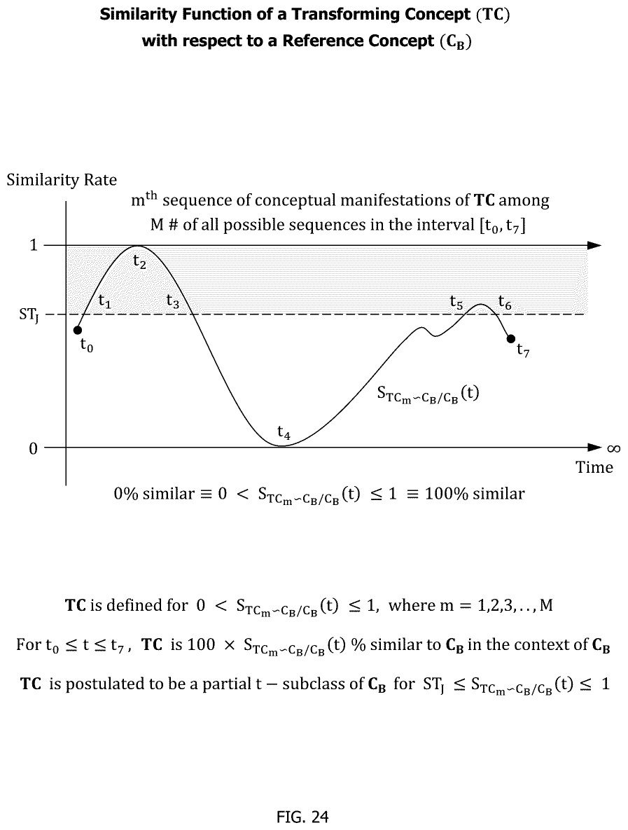

FIG. 24 is a similarity function of a bounded transforming-concept (TC) with respect to a reference concept—or base concept—(C_{B}) in the context of the same reference concept—or base concept—(C_{B}), where the similarity function may be an interpolation of the outcomes of comparisons of conceptual manifestations in a certain period of time. The example similarity function represents m^{th} arbitrary sequence of conceptual manifestations among M number (#) of all possible sequences of conceptual manifestations that TO may generate in the interval [t₀,t₇]. More concretely, given that all conceptual manifestations belong to the transforming concept TC in particular, S_{TC}_{ₘ}_{˜C}_{_{B}}_{/C}_{_{B}}(t) represents the similarity rate between the m^{th} sequence of conceptual manifestations of TC and a reference concept C_{B} in the context of C_{B} with respect to time, where TCₘ represents an arbitrary sequence (m^{th} sequence) among all sequences of conceptual manifestations that can be generated within the contextual boundaries 0<S_{TC}_{ₘ}_{˜C}_{_{B}}_{/C}_{_{B}}(t)≤1 in a certain period of time. In other words, TC is defined for 0<S_{TC}_{ₘ}_{˜C}_{_{B}}_{/C}_{_{B}}(t)≤1, where m=1, 2, 3, . . . , M in the interval [tᵢₙᵢₜᵢₐₗ,t_{final}]. According to the similarity function, for t₀≤t≤t₇, TC is 100×S_{TC}_{ₘ}_{˜C}_{_{B}}_{/C}_{_{B}}(t) % similar to C_{B} in the context of C_{B}. The first conceptual manifestation occurs at t₀ and the last conceptual manifestation occurs at t₇. The similarity rate oscillates between 1 and 0, peaking at t₂ thus becoming 1 and bottoming out at t₄ becoming very close to 0—but not 0, which is not possible for a bounded transforming concept according to the disclosed definition. Further, TC is postulated to be a partial-transforming-subclass of C_{B} for ST_{J}≤S_{TC}_{ₘ}_{˜C}_{_{B}}_{/C}_{_{B}}(t)≤1 where ST_{J} is the similarity threshold defining the minimum similarity limit for the partial-transforming-subclass. ST_{J} may have any reel value for 0<STⱼ≤1 including dynamic values, thus ST_{J} itself may also be defined as a function, or a parametric equation, etc., such as an event-based function, or a rule based parametric equation. According to the FIG. 24, any conceptual manifestation that falls into the area that is bounded by ST_{J} and 1 (the grey area) is assumed to be a partial-transforming-subclass of C_{B}, thus TC is postulated to be a partial-transforming-subclass of C_{B} for the intervals [t₁,t₃] and [t₅,t₆]. Further, besides TC, any manifestation of any other transforming-object that meets said conditions is also postulated to be a partial-transforming-subclass of C_{B}. Thus, the rule ST_{J}≤S_{TC}_{ₘ}_{˜C}_{_{B}}_{/C}_{_{B}} (t)≤1 becomes a universal rule for generating partial-transforming-subclasses of the reference concept C_{B} in the context of C_{B}. Consequently, the rule ‘ST_{J}≤S_{TC}_{ₘ}_{˜C}_{_{B}}_{/C}_{_{B}}(t)≤1’ may be used as a general rule—such as embedded with a super-concept, i.e., a conceptual super-object—for generating a partial-transforming-subclass of a concept where TCₘ corresponds to any encountered or envisioned concept, ST_{J} corresponds to the similarity threshold, C_{B} corresponds to any root-concept and also the context of the similarity comparison to be executed between an encountered or envisioned concept and the root-concept. Further, the rule ST_{J}≤S_{TC}_{ₘ}_{˜C}_{_{B}}_{/C}_{_{B}}(t)≤1 may be expanded to become

$$S {T}_{J} \leq {S}_{{TC}_{m} \sim {C}_{{B}_{1}} / {C}_{{B}_{2}}} ( t ) \leq 1$$

where TCₘ corresponds to any encountered or envisioned concept, ST_{J} corresponds to the similarity threshold, C_{B}_{₁} corresponds to any root-concept and C_{B}_{₂} corresponds to any concept that determines the context of the similarity comparison to be executed between an encountered or envisioned concept and the root-concept.

Last but not least, the disclosed example—at FIG. 22—of an arbitrary similarity function of a transforming-object (TO) with respect to a reference object (O_{B}) in the context of a base concept (C_{B}) may be expanded in such a way that the reference object (O_{B}) may be a reference transforming object (TO_{B}) and/or the base concept (C_{B}) may be a base transforming concept (TC_{B}). Further, the disclosed example—at FIG. 23—of an arbitrary similarity function of a transforming-object (TO) with respect to a reference concept (C_{B}) may be expanded in such a way that the reference concept (C_{B}) may be a reference transforming concept (TC_{B}). Further, the disclosed example—at FIG. 24—of an arbitrary similarity function of a transforming-concept (TC) with respect to a reference concept (C_{B}) may be expanded in such a way that the reference concept (C_{B}) may be a reference transforming concept (TC_{B}).

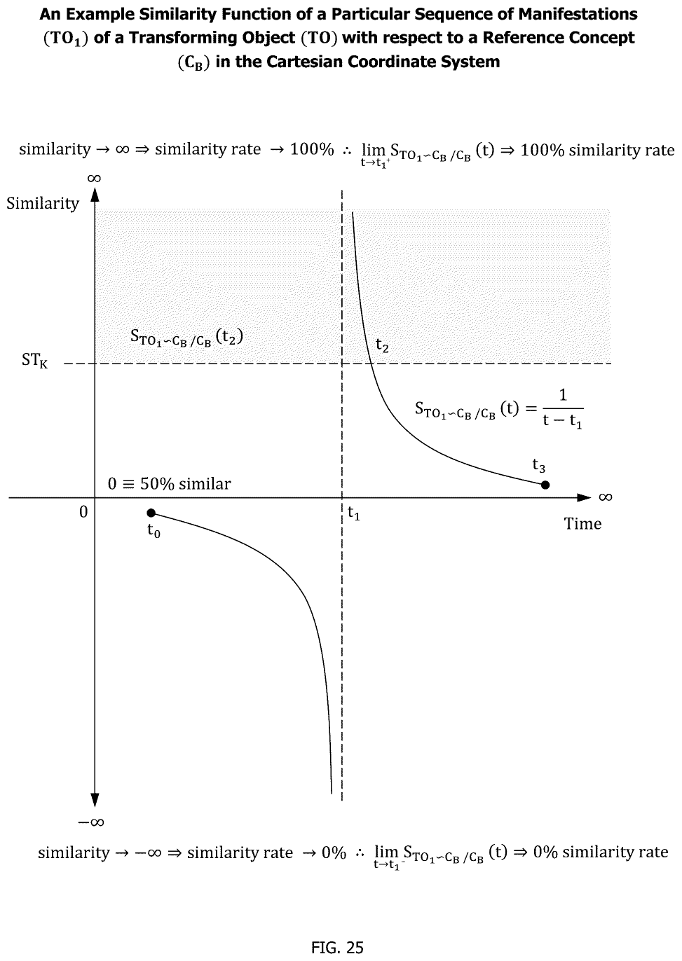

FIG. 25 is an example similarity function of a particular sequence of manifestations (TO₁) of a transforming object (TO) with respect to a reference concept (C_{B}) in the cartesian coordinate system. The similarity function S_{O}_{₁}_{˜C}_{_{B}}_{/C}_{_{B}} (t)=1/(t−t₁) represents the interpolation of the outcomes of the comparisons of manifestations in the interval [t₀,t₃]. In the cartesian coordinate system as similarity→∞ then similarity rate→100%, therefore—according to the example function—the right limit of the similarity rate S_{O}_{₁}_{˜C}_{_{B}}_{/C}_{_{B}} (t) at t₁ is 100% similar. Similarly, as similarity→−∞ then similarity rate→0%, therefore—according to the example function—the left limit of the similarity rate S_{TO}_{₁}_{˜C}_{_{B}}_{/C}_{_{B}} (t) at t₁ is 0%. According to the FIG. 25, S_{TO}_{₁}_{˜C}_{_{B}}_{/C}_{_{B}} (t) is defined for −∞<S_{TO}_{₁}_{˜C}_{_{B}}_{/C}_{_{B}} (t)≤S_{TO}_{₁}_{˜C}_{_{B}}_{/C}_{_{B}} (t₀), S_{TO}_{₁}_{˜C}_{_{B}}_{/C}_{_{B}} (t₃)≤S_{TO}_{₁}_{˜C}_{_{B}}_{/C}_{_{B}} (t)<∞, and t₀≤t<t₁<t≤t₃. For t₀≤t<t₁<t≤t₃, TO₁ is 100×S_{TO}_{₁}_{˜C}_{_{B}}_{/C}_{_{B}} (t) % similar to C_{B} in the context of C_{B}. Further, TO is postulated to be associated with C_{B} for ST_{K}≤S_{TO}_{ₙ}_{˜C}_{_{B}}_{/C}_{_{B}} (t)≤1 where ST_{K} is the similarity threshold defining the minimum similarity limit for the establishment of the association, while the integer variable n may have any value from 1 to N where N represents the total number of all possible sequences of manifestations that TO may generate in the interval [t₀,t₃]. According to the FIG. 25, any manifestation that falls into the area that is bounded by ST_{K} and ∞ (the grey area) is assumed to be associated with C_{B}, thus sequence #1 of manifestations of TO in the interval [t₀,t₃], i.e., TO₁, is postulated to be associated with C_{B} in the interval (t₁,t₂].

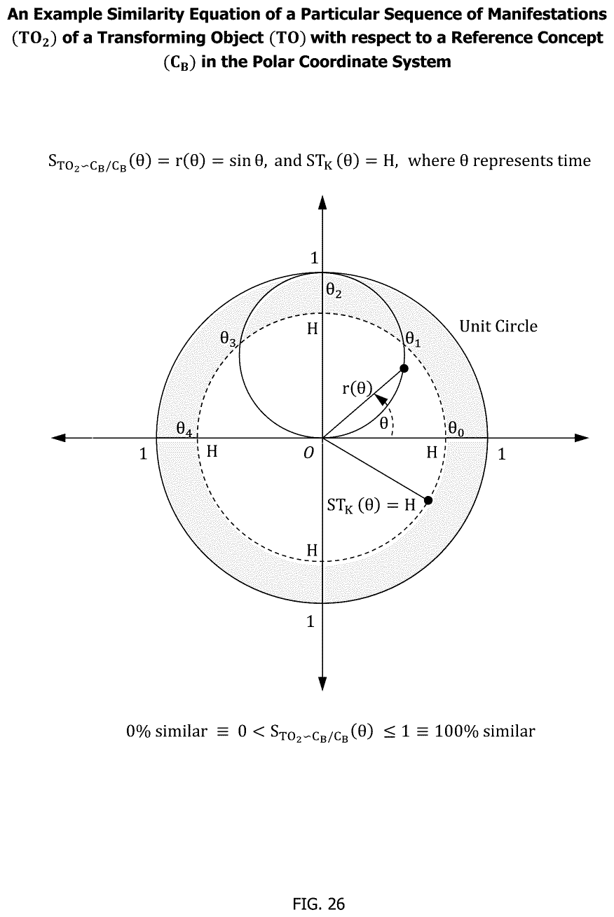

FIG. 26 is an example similarity equation of a particular sequence of manifestations (TO₂) of a transforming object (TO) with respect to a reference concept (C_{B}) in the polar coordinate system. The similarity equation S_{TO}_{₂}_{˜C}_{_{B}}_{/C}_{_{B}}(O) r(θ)=sin θ, represents the interpolation of the outcomes of the comparisons of manifestations in the interval [θ₀, θ₄] where the angle θ represents time. According to the FIG. 26, S_{TO}_{₂}_{˜C}_{_{B}}_{/C}_{_{B}}(θ) is defined for 0<S_{TO}_{₂}_{˜C}_{_{B}}_{/C}_{_{B}}(θ)≤1 and 0≤θ≤π. For θ₀≤θ≤θ₄, TO₂ is 100×S_{TO}_{₂}_{˜C}_{_{B}}_{/C}_{_{B}} (θ) % similar to C_{B} in the context of C_{B}. Further, TO is postulated to be associated with C_{B} for ST_{K} (θ)≤S_{TO}_{ₙ}_{˜C}_{_{B}}_{/C}_{_{B}}(θ)≤1 where ST_{K} (θ) is the similarity threshold defining the minimum similarity limit for the establishment of the association, while the integer variable n may have any value from 1 to N where N represents the total number of all possible sequences of manifestations that TO may generate in the interval [θ₀,θ₄]. According to the FIG. 26, any manifestation that falls into the area that is bounded by ST_{K} (θ)=H and 1 (the grey area) is assumed to be associated with C_{B}, thus sequence #2 of manifestations of TO in the interval [θ₀, θ₄], i.e., TO₂, is postulated to be associated with C_{B} in the interval [θ₁,θ₃].

All in all, by utilizing the concept of t-objects and t-concepts, any object or concept that may exist within certain contextual boundaries, including those that does not yet exist, i.e., uninvented things, may be—albeit indirectly—processed in a fuzzy manner to a certain extend. Thus, for example, super-objects comprising event based strategic applications may also be developed proactively for future encounters, etc.

Example Methods for Identifying the Context (C_{B}), Root-Object (O_{B}), and Similarity Threshold (ST) of a Super-Object:

According to the embodiments, as previously disclosed, the rule ‘ST_{W}≤S_{TO}_{ₙ}_{˜O}_{_{B}}_{/C}_{_{B}}(t)≤1’ may correspond to the general rule applied for super-objects with respect to the establishment of associations with various objects where TOₙ corresponds to any encountered object, ST_{W} corresponds to the similarity threshold, O_{B} corresponds to the root-object, and C_{B} corresponds to the base concept that determines the context of the similarity comparison to be executed between an encountered object and the root object. In order to generate a syntax for super-objects in this context, let TOₙ to be the n^{th} individual object encountered by a super-object that is being considered (instead of the n^{th} sequence of manifestations of a transforming-object), ‘W’ to be the identifier of said super-object, ST_{W} to be the similarity threshold of said super-object, O_{B} to be the root-object of said super-object, C_{B} to be the context of said super-object (n.b., according to the disclosed framework, all objects are considered transforming objects—even if they are not). In this context, TOₙ˜O_{B}/C_{B} may represent the comparison process of a super-object with an encountered object, which reads as ‘comparison of TOₙ with O_{B} in the context of C_{B}’ and ST_{W}≤S_{TO}_{ₙ}_{˜O}_{_{B}}_{/C}_{_{B}}≤1 may represent the condition for establishing an association between said super-object and the encountered object with respect to the similarity rate S_{TO}_{ₙ}_{˜O}_{_{B}}_{/C}_{_{B}} that is measured in that process, which reads as ‘encountered object TOₙ is assumed to be associated with super-object W if and only if the similarity rate between TOₙ and O_{B} in the context of C_{B} is more than or equal to the similarity threshold ST_{W}’.

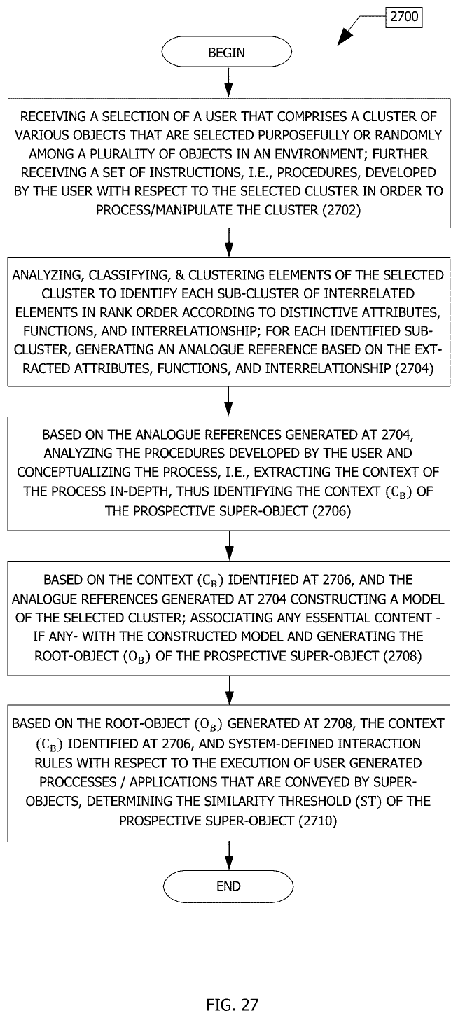

FIG. 27 is the flowchart diagram 2700 illustrating an example process that includes steps with respect to identifying the context (C_{B}), root-object (O_{B}), and similarity threshold (ST) of a super-object.

The process begins with an interaction of a system user—for example through a client of the system—with one or more object/s in an environment where the objects may be a wide variety of singular elements and/or clusters of interrelated elements. Further, the objects in the environment may be virtual or physical or both, such as objects of the Internet of Things (IoT).

At 2702, the system receives a selection of the user that comprises a cluster of various objects that are selected purposefully or randomly among a plurality of objects in the environment. According to the embodiments, a selected cluster may be contextually and structurally complex and may involve collections of distant and even irrelevant objects. For example, in the case of the Internet, the cluster may comprise both ‘singular elementary objects with very basic functions’ and ‘subclusters of interrelated elementary objects with very complex functions’ and those elements/subclusters may be from irrelevant and contextually distant websites. Next, the system receives a set of instructions, i.e., procedures, developed by the user with respect to the selected cluster in order to process/manipulate the cluster. According to the embodiments, the procedures may be developed by the user with the assistance of the system or completely independent of the system, while they may be basic or complex depending on the manipulated cluster and the procedures related with them.

As a result of the process 2702, the system receives a set of instructions developed by a user with respect to a cluster of objects that are selected by the user.

At 2704, the system analyzes, classifies, and clusters the elements of the selected cluster to identify each subcluster of interrelated elements in rank order—including each element as a 0^{th} order cluster—according to distinctive attributes, functions, and interrelationship. Next, for each identified subcluster, the system generates an analogue reference based on the identified attributes, functions, and interrelationship. In one embodiment, the step 2704 is executed right after the sub-step of receiving the selection of the user at 2702, since the step 2704 does not involve processing the procedures developed by the user with respect to the selected cluster.

As a result of the process 2704, the system semantically identifies each subcluster in rank order and assigns an analogue reference in this context.

At 2706, based on the analogue references generated at 2704, and the set of instructions received at 2702, the system analyzes the procedures developed by the user with respect to the selected cluster and conceptualizes the user generated process, i.e., extracts the context of the process in-depth, thus identifies the context (C_{B}) of the prospective super-object. According to various embodiments, the context (C_{B}) comprises the extracted function and/or distinctive attributes of each subcluster involved in the process including the interrelationship in terms of functions and/or distinctive attributes within the context of the user generated process (n.b., but not within the context of the cluster itself, since it may be no longer valid in the context of the user generated process), while comprising the function and/or distinctive attributes of each object involved in the set of instructions that manipulate the cluster, such as functions and methods of a computer program and non-executable content with respect to those procedures. In other words, the interaction between the ‘objects of the cluster’ and the ‘objects of the set of instructions’ constitutes the base of the context of the ‘user generated process’, i.e., ‘user generated application’. Further, depending on the complexity of the selected cluster and/or the complexity of the set of instructions with respect to the cluster, the user generated process may be represented by multiple subclusters and/or subsets of instructions to be processed in coordination. For example, the user generated process may be divided into sub-processes where each subset of instructions may be embedded with a super-object that is associated with the corresponding subcluster. In this process, each super-object to which the process is distributed operates in coordination with the others, for example, event-based rules—which may be embedded within the rule-base of each super-object—may define the order of execution of the instructions—whenever needed, according to the embodiments.

As a result of the process 2706, the system conceptualizes a user generated process (i.e., user generated application) with respect to an object cluster (thus the process becomes a concept, i.e., class) and identifies the context (C_{B}) of the respective prospective super-object.

At 2708, based on the context (C_{B}) identified at 2706, and the analogue references generated at 2704 the system constructs a model of the selected cluster. Next, the system associates any essential content—if any—with the constructed model and generates the root-object (O_{B}) of the prospective super-object. According to an embodiment, first, the system eliminates subclusters that are not involved in the process thus the selected cluster becomes free of any redundant subclusters. Next, the system conceptualizes the remaining cluster in accordance with the context (C_{B}) and extracts a model from said cluster while identifying any content of the remaining cluster that is essential to be included in/conveyed with the root-object. An essential content may be, for example, an image, a text, a link, etc. that should be partially or completely contained in the root-object. Next the system includes the essential content into the model and re-generates analogue references accordingly, thus, the system generates the root-object (O_{B}) of the prospective super-object, according to the embodiment.

As a result of the process 2708, the system constructs a model of the selected cluster including any essential content and generates the root-object (O_{B}) of the respective prospective super-object.

At 2710, based on the root-object (O_{B}) generated at 2708, the context (C_{B}) identified at 2706, and system-defined interaction rules with respect to the execution of user generated processes/applications that are conveyed by super-objects, the system determines the similarity threshold (ST) of the prospective super-object. The similarity threshold (ST) within the ontological model ‘ST≤S_{TO}_{ₙ}_{˜O}_{_{B}}_{/C}_{_{B}}≤1’ may be considered as the informatical representation of the intuition or at least a major component of it—thus, may be considered as one of the most prominent features of the disclosed subject matter. In principle, similarity threshold within the context of said ontological model (ST≤S_{TO}_{ₙ}_{˜O}_{_{B}}_{/C}_{_{B}}≤1) represents a value in the region between two critical boundaries: the lower boundary and the upper boundary. Within the context of a process with respect to a root-object, the lower boundary is the similitude rate of the least similar object (to the root-object) that is adequate for the realization of the process among all adequate objects. In other words, lower boundary value ensures that there exists at least one adequate object among all objects possessing the similitude rate of the lower boundary. Below this boundary there exists no adequate object, n.b., nevertheless any value below this boundary—including zero, i.e., disparateness—may still be assigned as the similarity threshold depending on the needs of the implication. Within the context of a process with respect to a root-object, the upper boundary is the similitude rate of the most similar object (to the root-object) that is inadequate for the realization of the process among all inadequate objects. In other words, upper boundary value ensures that there exists at least one inadequate object among all objects possessing the similitude rate of the upper boundary. Above this boundary there exists no inadequate object, i.e., all objects are adequate for the realization of the process, n.b., nevertheless any value above this boundary—including 1, i.e., identicalness—may still be assigned as the similarity threshold depending on the needs of the implication. For example, lower boundary value may be assigned as the similarity threshold (ST) representing the borderline rate of similitude to a root-object (O_{B}) with respect to the execution of an operation—represented with context (C_{B})—that is initially designed for manipulating the root-object (O_{B}), such as a user generated application or any operation with respect to the root-object (O_{B}). In various embodiments, according to the model ST≤S_{TO}_{ₙ}_{˜O}_{_{B}}_{/C}_{_{B}}≤1, as similarity threshold ST converges to the lower boundary, the coverage of the set of ‘adequate objects’ increases while the possibility of success—in arbitrary encounters—decreases. Similarly, as similarity threshold ST converges to the upper boundary, the possibility of success—in arbitrary encounters—increases, while the coverage of the set of ‘adequate objects’ decreases. Hence, optimal efficiency may fall somewhere in between the lower and upper boundaries according to the operational needs based on the interaction rules of the system, according to the embodiments. Thus, fulfilling the association rule ST≤S_{TO}_{ₙ}_{˜O}_{_{B}}_{/C}_{_{B}}≤1, i.e., the establishment of an association, does not necessarily ensure the realization of the respective task unless S_{TO}_{ₙ}_{˜O}_{_{B}}_{/C}_{_{B}} is identified to be above the upper boundary. Or in general, for any encountered object TOₙ, where S_{TO}_{ₙ}_{˜O}_{_{B}}_{/C}_{_{B}} is identified to be more than or equal to the respective similarity threshold but less than 1, the task: i) may be fully processed; ii) may be partially processed; or iii) may not be processed at all. Note: In the context of the disclosed subject matter, for the second (ii) and third (iii) cases, further creative processing is proposed, as a part of the process 2800.

### Determinability of Critical Boundaries and Optimum Value of Similarity Threshold:

In a universe where any interaction is precisely observable and perceivable, if the set of all possible outcomes of all permutations and/or all combinations of interactions between elements and/or clusters of interrelated elements is finite then within the context of the disclosed ontology model ST≤S_{TO}_{ₙ}_{˜O}_{_{B}}_{/C}_{_{B}}≤1, the lower and upper boundaries and the optimum value of a prospective similarity threshold is said to be precisely determinable. In one embodiment, in order to identify the lower and upper boundaries, and the optimum value of a prospective similarity threshold with respect to a certain process, e.g., a user generated application, via utilizing the disclosed methods and systems, the system: i) inter-manipulates all elements and/or all clusters of interrelated elements existing in the respective universe; ii) identifies each possible object in the universe based on all possible outcomes of permutations and/or combinations of interactions between the existing elements and/or clusters of interrelated elements, and iii) identifies the similarity rate and adequacy of each object with respect to the realization of the process. Thus, the system may precisely identify the lower and upper boundaries, and the optimum value of a prospective similarity threshold, based on the extracted data and information, according to the embodiment. According to another embodiment, the system executes the above process only for a portion of elements and/or clusters of interrelated elements existing in the universe in order to train machine learning models. Further the system may specially include some distinctive samples to the dataset in order to optimize the training. Thus, by compromising the precise determination of critical values and allowing a degree of uncertainty, the system may still operate reliably—which is indeed essential for the type of environments disclosed below.

In a universe where any interaction is precisely observable and perceivable, if the set of all possible outcomes of all permutations and/or all combinations of interactions between elements and/or clusters of interrelated elements is infinite then within the context of the disclosed ontology model ST≤S_{TO}_{ₙ}_{˜O}_{_{B}}_{/C}_{_{B}}≤1, the lower and upper boundaries and the optimum value of a prospective similarity threshold is said to be determinable within a degree of uncertainty. In one embodiment, in order to identify the lower and upper boundaries, and the optimum value of a prospective similarity threshold with respect to a certain process, e.g., a user generated application, via utilizing the disclosed methods and systems and also state-of-the-art machine learning techniques the system: i) selects a subset from the set of all elements and/or all clusters of interrelated elements existing in the respective universe in order to train machine learning models; ii) inter-manipulates the elements and/or clusters of interrelated elements belonging to the selected subset; iii) identifies each possible object in the subset based on all possible outcomes of permutations and/or combinations of interactions between the existing elements and/or clusters of interrelated elements of the subset, iv) identifies the similarity rate and adequacy of each object with respect to the realization of the process; and v) trains machine learning models based on the extracted data and information. Thus, the system may identify the lower and upper boundaries, and the optimum value of a prospective similarity threshold by artificial intelligence—based on training appropriate machine learning models. In this context, as the number of completed tasks increases the training dataset gets larger and more complex, thus, the degree of uncertainty with respect to the determination of the lower and upper boundaries and the optimum value of a prospective similarity threshold decreases, according to the embodiment.

As a result of the process 2710, the system determines the similarity threshold (ST) of the prospective super-object.

Following the execution of the step 2710 the system embeds the context (C_{B}), the root-object (O_{B}), and the similarity threshold (ST) with the prospective super-object—along with other essential information—and stores the prospective super-object in a storage medium—such as by recording it in a database. Thus, the prospective super-object becomes a super-object. As a result of the process 2700 the system identifies and sets the rule ‘ST≤S_{TO}_{ₙ}_{˜O}_{_{B}}_{/C}_{_{B}}≤1’ for the establishment of an association between a super-object and an encountered object (TOₙ).

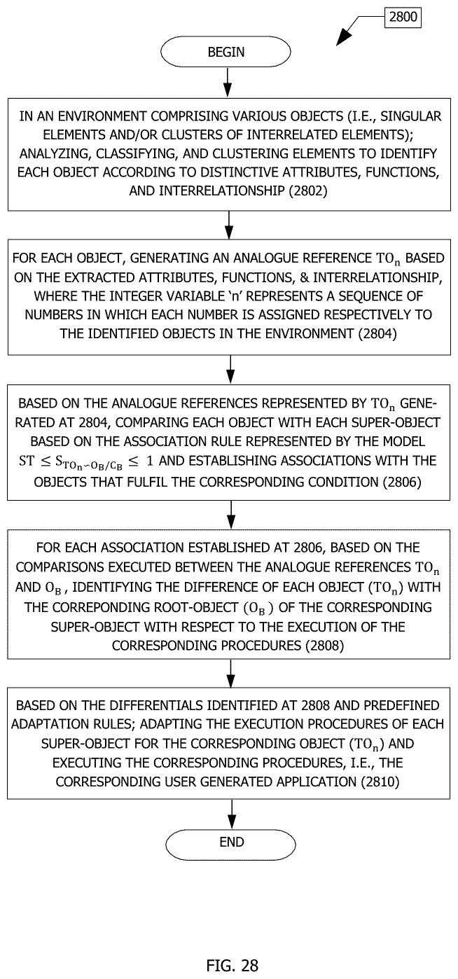

FIG. 28 is the flowchart diagram 2800 illustrating an example process that includes steps with respect to identifying associations between objects and super-objects and executing the corresponding set of instructions accordingly in an environment comprising both virtual and physical objects including resources of various data networks.

At 2802, the system analyzes, classifies, and clusters elements to semantically identify each object (i.e., each singular element and each cluster of interrelated elements) according to distinctive attributes, functions, and interrelationship. Next, for each object—including each singular element—the system generates an analogue reference TOₙ based on the extracted attributes, functions, and interrelationship, where the integer variable ‘n’ represents a sequence of numbers in which each number is assigned respectively to the identified objects in the environment (2804).

At 2806, based on the analogue references—represented by TOₙ—generated at 2804, the system compares each object with each super-object based on the association rule represented by the model ST≤S_{TO}_{ₙ}_{˜O}_{_{B}}_{/C}_{_{B}}≤1 and establishes associations with the objects that fulfil the corresponding condition. In one embodiment the system utilizes machine learning for preliminary analysis of objects in order to optimize the process, such as by eliminating the irrelevant objects beforehand in order to gain speed in the process 2806.

At 2808, for each association established at 2806, based on the comparisons executed between the analogue references TOₙ and O_{B}, identifying the difference of each object—represented by TOₙ within the model—with the corresponding root-object—represented by O_{B} within the model—of the corresponding super-object with respect to the execution of the corresponding procedures.

At 2810, based on the differentials identified at 2808 and predefined adaptation rules, the system adapts the execution procedures of each super-object for the corresponding object (TOₙ) and executes the corresponding procedures, i.e., the corresponding user generated application that is embedded with the super-object.

Strategies related to Conditions that are Partially Satisfied due to Missing Components of Associated Objects and/or Loss of Components of Associated Objects during a Process:

In principle, the system may fully or partially realize a given task—such as the execution of a user generated application—depending on the interaction rules with respect to the given task and the capability of the associated objects with respect to the execution of the procedures. Focusing on the latter, once an object or a cluster of objects is associated with a super-object, conditions for the execution of a task may be partially satisfied due to missing components of the associated objects and/or loss of components of the associated objects during the process. In order to deal with such situations, if possible, the system may attempt to dynamically create the missing components, i.e., objects, and/or search accessible alternative sources in the environment in order to identify and associate the missing components, i.e., objects.

According to an embodiment, upon determination of the adaptation procedures—at 2810—with respect to the execution of a user generated application embedded with a super-object that is associated with an object or a cluster of objects, via utilizing disclosed methods and systems as well as state-of-the-art techniques: At 2810/1, the system identifies one or more missing components if any, such as a missing function or a certain content that is essential to fully perform the task; At 2810/2, the system dynamically generates components (objects) in order to compensate the missing components—if possible—and/or dynamically scans accessible environments for alternative objects that may compensate the missing components and/or dynamically creates composite objects from multiple objects collected from various environments and further modifies them according to the executional needs—if needed; At 2810/3, if succeeded, the system executes the task, else re-executes steps 2810/1, and 2810/2 in order to identify new ways or resources for the compensation of the missing components and the execution of the task; At 2810/4, during the process of execution of the user generated application if one or more components (objects) become unavailable or non-existing then the system re-executes the steps 2810/1, 2810/2, and 2810/3, according to the embodiment.

With respect to partial execution of a user generated application, the system identifies each independent sub-process with respect to sub-clusters of objects based on the context (C_{B}) and root-object (O_{B}). Next, the system identifies sub-process priority (i.e., order of importance of each independent sub-process) of the user-generated process based on the context (C_{B}), and predefined execution rules. For example, most essential sub-processes having the highest rank, while least essential (e.g., relatively negligible) sub-processes having the lowest rank. Next, based on the order of importance of the sub-processes, the system prioritizes the sub-clusters of the root-object (O_{B}), i.e., identifies the priority of elements and clusters of interrelated elements. For example, the system may assign a weight coefficient for each element and each cluster of interrelated elements, with 1 being the most essential and with 0 being the least essential, e.g., relatively negligible. Based on weight coefficients assigned, the system and/or the developer of the respective user generated application may determine adaptation rules with respect to partial execution of the application. According to an embodiment, upon determination of the adaptation procedures—at 2810—with respect to the execution of a user generated application embedded with a super-object that is associated with an object or a cluster of objects, via utilizing disclosed methods and systems as well as state-of-the-art techniques: the system partially executes the user generated application according to the weight coefficients assigned.

As a result of the process 2800, the system identifies associations between super-objects and objects—among a set of encountered objects—and executes the each of the corresponding procedures, i.e., the each of the corresponding user generated applications that are embedded with the super-objects.

Revisiting Transforming-Objects with respect to Processes 2700 and 2800: With respect to the execution of processes 2700 and 2800 for a transforming object, i.e., the embodiment of a transforming concept, the transition is straight forward and can be briefly described by an example. Consider the hypothetical example of a complex mechanical transforming system that transforms within the context of ‘internal combustion engines’ and a user generated process with respect to ‘integrating a turbo charger to any suitable internal combustion engine encountered’, wherein each manifestation of the transforming-object may vary from a gas turbine to a Wankel, from a Wankel to a piston engine, from a piston engine to a rocket engine including not yet invented—but possible—sub-classes in between. In this hypothetical example, i) the context of ‘internal combustion engine’ defines the boundaries of the transformations of the transforming-object (TO), ii) each possible manifestation of the transforming-object defines each possible encounter with the transforming-object that may be represented by an integer variable (TO), iii) the process of ‘integrating a turbo charger’ defines the context (C_{B}), and iv) the target object ‘suitable internal combustion engine’ with respect to the process defines the root-object (O_{B}).

### EXAMPLES OF POSSIBLE INDUSTRIAL IMPLEMENTATIONS

Some of the prominent features of the web resource interaction system with respect to industrial implementations are as follows: Within the scope of any decentralized data network including the Internet, embodiments provide an infrastructure that enables an advanced interaction environment on any resource of a data network, where the system automatically controls the interactions of both prospective and associated super-objects with web objects (e.g., according to their roles/functions, and/or interrelationship, and/or predefined features introduced to the system) while dynamically adapting itself to contextual and/or structural alterations of—previously interacted—resources—irrespective of the complexity or dynamicity of alterations/transformations. Therefore, embodiments provide an infrastructure that enables a steady and consistent interaction environment upon complex and dynamic web environments in a self-contained manner, where human and machine users may develop and deploy modular sub-systems—via super-objects that stably and sustainably interact with the objects of those environments—while further interacting with already deployed sub-systems or interacting with each other through those sub-systems that act as network links.

In terms of industrial implementations, the web resource interaction system enables: i) Semi or fully automated content generation and integration (i.e., generating and associating passive super-objects with web objects, such as annotating contents) in complex and dynamic web environments; ii) Semi or fully automated feature generation and integration (i.e., developing and associating super-objects that dynamically manipulate web objects—including script content, such as other applications existing on the web) in complex and dynamic web environments; iii) Semi or fully automatic development and deployment of networks of modular sub-systems (i.e., developing and associating clusters of interrelated super-objects that dynamically manipulate web objects—including script content—incoordination) in complex and dynamic web environments; iv) Fully automatic control of interactions of super-objects with web objects in complex and dynamic web environments; v) Fully automatic control of interactions of users with web objects in the process of development and deployment of prospective super-objects in complex and dynamic web environments; vi) Fully automatic control of interactions of users with super-objects in complex and dynamic web environments; vii) Fully automatic control of interactions of users with each other through super-objects that act as network links in complex and dynamic web environments; viii) Fully automatic adaptation in response to contextual and/or structural alterations (i.e., maintenance of interactions by re-associating/re-integrating said user generated applications and adapting their procedures to alterations accordingly) in complex and dynamic web environments; and all in real time and in a self-contained manner. Last but not least, the system inherently provides a low-code/no-code software application development framework, by which layman users—besides expert users—may also be able to develop complex sub-systems (via developing modular super-objects that dynamically manipulate web objects). Thus, laymen may become web developers and service providers in complex and dynamic web environments.

In the case of the Internet as being the data network, the system described herein provides a stable and sustainable interaction environment on any resource of the Web, such as adaptive websites, dynamic web pages, complex and dynamic web objects, etc., where users (human or machine) may develop and deploy sub-systems thereon. Further, the system provides laymen a low code/no code application development environment where they may develop super-objects that dynamically manipulate objects of said web resources. Thus, the system paves the way for the development of an enormous variety of unprecedented sub-systems created by masses, such as novel systems for improvement of services, integration of websites, evaluation of information, data extraction or mining, social networking, entertainment, etc. Further, the system provides a basis for users to interact with each other through user generated sub-systems (i.e., networks of super-objects) thus may pave the way for web-wide social networking without borders, thus making existing centralized monopolist platforms, such as Facebook™, Twitter™, etc., redundant. Further, besides the semantics of contents, the system also focuses on revealing the semantics of structures in-depth, which is precisely identifying the role/function of each object and each cluster of objects of web resources, thus the system may pave the way for deciphering the full semantics of the entire Web not only as an environment of documents and contents but also as an environment of complex and dynamic interfaces. Further, the system may automatically collect complete data/information for each interaction process within the system (e.g., complete data/information about each software development and deployment process including the processes by which users interact with these applications), thus may pave the way for the accumulation of a big data of comprehensive processes. Further, the system may utilize the collected big data of comprehensive processes and artificial intelligence for creating and conceptualizing content and application ideas by itself.

The current disclosure therefore offers an AI based disruptive internet communication technology by which system users may build a web on the Web, while improving or integrating the services of websites, or challenging the information right at the source without technical and/or structural limitations or limitations imposed through administrative regulations. In this context, unlimited number of sub implementations may be formed with many practical benefits.

Social and Economic Impact: Employing such an infrastructure based on the described technology herein, ordinary internet users may become publishers & broadcasters anywhere on the Web, or they may become web developers & service providers throughout the Web, or they may just become nodes of a web-wide social network without borders and greedy stakeholders. Thus, the domain of the internet may be expanded tremendously. But more importantly, users may gain utmost interaction ability on any web resource, thereby the Web may be liberalized to a tremendous degree. And because interaction is the key to evolution, such an infrastructure may eventually pave the way for the evolution of information and services on the Web, while corroding the monopoly power of major websites and social media networks by extending the borders of interaction far beyond their scope. Thus, decentralized social networks may be ignited among those who prefer to express their dissent wherever and whenever needed. A totally new industry may thus be formed within the users' initiative that is capable of creating radical solutions right on the spot for improvement of services, integration of websites, evaluation of information, social networking, etc., which may revolutionize the internet as we know it today both socially and economically. Consequently, employing such an infrastructure may deeply influence the future of the society and economy while influencing various fields of science and technology with the idiosyncratic ‘big data’ that it may collect and accumulate, while creating a new field of scientific research about a novel communication paradigm (i.e., Superimposed Communication) which may be expanded even beyond the boundaries of the web and the Internet. Note: Within the scope of Superimposed Communication, even a simple static web page has an enormously rich interactivity potential regardless of its popularity. Such a development may truly liberate social interactivity from the bounds of social media websites by providing an unbounded social interaction alternative webwide and thus may deeply affect websites/webpages that are currently idle, especially in terms of an increase in demand. Indeed, it may be questioned that ‘why someone should express himself or herself on a 3rd party intermediary platform about a subject, instead of expressing himself or herself right on the source of the subject matter when applicable’.

Potential of future commercialization: The ultimate goal may be to provide a universal infrastructure and framework for both individual and corporate enterprises who may develop and deploy their own applications to provide services within the scope of said interaction possibilities. As a business model this may be similar to an AIP (Application Infrastructure Provider) which provides the computing and operational infrastructure for developing, deploying, and managing enterprise class applications. In this regard, the infrastructure envisioned to be provided may pave the way for the supply of a vast variety of services, e.g., for improvement of services, integration of websites, evaluation of information, data mining, social networking, entertainment, etc.

Example Case for Evaluation of Information: The Wikipedia™ website provides an internal evaluation mechanism by which wiki users may evaluate any bit of information e.g., a word, a sentence, a paragraph, a picture, a video, an audio, etc., of a wiki article right on the spot, by marking, linking, reporting, annotating, opening up a discussion, offering an alternative etc. In this context, Wikipedia™ may develop and deploy its own ‘Superimposed Wikipedia Application’ through the envisioned infrastructure in order to extend this particular service webwide and enable wiki users to evaluate any information on any web page right on the spot. Similarly, fact checking organizations like BBC, AFP, Le Monde™, etc. may develop and deploy their own ‘Fact Checking Superimposed Applications’ through the envisioned infrastructure for automatically detecting suspicious news items anywhere on the web (e.g., detecting their source pages, circulating link previews, quotations, etc.) and automatically flagging wherever they appear, including highlighting the disputable fragments and opening them up for public discussion and expert evaluation right on the spot. Similarly, a superimposed application for criticism may be developed and system users may criticize all kinds of information existing/circulating at the web via superimposed critical posts whose scoring and ranking may be based on quality, e.g., critical thinking, rather than on quantity, e.g., popularity. In such a mechanism, ‘critical thinking’ may be defined as an ‘intellectually disciplined process of actively and skillfully conceptualizing, applying, analyzing, synthesizing, and/or evaluating information gathered from, or generated by, observation, experience, reflection, reasoning, or communication, as a guide to belief and action.’ In this context, publishers may be expected to create posts conforming to the critical thinking criteria where they support analytical, positive, or negative criticism by concrete evidence. Such a mechanism may also contribute greatly to the dissemination of critical intelligence and skepticism. Uncensored analytical criticism directly at the very source may reduce social/massive reaction time and increase the quality feedback, thus enhancing overall intelligence.

Example Case for Social Networking: Social network platforms, such as Facebook™, enables users to create and publish their own interactive posts. A post appears on the author's Facebook page, while circulating on the news feed of other users' Facebook pages. In this context, Facebook™ may develop and deploy its own ‘Superimposed Facebook Application’ through the envisioned infrastructure in order to extend this particular service web wide and enable Facebook users to publish interactive posts in relation to any information on any web page right on the spot. For example, a Facebook user may initiate a discussion on an article of the constitution on the website of the Supreme Court of the United States or criticize a portion of a political article by a world-renowned columnist published on the website of Die Welt™. Further, users may interact and socialize with each other through these posts thus they may build a web-wide social network without borders. Similarly, any other social networking website like Twitter™, Instagram™, Reddit™, etc. or any online video platform like YouTube™, Vimeo™, Dailymotion™, etc., may develop and deploy its own ‘Superimposed Application’ through the envisioned infrastructure provided by the system. Social networking websites may extend services web wide and enable their users to become publishers and/or broadcasters anywhere on the Web right on the spot.

Example Case for Improvement of Services: Enterprise service provider ESPA™ develops browser extensions, plugins, addons and various other applications for improvement of services and integration of websites. For some cases ESPA™ utilizes integration codes—such as APIs—provided by the websites. However, for most of the cases ESPA™ cannot utilize such codes since either they do not meet the needs, or they do not exist. In such cases experts of ESPA™ manually interpret each target web page to be processed/manipulated and develop tailored applications in order to provide the targeted services. In the ongoing process, whenever a serviced web page is altered contextually and/or structurally, a maintenance expert manually interprets the alterations of that page and adapts the corresponding application/s according to the alterations. Because of all these inadequacies, ESPA™ is able to offer only relatively simple applications with limited competence. However, ESPA™ may develop, deploy, and manage any application through the envisioned infrastructure in order to semi-automatically develop and automatically deploy said applications and automatically maintain the services that they provide, without the need of integration APIs. Further, by the competencies gained including the contextual adaptation ability with the automation provided by the envisioned infrastructure, ESPA™ may expand the scope of the services and develop much more competent applications. Besides, instead of tailored applications that are designed particularly for target web pages, ESPA™ may develop smart applications that are designed to fit similar websites contextually. For example, ESPA™ may develop a ‘one size fits all’ application package for online video platforms (e.g., YouTube™, Vimeo™, Dailymotion™, etc.) such that the pack comprises an application that processes/manipulates video player interfaces for improvement of their features (e.g., by associating/integrating an effects filter, a 2D to 3D convertor, a video editor for creating and sharing audio-visual commentaries, a star rating system for evaluating video content, etc.) including visually modifying the interfaces by associating/integrating virtual controls (e.g., adding control buttons, displays, etc.), and another application that processes/manipulates link previews of recommended videos (e.g., for displaying star ratings of corresponding videos). Moreover, ESPA™ may introduce non-generic dynamic interfaces such as lists, tables, forms, etc. to the system according to their roles/functions. Thus, ESPA™ may develop and deploy particular applications that process/manipulate and/or utilize system-defined unique interfaces for improvement of services and/or integration of websites. For example, ESPA™ may develop an application that automatically collects data from bus, railway, and airline websites to provide users with better route alternatives (e.g., the cheapest or the fastest route combination) without the need for any manual or semi-automatic maintenance against any kind of alterations made by said websites. Further, ESPA™ may share these alternatives directly on said websites instead of presenting them on an external website, and even may create a second-hand online ticket market upon them for users who want to sell/buy already purchased tickets.

Example Case for Industrial Processes: Boeing Corporation utilizes various automation tools for various processes such as tools for Supervisory Control and Data Acquisition (SCADA), Manufacturing Resource Planning (MRP-II), Enterprise Resource Planning (ERP), etc. Most of these tools are centralized and server-based computing systems, accordingly, some of them are web-based technologies. In this context, Boeing may deploy the system for its own intranet and make the system work on web-based automation systems, thus may enable employees to associate/integrate contents and features within certain limitations in accordance with these systems and corresponding processes. For example, both blue-collar and white-collar employees—such as manual workers, technicians, engineers, researchers, etc.—from various fields and units can be encouraged to review, criticize, and improve functions of the corresponding automation systems in accordance with their field of expertise—within certain limits. For example, a technician—such as an aircraft structures technician working in the fuselage construction process—may criticize a certain function of the automation system that operates in his/her field of duty—such as a poorly designed interface of an MRP-II or SCADA system. And in response to that criticism, a colleague of his/hers—such as an aerospace engineer working in the same process—may develop and deploy an application that improves the interface in the context of that criticism. Thus, employees may autonomously contribute to the improvement and optimization of the processes by developing and deploying sub-systems that are virtually integrated into the automation systems, without any direct interference and completely independent of software developers. In the long run, accepted and useful applications may be permanently embedded in the system by the software developers. In addition, for industrial processes, strict limits may be set accordingly, so that interactions do not put production processes at risk.

Example Case for E-commerce: Individual entrepreneurs and software developers Ayse and Levent may develop, deploy, and manage an application that provides a superimposed e-commerce network on web resources. For example, via the application, posts that includes goods or services in accordance with the context of web pages and/or web objects may be published, such as by e-commerce websites or local businesses. For example, a post may be published in relation with a service presented in corporate websites (e.g., IBM™, Microsoft™, Google™, etc.), or in relation with a product existing in major e-commerce websites (e.g., Amazon.com, Alibaba.com, Walmart.com, etc.). Thus, small, and medium scale service providers or e-commerce enterprises including local businesses may compete against large scale major/global corporations virtually through the superimposed e-commerce network provided by this system. Further, system users themselves may become sellers of goods and providers of services anywhere on the web. For example, a local micro business or an individual seller may offer the advantage of possessing a niche product or proposing a niche service or offering a fast & free delivery option—which can be unbeatable when compared to the base e-commerce website (e.g., Amazon.com), thus, the target user may prefer the local business or individual seller. In general, a superimposed e-commerce network may pave the way for fair competition of the small to medium scale enterprises against large scale e-commerce websites worldwide. Also, services regarding e-commerce websites that are provided by independent websites (e.g., fake review analyzing engines/services) may be integrated by the application to the target websites. Thus, Ayse and Levent may create a superimposed e-commerce platform serving to Web users all over the world.

Example Case for Entertainment; Individual entrepreneurs and software developers Lea and Deniz (whom the inventor of the disclosed technology loves more than anything in the universe) may develop, deploy, and manage an application that provides a superimposed entertainment platform, by which both an infrastructure for superimposed games may be provided and a superimposed network that is fully devoted to entertainment may be set up. For example, objects of web pages that contain images may be transformed into virtual graffiti fields through the application so that network users may process/manipulate images if they wish so. Or more interestingly, various intelligent superimposed video games may be designed and developed based on the system's interpretation of web objects of web resources, such as an animated character, e.g., Pac-Man™, may digest the ASCII characters of a governmental site within the context of a proposed law while strolling on the web pages and the player (e.g., a government officer, a government sympathizer, etc.) may try to recover the digested ASCII characters. Thus, Lea and Deniz may create a superimposed gaming platform serving to Web users all over the world.

Summary of the benefits of the system with respect to the World Wide Web: i) Administrative restrictions including moderation and censorship, membership requirements, technical/structural limitations, etc. may be fully eliminated; ii) The whole Web may function as a global social networking platform; iii) Any field of a web page may be modified in order to improve the services including improvement of limited features; iv) Websites may be virtually integrated including the rival ones; v) A global signalization mechanism throughout the Web may be created, where existing or circulating Web contents may be automatically marked and flagged to indicate the presence of a remarkable condition such as fake, doctored news wherever they appear. This mechanism may be used to fight against disinformation such as fabricated news or fake reviews; vi) Posts, comments, reviews, or any kind of user generated content may be gathered up, on a single, integrated platform and this platform may archive and/or present user generated contents in association with their publishers, instead of disassociated posts/comments on different websites; vii) The noticeability of users who provide content on the Web may be greatly enhanced. For example, an able critic may get noticed by millions—at the very source of the subject matter or information—by adding her own article on top of the article of a popular columnist in a global news website, e.g., New York Times™, Le Monde™, etc. If liked, the user may gain followers and may be able to expand worldwide through her own superimposed network.

Ethical, legal, and fair use issues that may occur with respect to implementations of the system: In essence, the methods and systems described herein provides the technological infrastructure for constructing an AI-based web infrastructure for superimposed communication that allows users to develop and deploy any application which may be parallel to the capabilities of the system. In this context, due to the extreme versatility and capability of the system, some user generated applications may exceed the laws of the regions in which they are applied. To address any ethical and legal problem that may arise on behalf of the infrastructure provider, the envisioned infrastructure—based on the system described herein—may administratively operate similarly to an ‘application infrastructure provider’ (AIP). In this context, the infrastructure acts as an intermediary only (similar to that of web hosting or cloud service providers), where all responsibility regarding services provided through the infrastructure may be on developers/service providers both legally and ethically. Accordingly, all kinds of violations and their consequences including legal sanctions may solely bind the developers/service providers. Nevertheless, the infrastructure provider may impose restrictions in order to regulate the services to be provided by developers/service providers within the scope of regional laws and universal ethics including ethics in AI.

Elaborations on the process of filtering: The web resource interaction system may filter and/or group visual elements for interaction, and similarly, may filter and/or group visual elements in order to disable such visual elements from interaction, wherein filtering may be based on identification of each visual element according to their roles and/or functions, and identification of each cluster of interrelated visual elements including the role/function of each cluster. To elaborate on the technical purpose of this feature; Web pages may contain hundreds of visual elements with thousands of combinations of them, and in case of an infinite scrolling web page, there can be infinitely many visual elements and infinitely many combinations. In addition, even the content and structure of static web pages may change over time, and a significant portion of visual elements or visual element clusters may be altered. Moreover, these alterations may happen very often and radically in dynamic web pages. As a result, manual selection of visual elements for interaction, i.e. enabling interaction without any automated filtering and grouping mechanism, may involve several technical disadvantages such as: i) creating an unsteady system that is extremely prone to loss of associations by the alterations of web pages; ii) creating an unsteady system, where users (human or machine) may make erroneous selections during the selection process of visual elements and/or visual element clusters that they may associate their super-objects with (e.g. associating super-objects with irrelevant elements such as, search fields, containers, buttons, scrollbars, or combinations thereof etc.); iii) creating a vulnerable system, where users (human or machine) may create superfluous associations with random, irrelevant visual elements, e.g. by increasing the data processing and storage load of the system. In addition, enforcing users (human or machine) to interact with content of web resources according to roles and/or features and/or functions, etc. may be a requirement depending on the type of implementation. For example, there may be need to focus on contextual information or subject matter of web pages (e.g., news items, articles, comments, link previews, videos, social media posts, etc.). Alternatively, or in addition, there may be need to associate software applications that are stored and executed by the system with visual elements and/or with clusters of interrelated visual elements with certain functions such as, being a social media post interface, or a video player interface, etc., where the applications are executed within the defined cluster of interrelated visual elements according to particular procedures coded correspondingly. In general, the benefit of interacting with temporary ads or other extraneous content, or with elements of user interfaces, such as search fields, buttons, scrollbars, icons, containers, etc., may be questionable as well. Consequently, identifying and filtering particular visual elements for interaction, and/or identifying and clustering interrelated visual elements may be a necessity in terms of applicability, effectivity, and feasibility.

Elaborations on the subject of interacting with link previews of web pages: Link previews are hyperlinks with a preview. The preview may be textual and/or visual, and/or audial content including metadata about the linked web page. They can be permanent or temporal on a web page. They are mostly used in web pages through dynamic visual elements to alternately present available content of the website or used in the search engine result lists. According to the embodiments of the system, interacting with link previews is obviously an option,—if preferred so. According to the process 400, when a super-object is associated with a visual element, it may also be associated with the hyperlink associated with the visual element—if any—, and accordingly the super-object becomes associated with the link location besides the visual element. Further, according to the process 200, for each rendered web page, the database is queried to determine whether the hyperlinks detected in the web page are links of interacted web pages or not. Furthermore, since a link preview is a visual element and/or cluster of visual elements possessing informative and navigational features with certain attributions, link previews may also be identified by utilizing the process 300. In general, any visual element or cluster of visual elements with identifiable features,—such as link previews—, may be identified by utilizing the process 300. In one embodiment, link previews—which are classified/categorized as main or side content according to their roles in a web page—are also identified and disabled for interaction, while any link preview—including search engine results—, that belongs to an interacted web page is determined and marked with one or more input markers (IM) according to the types of associated super-objects. Thus, through the input markers (IM), metadata of all associated super-objects of the previewed web page (except software applications that are integrated with the page) may be reached by users without leaving the rendered web page. In one embodiment this feature is used as a signalization mechanism for identifying and marking the link previews of web pages with special conditions such as, containing fake and doctored news. In this regard, once a web page is flagged by a particular super-object, then the link previews of the web page may also be flagged by the system to indicate the condition throughout the data network (e.g., via marking social media posts, search engine result lists, web pages, etc. containing link previews).

Elaborations on the definitions of some of the terms and abbreviations that are used in this subject matter: i) ‘User generated contents’ and ‘user generated software applications’ are ‘user inputs into the system’ referred to as ‘user input’ or ‘super-object’. ‘User input’ and ‘super-object’ are terms that have the same meaning and used interchangeably in the specification, drawings, etc., unless indicated otherwise. User inputs, i.e., super-objects, are user generated contents or user generated software applications that are associated with singular elementary objects and/or meaningful clusters of elementary objects. ii) An ‘elementary visual object’ corresponds to a ‘visual element’, a ‘meaningful cluster of elementary visual objects’ corresponds to a ‘cluster of interrelated visual elements’ and a ‘web object’ corresponds to either an ‘elementary web object’ or a ‘meaningful cluster of elementary web objects’. An ‘elementary object’ corresponds to an ‘element’, a ‘meaningful cluster of elementary objects’ corresponds to a ‘cluster of interrelated elements’ and an ‘object’ corresponds to either an ‘elementary object’ or a ‘meaningful cluster of elementary objects’. Furthermore, an object may be any virtual or physical object, for example, may be a virtual object that contains data and code, wherein data may be in the form of fields (i.e., attributes or properties), and code may be in the form of procedures (i.e., methods), or may be a physical object that contains mechanical elements, such as any embodiment of a physical system (e.g., a jet engine, a table, a nuclear fusion reactor, etc.). iii) ‘Input metadata’ or ‘IMD’ is metadata of the corresponding super-object. iv) Input marker or ‘IM’ is a visual/audial indicator that indicates the presence of one or more super-objects that are associated with the corresponding visual element or cluster of visual elements. v) The term ‘context’ is used in the meaning of ‘the interrelated conditions in which something exists or occurs’ (Ref: Merriam-Webster dictionary). In this regard, the term ‘contextual’ is used in the meaning of ‘about context’, but also in the meaning of ‘content wise’, ‘related to content’, etc. vi) The terms: ‘identifying’, ‘determining’, ‘extracting’, ‘detecting’, etc. have been used in a similar sense and may be used interchangeably unless indicated otherwise. vii) An ‘interacted visual element’ or ‘previously interacted visual element’ is a ‘visual element that is associated with one or more super-object’. In the context of Superimposed Communication, a ‘user interaction with a web object’ is a content and/or software application generated by a user to be associated particularly with that web object for manifesting the content and/or executing the program instructions with respect to the web object—unless indicated otherwise. viii) The general interaction cycle may also be exemplified as such: Web pages share contents to be conveyed to users, then users may react to these contents via super-objects, then the interacted web pages themselves may—automatically or manually—react to these super-objects either via/through super-objects or the web page itself and so forth. ix) The term ‘analogy’ is used in the meaning of ‘a correspondence or partial similarity’ or ‘a comparison between one thing and another’. The term ‘analogue’ is used in the meaning of ‘a thing seen as comparable to another’ and depending on the context also used in the meaning of ‘representation by a continuously variable quantity instead of binary’. x) Attribute: a quality or feature regarded as a characteristic or inherent part of someone or something. Property: an attribute, quality, or characteristic of something. xi) ‘Superimposing’ is defined herein as the combined process of associating user generated contents and/or user generated software applications with visual elements and/or clusters of visual elements of a web resource, identifying visual elements and/or clusters of visual elements that are associated with user generated contents and/or user generated software applications, displaying metadata of user generated contents and/or user generated software applications in connection with the corresponding visual elements and/or clusters of visual elements, and displaying user generated contents and/or adapting and executing user generated software applications. In this context, ‘superimposed communication’ is further defined herein as communication based on superimposing, and ‘superimposed networking’ is defined herein as the social networking based on superimposing, i.e., connecting users through user generated contents and/or user generated applications that are superimposed on web resources. Note: A ‘user input’ should not be confused with web page activity such as detecting a pointing device input on a visual element field, clicking a button with the pointing device, operating a pull-down menu, and/or other operations by a user on a rendered web page and/or visual element that do not involve user generated input. On the other hand, said web page activity or any kind of user activity—including interpretations of physical activity, such as sentiment analysis of users—may also be collected, encapsulated, and superimposed as a user generated content, and even used as data inputs in a user generated application. Furthermore, in principle, any kind of input, such as live camera streams or signal outputs of industrial sensors, may be used to generate user generated contents or used as data inputs and/or references for user generated software applications.

An alternative summary of the disclosure: An adaptive web resource interaction system based on analogue referencing includes a computer implemented method, a computer system, and a non-transitory computer readable medium to provide an autonomous infrastructure that enables a fully automatically controlled interaction environment on web resources where the system dynamically adapts itself to contextual and/or structural alterations of each interacted web resource according to each rendering of a client individually. Thus, within the scope of any data network including the Internet, the system provides an infrastructure that ensures the consistency (stability) and persistency (sustainability) of interactions, where human and machine users may interact with web resources by associating/integrating—and/or reaching to—virtually any kind of user input including user generated software applications—stored and executed by the system—that dynamically process/manipulate web objects, and interact with those user inputs or with each other through those user inputs that act as network links. The current disclosure therefore offers a procreative communication technology by which an unlimited number of sub-technologies and sub-implementations may emerge.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects (of any kind), and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively, or in addition, each logical component may include memory hardware, such as a portion of the memory, for example, that comprises instructions executable with the processor or other processors to implement one or more of the features of the logical components. When any one of the logical components includes the portion of the memory that comprises instructions executable with the processor, the logical component may or may not include the processor. In some examples, each logical components may just be the portion of the memory or other physical memory that comprises instructions executable with the processor or other processor to implement the features of the corresponding logical component without the logical component including any other hardware. Because each logical component includes at least some hardware even when the included hardware comprises software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

1. A method comprising:
analyzing an environment encountered by a client to identify elements in the environment;
generating, for each of the identified elements, uniform element identifiers (UEIs), each of the UEIs uniquely identifying a corresponding one of the identified elements;
associating, with each of the UEIs, at least one of: information regarding the environment, distinctive information of the corresponding one of the elements, distinctive properties of the corresponding one of the elements, or relative position information of the corresponding one of the elements in the environment;
identifying, for each of the elements, cluster information to interrelate the elements within the environment, the cluster information identifying clusters of interrelated elements based on respective relative position of the elements, respective functional relationships of the elements with other elements, or both;
associating with at least one of the elements or a cluster of interrelated elements an application that dynamically processes and/or manipulates at least one of the elements or the cluster of interrelated elements;
re-analyzing the environment in response to the environment being subsequently encountered as a re-encountered environment to re-identify each of the elements in the re-encountered environment;
generating, for each of the elements identified in the re-encountered environment, new uniform element identifiers (nUEIs), each of the nUEIs uniquely identifying a corresponding one of the elements identified in the re-encountered environment;
associating, with each of the nUEIs, at least one of: information regarding the re-encountered environment, distinctive information of the corresponding one of the elements identified in the re-encountered environment, distinctive properties of the corresponding one of the elements identified in the re-encountered environment, or relative position information of the corresponding one of the elements in the re-encountered environment;
comparing the nUEIs with the UEIs and associating the nUEIs with the UEIs based on a predefined threshold of similarity; and
adapting respective execution procedures of the application for the nUEIs in accordance with association and comparison of the nUEIs and the UEIs.

2. The method of claim 1, wherein identifying, for each of the elements, cluster information comprises an initial step of classifying each of the elements into one of a plurality of predetermined classes.

3. The method of claim 2, wherein identifying, for each of the elements, cluster information comprises identifying, for each of the clusters of interrelated elements, at least one function of a respective cluster within the environment, and generating, for each respective cluster, uniform cluster function identifiers (UCFIs), each of the UCFIs including the at least one function of the respective cluster.

4. The method of claim 3, wherein identifying, for each of the elements, cluster information comprises identifying the elements and clusters of interrelated elements available for user interaction with respect to development of a super-object based on a set of predefined interaction rules, the classification of the visual elements, and the uniform cluster function identifiers (UCFIs).

5. The method of claim 1, wherein associating with at least one of the elements or the cluster of interrelated elements the application comprises receiving a user selection of the at least one of the elements or the cluster of interrelated elements;
receiving user commands to generate the application that dynamically processes and/or manipulates the selected at least one of the elements or the cluster of interrelated elements; and
setting adaptation rules for the application according to the selected at least one of the elements or the cluster of interrelated elements.

6. The method of claim 1, further comprising receiving an input representative of a user interaction with at least one of the elements or the cluster of interrelated elements; and
storing the user interaction with the at least one of the elements as super-object in association with the one of the UEIs, or storing the user interaction with the cluster of interrelated elements as super-object in association with a corresponding set of the UEIs that belong to the cluster of interrelated elements.

7. The method of claim 6, wherein identifying, for each of the elements, cluster information comprises identifying, for each of the clusters of interrelated elements, at least one function of a respective cluster within the environment, and generating, for each respective cluster, uniform cluster function identifiers (UCFIs); and
recording a corresponding UCFI of the respective cluster and/or recording for each of the UEIs that belong to the respective cluster corresponding cluster information.

8. The method of claim 7, wherein identifying, for each of the elements, cluster information comprises classifying each of the elements into one or more of a plurality of predetermined classes, and wherein recording the corresponding UCFI comprises recording, for each of the UEIs that belong to the respective cluster, corresponding cluster information and a predetermined class of each of the elements in the respective cluster.

9. The method of claim 1, wherein the UEIs are stored in a database as recorded UEIs (rUEIs) and comparing the nUEIs with UEIs comprises comparing the nUEIs with the rUEIs stored in the database.

10. The method of claim 1, wherein re-identifying, for each of the elements identified in the re-encountered environment, new cluster information comprises:
re-identifying, for each of a plurality of new clusters, a function within the re-encountered environment; and
generating, for each of the new clusters, new uniform cluster function identifiers (nUCFIs), each of the nUCFIs including the function of a respective new cluster of interrelated elements.

11. The method of claim 10, wherein re-identifying, for each of the elements identified in the re-encountered environment, new cluster information further comprises an initial step of re-classifying each of the elements identified in the re-encountered environment into one or more of a plurality of predetermined classes.

12. The method of claim 10, further comprising comparing the nUCFIs with UCFIs stored in a database as recorded UCFIs (rUCFIs) and associating the nUCFIs with the rUCFIs based on a predefined threshold of similarity to re-establishing a previously established association between a super-object and an element or a cluster of interrelated elements.

13. The method of claim 11, wherein comparing the nUEIs with UEIs comprises:
constructing, based on the UEIs, an initial state representation of the at least one of the elements or the cluster of interrelated elements associated with the application;
constructing based on the nUEIs a recent state representation of the at least one of the elements or the cluster of interrelated elements associated with the application; and
comparing the initial state representation with the recent state representation to identify contextual and structural differences.

14. The method of claim 13, wherein adapting respective execution procedures of the application comprises adapting the respective execution procedures of the application to the recent state representation of the at least one of the elements or the cluster of interrelated elements associated with the application in accordance with the identified contextual and structural differences.

15. The method of claim 14, wherein adapting respective execution procedures of the application to the recent state representation comprises identifying a procedure to adapt the respective execution procedures to the recent state representation of the at least one of the elements or the cluster of interrelated elements associated with the application according to the identified contextual and structural differences, a predefined set of adaptation rules defined for the application, and the at least one of the elements or the cluster of interrelated elements associated with the application.

16. A system comprising:
a server computer configured to:
analyze an environment encountered by a client to identify elements in the environment;
generate, for each of the identified elements, uniform element identifiers (UEIs), each of the UEIs uniquely identifying a corresponding one of the identified elements;
associate, with each of the UEIs, at least one of: information regarding the environment, distinctive information of the corresponding one of the elements, distinctive properties of the corresponding one of the elements, or relative position information of the corresponding one of the elements in the environment;
identify, for each of the elements, cluster information to interrelate the elements within the environment, the cluster information identifying clusters of interrelated elements based on respective relative position of the elements, respective functional relationships of the elements with other elements, or both;
associate with at least one of the elements or a cluster of interrelated elements an application that dynamically processes and/or manipulates at least one of the elements or the cluster of interrelated elements;
re-analyze the environment in response to the environment being subsequently encountered as a re-encountered environment to re-identify each of the elements in the re-encountered environment;
generate, for each of the elements identified in the re-encountered environment, new uniform element identifiers (nUEIs), each of the nUEIs uniquely identifying a corresponding one of the elements identified in the re-encountered environment;
associate, with each of the nUEIs, at least one of: information regarding the re-encountered environment, distinctive information of the corresponding one of the elements identified in the re-encountered environment, distinctive properties of the corresponding one of the elements identified in the re-encountered environment, or relative position information of the corresponding one of the elements in the re-encountered environment;
compare the nUEIs with the UEIs and associating the nUEIs with the UEIs based on a predefined threshold of similarity; and
adapt respective execution procedures of the application for the nUEIs in accordance with association and comparison of the nUEIs and the UEIs.

17. The system of claim 16, wherein the server computer is further configured to classify each of the elements into one of a plurality of predetermined classes in order to identify, for each of the elements, respective cluster information.

18. The system of claim 17, wherein the server computer is further configured to identify, for each of the clusters of interrelated elements, at least one function of a respective cluster within the environment, and generate, for each respective cluster, uniform cluster function identifiers (UCFIs), each of the UCFIs including the at least one function of the respective cluster.

19. The system of claim 18, wherein the server computer is further configured to identify the visual elements and clusters of interrelated visual elements in the web page available for user interaction with respect to development of a super-object based on a set of predefined interaction rules, classification of the visual elements, and the uniform cluster function identifiers (UCFIs).

20. The system of claim 16, wherein the server computer is further configured to:
receive a user selection of the at least one of the elements or the cluster of interrelated elements;
receive user commands to generate the application that dynamically processes and/or manipulates the selected at least one of the elements or the cluster of interrelated elements; and
set adaptation rules for the application according to the selected at least one of the elements or the cluster of interrelated elements.

21. The system of claim 16, wherein the server computer is further configured to:
receive an input representative of a user interaction with the at least one of the elements or the cluster of interrelated elements; and
store, in a database, the user interaction with the at least one of the elements as super-object in association with the one of the UEIs, or store, in the database, the user interaction with the cluster of interrelated elements as super-object in association with a corresponding set of the UEIs that belong to the cluster of interrelated elements.

22. The system of claim 21, wherein the server computer is further configured to: identify, for each of the clusters of interrelated elements, at least one function of a respective cluster within the environment, and generate, for each respective cluster, uniform cluster function identifiers (UCFIs); and
record a corresponding UCFI of the respective cluster and/or recording for each of the UEIs that belong to the respective cluster corresponding cluster information.

23. The system of claim 22, wherein the server computer is further configured to: classify each of the elements into one or more of a plurality of predetermined classes, and wherein recordation of the corresponding UCFI comprises the server computer being further configured to: record, for each of the UEIs that belong to the respective cluster, corresponding cluster information and a predetermined class of each of the elements in the respective cluster.

24. The system of claim 16, further comprising a database, and wherein the server computer is further configured to store the UEIs in the database as recorded UEIs (rUEIs) and compare the nUEIs with the rUEIs stored in the database.

25. The system of claim 16, wherein the server computer is further configured to:
re-identify, for each of a plurality of new clusters, a function within the re-encountered environment; and
generate, for each of the new clusters, new uniform cluster function identifiers (nUCFIs), each of the nUCFIs including the function of a respective new cluster of interrelated elements.

26. The system of claim 25, wherein the server computer is further configured to: re-classify each of the elements identified in the re-encountered environment into one of a plurality of predetermined classes prior to identification, by the server computer, of new cluster information.

27. The system of claim 25, wherein the server computer is further configured to: compare the nUCFIs with UCFIs stored in a database as recorded UCFIs (rUCFIs) and associate the nUCFIs with the rUCFIs based on a predefined threshold of similarity to re-establish a previously established association between a super-object and an element or a cluster of interrelated elements.

28. The system of claim 16, wherein the server computer is further configured to:
construct, based on the UEIs, an initial state representation of the at least one of the elements or the cluster of interrelated elements associated with the application;
construct based on the nUEIs a recent state representation of the at least one of the elements or the cluster of interrelated elements associated with the application; and
compare the initial state representation with the recent state representation to identify contextual and structural differences.

29. The system of claim 28, wherein the server computer is further configured to: adapt the respective execution procedures of the application to the recent state representation of the at least one of the elements or the cluster of interrelated elements associated with the application in accordance with the identified contextual and structural differences.

30. The system of claim 29, wherein the server computer is further configured to: identify a procedure to adapt the respective execution procedures to the recent state representation of the at least one of the elements or the cluster of interrelated elements associated with the application according to identified contextual and structural differences, a predefined set of adaptation rules defined for the application, and the at least one of the elements or the cluster of interrelated elements associated with the application.

31. A non-transitory computer readable medium storing instructions executable by a processor, the computer readable medium comprising:
instructions executable with the processor to analyze an environment encountered by a client to identify elements in the environment;
instructions executable with the processor to generate, for each of the identified elements, uniform element identifiers (UEIs), each of the UEIs uniquely identifying a corresponding one of the identified elements;
instructions executable with the processor to associate, with each of the UEIs, at least one of: information regarding the environment, distinctive information of the corresponding one of the elements, distinctive properties of the corresponding one of the elements, or relative position information of the corresponding one of the elements in the environment;
instructions executable with the processor to identify, for each of the elements, cluster information to interrelate the elements within the environment, the cluster information identifying clusters of interrelated elements based on respective relative position of the elements, respective functional relationships of the elements with other elements, or both;
instructions executable with the processor to associate with at least one of the elements or a cluster of interrelated elements an application that dynamically processes and/or manipulates at least one of the elements or the cluster of interrelated elements;
instructions executable with the processor to re-analyze the environment in response to the environment being subsequently encountered as a re-encountered environment to re-identify each of the elements in the re-encountered environment;
instructions executable with the processor to generate, for each of the elements identified in the re-encountered environment, new uniform element identifiers (nUEIs), each of the nUEIs uniquely identifying a corresponding one of the elements identified in the re-encountered environment;
instructions executable with the processor to associate, with each of the nUEIs, at least one of: information regarding the re-encountered environment, distinctive information of the corresponding one of the elements identified in the re-encountered environment, distinctive properties of the corresponding one of the elements identified in the re-encountered environment, or relative position information of the corresponding one of the elements in the re-encountered environment;
instructions executable with the processor to compare the nUEIs with the UEIs and associating the nUEIs with the UEIs based on a predefined threshold of similarity; and
instructions executable with the processor to adapt respective execution procedures of the application for the nUEIs in accordance with association and comparison of the nUEIs and the UEIs.
